(19) United States
(12) Patent Application Publication
(10) Pub. No.: US 2012/0003467 A1
(43) Pub. Date: Jan. 5, 2012

(54) Antistatic laminate, optical film, polarizing plate, image display device and production method of antistatic laminate

(75) Inventors: Masaaki SUZUKI, Shizuoka (JP); Katsuyuki TAKADA, Shizuoka (JP); Hiroyuki YONEYAMA, Kanagawa (JP)

(73) Assignee: FUJI FILM Corporation, Tokyo (JP)

(21) Appl. No.: 13/067,856

(22) Filed: Jun. 30, 2011

(30) Foreign Application Priority Data
Jun. 30, 2010 (JP) P2010-150570
Mar. 31, 2011 (JP) P2011-081059

(51) Int. Cl. B32B 9/04; B32B 33/00; B05D 5/12; B32B 27/08

(52) U.S. Cl. 428/336; 428/446; 428/421; 428/422; 428/419; 428/448; 427/77

(57) ABSTRACT

A laminate includes a base material and an antistatic layer provided on the base material, wherein the antistatic layer has a sea-island phase separation structure and contains (A) a conductive polymer in a sea region of the sea-island phase separation structure, in a surface of the base material on a side adjacent to the antistatic layer at least one compound selected from (B1) a fluorine-containing compound and (B2) a silicone-based compound is distributed at an uneven concentration in an in-plane direction of the surface, and a common logarithm value (log SR) of surface resistivity SR (Ω/sq) of the antistatic layer is from 3.0 to 13.0.

### CROSS-REFERENCE TO RELATED APPLICATIONS

This application claims the benefit of Japanese Patent Application JP 2010-150570, filed Jun. 30, 2010 and Japanese Patent Application JP 2011-081059, filed Mar. 31, 2011, the entire contents of which are hereby incorporated by reference, the same as if set forth at length.

### FIELD OF THE INVENTION

The present invention relates to a laminate having an excellent antistatic property, an optical film, a polarizing plate using the optical film, an image display device using the optical film or the polarizing plate on the outermost surface of the display and a production method of an antistatic laminate.

### BACKGROUND OF THE INVENTION

The present invention relates to a laminate having an excellent antistatic property, an optical film, a polarizing plate using the optical film, and an image display device using the optical film or the polarizing plate on the outermost surface of the display.

In the field of optical products, precision instrument, building material, home appliance or the like, it is useful to apply a film having an antistatic function for the purpose of preventing, for example, dust attachment or electric circuit failure. In particular, in the field of home appliance, it has been recently required to provide various functions, for example, antireflective property or hardcoat property in addition to the antistatic property to a protective film provided on the surface of image display device, for example, a cathode ray tube display (CRT), a plasma display (PDP), an electroluminescence display (ELD) and a liquid crystal display device (LCD).

Ordinarily, the protective film (antireflective film) having the antireflective property comprises a low refractive index layer having a refractive index lower than that of a base material and an appropriate layer thickness formed directly or through other layer(s) on the base material. In order to realize a low reflectance, it is desired to use a material having a refractive index as low as possible in the low refractive index layer.

As an ingredient for reducing a refractive index of the material, a fluorine atom-containing material is ordinarily exemplified. It is known, however, when the fluorine atom-containing material is incorporated into a low refractive index layer, interfacial bonding between the low refractive index layer and a layer adjacent thereto decreases to result in decrease in adhesion property. On the other hand, it is proposed that surface strength is improved by using a crosslinkable material containing a fluorine atom (see JP-A-8-92323 (the term “JP-A” as used herein means an “unexamined published Japanese patent application”), JP-A-2003-222702 and JP-A-2003-26732). However, in the case of using a fluorine atom-containing layer on the outermost surface of antireflective film, the increase in a ratio of the fluorine atom in the compound for reducing the refractive index induces that the surface of film tends to be negatively charged to cause a problem in that dust is apt to attach to the surface.

In order to decrease the attachment of dust, it is ordinarily known to provide a layer (antistatic layer) having conductivity on the antireflective film to release the charge accumulated on the surface of antireflective film.

For instance, in JP-A-2005-196122, JP-A-11-92750 and JP-A-2003-294904, antireflective films provided with an antistatic layer containing conductive particles are described. However, since it is necessary to provide a new layer in addition to the low refractive index layer, the method has a problem of inferior productivity due to the loads of facilities and time for the production.

Further, since the conductive particles comprising metal oxide heretofore ordinarily used for the purpose of achieving the antistatic property mostly have a refractive index of approximately from 1.6 to 2.2, the antistatic layer containing such conductive particles has a high reflective index. When the reflective index of antistatic layer increases in the antireflective film, due to difference in the reflective index from the adjacent layers unintended interference unevenness occurs to cause a problem in that hue of reflected color becomes strong.

In response to the problem, in JP-A-2007-185824, JP-A-2005-316425 and JP-A-2007-293325, methods of kneading a conductive agent in a low refractive index layer are described.

In JP-A-2007-185824, a method of using a silicon alkoxide as a thermosetting binder in combination with an organic antistatic agent is described. However, the silicon alkoxide has a problem in that the binder after curing is poor in alkali resistance and thus it may cause a problem, for example, to use as an antireflective film on the surface of image display device which may be exposed to an alkaline detergent for domestic use.

In JP-A-2005-316425 and JP-A-2007-293325, techniques of using an organic antistatic agent in a low refractive index layer containing a binder having alkali resistance are described. It is described that the amount of the organic antistatic agent used in the low refractive index layer is from 0.3 to 5% by weight and the antistatic property may be obtained by the introduction of a small amount of the antistatic component. It is also described that the concentration of the antistatic agent may be varied in the thickness direction of the low refractive index layer so as to have high concentration of the antistatic component in the surface of the low refractive index layer to form a conductive pass. However, in the cured layer containing the organic antistatic component localized near the surface thereof for imparting the sufficient conductive performance, scratch resistance and adhesion property to the lower layer are not enough.

### SUMMARY OF THE INVENTION

To develop a technique for providing an excellent antistatic property without accompanying degradation of the various existing characteristics is a common subject not only in the field of antireflective film but also in various fields of technologies. From the standpoint of cost, development of a technique providing an excellent antistatic property with addition of a small amount of an antistatic agent has been also strongly requested.

An object of the present invention is to provide a laminate which has an excellent antistatic property and is excellent in productivity. Another object of the invention is to provide an optical film excellent in scratch resistance, adhesion property, dust resistance, antifouling property, antireflective property and hardcoat property using the laminate described above.

A still another object of the invention is to provide a polarizing plate or image display device using the optical film described above.

The above-described objects can be achieved by the constitutions described below.

(1) A laminate comprising an antistatic layer on a base material, wherein the antistatic layer has a sea-island phase separation structure, the antistatic layer contains (A) a conductive polymer in a sea region of the sea-island phase separation structure, in a surface of the base material on a side adjacent to the antistatic layer at least one compound selected from (B1) a fluorine-containing compound and (B2) a silicone-based compound is distributed at an uneven concentration in an in-plane direction of the surface, and a common logarithm value (log SR) of surface resistivity SR (Ω/sq) of the antistatic layer is from 3.0 to 13.0.
(2) The laminate as described in (1) above, wherein in the distribution of at least one compound selected from (B1) a fluorine-containing compound and (B2) a silicone-based compound in the surface of the base material on a side adjacent to the antistatic layer, concentration of at least one compound selected from (B1) a fluorine-containing compound and (B2) a silicone-based compound in the surface of the base material adjacent to the sea region containing (A) the conductive polymer of the antistatic layer is lower than concentration of at least one compound selected from (B1) a fluorine-containing compound and (B2) a silicone-based compound in the surface of the base material adjacent to the island region of the antistatic layer.
(3) The laminate as described in (1) or (2) above, wherein in the surface of the base material on a side adjacent to the antistatic layer (B1) the fluorine-containing compound is distributed at an uneven concentration in an in-plane direction of the surface, and (B1) the fluorine-containing compound is a fluoroaliphatic group-containing polymer containing 10% by weight or more of a polymerization unit derived from a fluoroaliphatic group-containing monomer.
(4) The laminate as described in (3) above, wherein the fluoroaliphatic group-containing polymer is a polymer having in its side chain, a perfluoroalkyl group having 4 or more carbon atoms or a fluoroalkyl group having 4 or more carbon atoms and a —CF₂H group.
(5) The laminate as described in any one of (1) to (4) above, wherein (A) the conductive polymer is a π-conjugated system conductive polymer or a derivative thereof.
(6) The laminate as described in (5) above, wherein the π-conjugated system conductive polymer is at least any one selected from polythiophene, polyaniline, a polythiophene derivative and a polyaniline derivative.
(7) The laminate as described in any one of (1) to (6) above, wherein the antistatic layer further contains (C) a cured compound of a fluorine-containing curable compound.
(8) The laminate as described in any one of (1) to (7) above, wherein the antistatic layer further contains at least any one selected from (D) a silicone-based antifouling agent and (F) a fluorine-containing antifouling agent.
(9) The laminate as described in any one of (1) to (8) above, wherein the antistatic layer further contains (F) an inorganic oxide particle.
(10) The laminate as described in any one of (1) to (9) above, wherein a thickness of the antistatic layer is from 20 nm to 5 μm.
(11) The laminate as described in any one of (1) to (10) above, wherein the base material comprises a support and a layer formed by coating a curable resin on the support and curing, and a surface of the layer formed by coating a curable resin on the support and curing is the surface of the base material on a side adjacent to the antistatic layer.
(12) The laminate as described in (11) above, wherein the layer formed by coating a curable resin on the support and curing is a hardcoat layer.
(13) The laminate as described in any one of (1) to (12) above, wherein the antistatic layer is a low refractive index layer having a refractive index from 1.25 to 1.49.
(14) The laminate as described in any one of (1) to (13) above, which further comprises a layer on the antistatic layer, and a common logarithm value (log SR) of surface resistivity SR (Ω/sq) of an outermost surface of the laminate is from 3.0 to 13.0.
(15) An optical film containing the laminate as described in any one of (1) to (14) above.
(16) A polarizing plate comprising a polarizing film and two protective films provided on both sides of the polarizing film, wherein at least one of the protective films is the laminate as described in any one of (1) to (14) above or the optical film as described in (15) above.
(17) An image display device having the laminate as described in any one of (1) to (14) above, the optical film as described in (15) above or the polarizing plate as described in (16) above.
(18) A method for producing the laminate comprising an antistatic layer on a base material as described in any one of (1) to (14) above, wherein the method comprises: distributing, onto the base material, at least one compound selected from (B1) a fluorine-containing compound and (B2) a silicone-based compound at an uneven concentration in an in-plane direction of a surface of the base material; and applying a solution containing a conductive polymer for forming the antistatic layer onto the base material.

According to the present invention, a laminate excellent in the antistatic property and excellent in the productivity can be provided. Since the laminate according to the invention is excellent in the antistatic property and excellent in the productivity, it can be applied to various fields, for example, field of optical products, precision instrument, building material or home appliance, requiring the antistatic property for the purpose of preventing, for example, dust attachment or electric circuit failure due to charge.

Further, according to the invention, an optical film excellent in the antistatic property, dust resistance, scratch resistance, antifouling property and hardcoat property and having a sufficient antireflective characteristic can be provided.

Moreover, using the optical film, a polarizing plate or image display device having high quality can be provided.

### DETAILED DESCRIPTION OF THE INVENTION

The present invention will be described in more detail below. In the specification, when a numerical value represents a physicality value, a characteristic value or the like, the expression “(numerical value 1) to (numerical value 2)” means “from (numerical value 1) or more to (numerical value 2) or less”. Also, in the specification, the term “(meth)acrylate” means “at least any one of acrylate and methacrylate”. The terms “(meth)acryloyl”, “(meth)acrylic acid” and the like are also same as above.

The laminate according to the invention is a laminate comprising an antistatic layer on a base material, wherein the antistatic layer has a sea-island phase separation structure, the antistatic layer contains (A) a conductive polymer in the sea region of the sea-island phase separation structure, in the surface of the base material on a side adjacent to the antistatic layer at least one compound selected from (B1) a fluorine-containing compound and (B2) a silicone-based compound is distributed at an uneven concentration in an in-plane direction of the surface, and a common logarithm value (log SR) of surface resistivity SR (Ω/sq) of the antistatic layer is from 3.0 to 13.0.

### [Antistatic Layer]

The antistatic layer of the laminate according to the invention will be described below.

### [Sea-Island Structure in Antistatic Layer]

In order to obtain high antistatic performance using a small amount of a conductive polymer, it is preferred for the conductive polymer to be localized, not to be uniformly distributed.

Due to the localization of the conductive polymer, a conductive path is apt to be formed even when a small amount of the conductive polymer is used. In particular, in the invention the antistatic layer has a sea-island phase separation structure, and the conductive polymer (A) is contained in the sea region which forms a continuous phase. It is preferable that the island regions are made from a cured compound of at least one of the non-fluorine-containing polyfunctional monomer and the fluorine-containing curable compound (C) described hereinafter. According to the invention, it is not always necessarily required that the island regions completely form discontinuous phases independently from the sea region containing the conductive polymer (A) in the whole area of the antistatic layer and the island regions may be partially connected.

Further, in case of containing a binder component in addition to the conductive polymer in the antistatic layer, the binder component having low compatibility to the conductive polymer is preferred. Such a binder component can prevent average distribution of the conductive polymer in the antistatic layer which causes decrease in contact frequency between the conductive polymers to reduce the conductivity.

In the inside of the antistatic layer according to the invention, a local concentration of the conductive polymer (A) in the sea region is preferably 1.5 times or more, more preferably 2.0 times or more, still more preferably from 5.0 to 50 times higher than an average concentration of the conductive polymer (A) in the conductive polymer.

As the local concentration increases and as the uneven distribution ratio increases, intermolecular distance of the conductive polymers decreases and the excellent conductivity is generated. Further, since the amount of the conductive polymer used can be reduced, it is advantageous in view of cost.

Moreover, due to the increase in the local concentration and uneven distribution ratio, the antistatic property can be provided without accompanying degradation of the antireflective property, scratch resistance and the like in case of forming an antireflective laminate and durability (for example, moisture/heat resistance or light resistance) of the organic conductive compound can be improved.

The size of the island region in the sea-island structure of antistatic layer is preferably in a range from 5 to 2,000 nm from the standpoint of film strength and appearance. The size of the island region can be analyzed by observing fine structure of the antistatic layer as an image using, for example, oblique cutting TOF-SIMS, SEM, TEM or a laser microscope. The size of the island region of 5 nm or more is preferred in view of compatibility between the conductivity and the adhesion property. On the other hand, when the size of the island region is 2,000 nm or less, scattering at the interface of each region is maintained at a neglectable level. As a result, the laminate is prevented from generating white turbidity. From the standpoint described above, the size of the island region is preferably from 5 to 2,000 nm, more preferably from 10 to 1,000 nm, and still more preferably from 30 to 200 nm.

When the antistatic layer is viewed by cutting it in arbitrary direction, an area ratio of the sea region in the sea-island structure of the antistatic layer is preferably 6 to 70% and more preferably 10 to 40%. When the area ratio of the sea region is no less than 6%, sufficient conductivity is obtained, and when the area ratio of the sea region is no more than 70%, deterioration of the adhesion property or surface state of the coated layer hardly occur

With respect to the local concentration according to the invention, the mass distribution of organic conductive compound in the layer can be determined according to the method described below.

First, the laminate is obliquely cut at an angle from 5 to 0.02° by a microtome and the cut section of the layer obtained is analyzed by TOF-SIMS method.

Although a spatial resolution of ion image by the TOP-SIMS method is approximately from 0.1 to 0.2 μm, the oblique cut makes it possible to quantitatively comprehend distribution of the organic conductive compound in the layer thickness direction in the thin layer.

The TOF-SIMS method is an abbreviation of Time-of-Flight Secondary Ion Mass Spectrometry and is a method wherein an ion image reflecting a structure of an organic compound present on the surface of a solid sample can be determined by measuring a secondary ion, for example, a molecular ion or fragment ion, which is discharged from a molecule in the sample by irradiation of a primary ion, for example, Ga⁺ or In⁺.

The detection of secondary ion by the TOF-SIMS method can be conducted by using any of a positive ion and a negative ion. According to the present invention, a positive ion is selected and the total secondary ion image of 0 to 1,000 amu (amu: atom mass unit) is measured in a raw data form in the same region of the cut section of the layer. In order to neutralize charge-up on the surface of the sample during the measurement, a flood gun may be used.

### [(A) Conductive Polymer]

The conductive polymer (A) is preferred because it is easy to from the sea-island phase separation structure in response to the state of base material and it prevents the occurrence of surface state failure of the layer. The conductive polymer includes an ionic conductive polymer and a π-conjugated system conductive polymer.

### (Ionic Conductive Polymer)

The ionic conductive polymer includes, for example, an ionene type polymer having a dissociable group in its main chain and a cationic polymer compound.

Examples of the ionic conductive polymer include an ionene type polymer having a dissociable group in its main chain as described, for example, in JP-B-49-23828 (the term “JP-B” as used herein means an “examined Japanese patent publication”), JP-B-49-23827, JP-B-47-28937, JP-B-55-734, JP-A-50-54672, JP-A-59-14735, JP-A-57-18175, JP-A-57-18176 and JP-A-57-56059, and a cationic polymer compound as described, for example, in JP-B-53-13223, JP-B-57-15376, JP-B-53-45231, JP-B-55-145783, JP-B-55-65950, JP-B-55-67746, JP-B-57-11342, JP-B-57-19735, JP-B-58-56858, JP-A-61-27853, JP-A-62-9346, JP-A-10-279833 and JP-A-2000-80169.

A particularly preferable ionic conductive polymer is a polymer type quaternary ammonium salt containing a quaternary ammonium cation. When the polymer type quaternary ammonium salt is used as the organic conductive polymer, the laminate excellent in the surface state of the coated layer and adhesion property is obtained.

The content of the ionic conductive polymer in a composition (preferably a coating solution) for forming the antistatic layer is preferably from 6 to 70% by weight, more preferably from 6 to 50% by weight, most preferably from 10 to 40% by weight, based on the total solid content of the composition. When the content of the ionic conductive polymer is 6% by weight or more, sufficient conductivity is obtained and when it is 70% by weight or less, deterioration of the adhesion property or surface state of the coated layer hardly occur.

### (π-Conjugated System Conductive Polymer)

As the π-conjugated system conductive polymer, any organic polymer the main chain of which is constituted with a π-conjugated system may be used without particular limitation. The π-conjugated system conductive polymer is preferably a π-conjugated system heterocyclic compound or a derivative of π-conjugated system heterocyclic compound in view of compound stability and high conductivity.

The π-conjugated system conductive polymer includes at least one member selected from the group consisting of an aliphatic conjugated system including polyacetylene, polyacene or polyazulene, an aromatic conjugated system including polyphenylene, a heterocyclic conjugated system including polypyrrole, polythiophene or polyisothianaphthene, a hetero atom-containing conjugated system including polyaniline or polythienylenevinylene, a mixed type conjugated system including poly(phenylenevinylene), a multiple chain type conjugated system which is a conjugated system including plural conjugated chains in its molecule, derivatives of these conductive polymers, and a conductive complex which is a polymer formed by graft or block copolymerization of the conjugated polymer chain described above to a saturated polymer.

From the standpoint of stability in the air, polypyrrole, polythiophene, polyaniline or a derivative thereof is preferred, and polythiophene, polyaniline or a derivative thereof, that is, polythiophene, polyaniline, a polythiophene derivative or a polyaniline derivative is more preferred.

Although the π-conjugated system conductive polymer exhibits sufficient conductivity and compatibility with a binder resin even when it is unsubstituted, it is preferred to introduce a functional group, for example, an alkyl group, a carboxyl group, a sulfo group, an alkoxy group or a hydroxy group into the π-conjugated system conductive polymer in order to more increase the conductivity and compatibility.

Specific examples of the π-conjugated system conductive polymer include, a polypyrrole, for example, polypyrrole, poly(N-methylpyrrole), poly(3-methylpyrrole), poly(3-ethylpyrrole), poly(3-n-propylpyrrole), poly(3-butylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), poly(3-ethoxypyrrole), poly(3-butoxypyrrole) or poly(3-methyl-4-hexyloxypyrrole),

a polythiophene, for example, polythiophene, poly(3-methylthiophene), poly(3-ethylthiophene), poly(3-propylthiophene), poly(3-butylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3-chlorothiophene), poly(3-iodothiophene), poly(3-cyanothiophene), poly(3-phenylthiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3-methyl-4-methoxythiophene), poly(3,4-ethylenedioxythiophene), poly(3-methyl-4-ethoxythiophene), poly(3-carboxythiophene), poly(3-methyl-4-carboxythiophene), poly(3-methyl-4-carboxyethylthiophene) or poly(3-methyl-4-carboxybutylthiophene),
a polyaniline, for example, polyaniline, poly(2-methylaniline), poly(3-isobutylaniline), poly(2-anilinesulfonic acid) and poly(3-anilinesulfonic acid).

### (Polymer Dopant Having Anion Group)

It is preferred that the π-conjugated system conductive polymer is used together with a polymer dopant having an anion group (hereinafter, also referred to as a “polyanion dopant”). Specifically, in such a case, the organic conductive compound is an organic conductive polymer composition containing an organic conductive polymer compound (π-conjugated system conductive polymer) and a polymer dopant having an anion group. Due to using the combination of the π-conjugated system conductive polymer with the polymer dopant having an anion group, high conductivity, the improvement in time-lapse stability of the conductivity and the increase in water resistance as the laminate are achieved.

Examples of the polyanion dopant include a polymer containing any one of structures selected from substituted or unsubstituted polyalkylene, substituted or unsubstituted polyalkenylene, substituted or unsubstituted polyimide, substituted or unsubstituted polyamide and substituted or unsubstituted polyester and a structural unit having an anionic group.

The polyalkylene is a polymer having a main chain constituted from repetition of methylene. Examples of the polyalkylene include polyethylene, polypropylene, polybutene, polypentene, polyhexene, polyvinyl alcohol, polyvinyl phenol, poly(3,3,3-trifluoropropylene), polyacrylonitrile, polyacrylate and polystyrene.

The polyalkenylene is a polymer having a main chain consisted form a structural unit containing an unsaturated double bond (a vinyl group).

The polyimide includes polyimides formed from an acid anhydride, for example, pyromellitic anhydride, biphenyltetracarboxylic anhydride, benzophenonetetracarboxylic anhydride or 2,2′-[4,4′-di(dicarboxyphenylthio)phenyl]propane dihydride and a diamine, for example, oxydiamine, paraphenylenediamine, metaphenylenediamine or benzophenonediamine.

The polyamide includes, for example, polyamide 6, polyamide 6,6 and polyamide 6,10.

The polyester includes, for example, polyethylene terephthalate and polybutylene terephthalate.

In the case where the polyanion dopant has a substituent, examples of the substituent include an alkyl group, a hydroxy group, an amino group, a carboxyl group, a cyano group, a phenyl group, a phenol group, an ester group and an alkoxy group. Considering solubility in an organic solvent, heat resistance, compatibility with a binder resin or the like, an alkyl group, a hydroxy group, a phenol group or an ester group is preferred.

The alkyl group includes, for example, a chain (strait-chain or branched) alkyl group, for example, a methyl group, an ethyl group, a propyl group, a butyl group, an isobutyl group, a tert-butyl group, a pentyl group, a hexyl group, an octyl group, a decyl group or a dodecyl group, and a cycloalkyl group, for example, a cyclopropyl group, a cyclopentyl group or a cyclohexyl group.

The hydroxy group includes a hydroxy group connected directly or through other functional group to the main chain of polyanion dopant. The other functional group includes, for example, an alkyl group having from 1 to 7 carbon atoms, an alkenyl group having from 2 to 7 carbon atoms, an amido group and an imido group. The hydroxy group may be present at a terminal of or in the functional group.

The amino group includes an amino group connected directly or through other functional group to the main chain of polyanion dopant. The other functional group includes, for example, an alkyl group having from 1 to 7 carbon atoms, an alkenyl group having from 2 to 7 carbon atoms, an amido group and an imido group. The amino group may be present at a terminal of or in the functional group.

The phenol group includes a phenol group connected directly or through other functional group to the main chain of polyanion dopant. The other functional group includes, for example, an alkyl group having from 1 to 7 carbon atoms, an alkenyl group having from 2 to 7 carbon atoms, an amido group and an imido group. The phenol group may be present at a terminal of or in the functional group.

The anionic group of the polyanion dopant include, for example, —O—SO₃⁻X⁺, —SO₃⁻X⁺ and —COO⁻X⁺ (wherein X⁺ represents a hydrogen ion or an alkali metal ion).

Of the anionic groups, —SO₃⁻X³⁰ or —COO⁻X⁺ is preferred from the standpoint of doping ability to the organic conductive polymer compound.

Of the polyanion dopants, in view of the solvent solubility and conductivity, polyisoprenesulfonic acid, a copolymer containing isoprenesulfonic acid, polysulfoethyl methacrylate, a copolymer containing sulfoethyl methacrylate, poly(4-sulfobutyl methacrylate), a copolymer containing 4-sulfobutyl methacrylate, polymethacryloxybenzenesulfonic acid, a copolymer containing methacryloxybenzenesulfonic acid, polystyrenesulfonic acid and a copolymer containing styrenesulfonic acid are preferred.

As for a polymerization degree of the polyanion dopant, a number of monomer units is preferably in a range from 10 to 100,000, and, in view of the solvent solubility and conductivity, more preferably in a range from 50 to 10,000.

The content of the polyanion dopant is preferably in arrange from 0.1 to 10 mol, and more preferably in arrange from 1 to 7 mol, per mole of the organic conductive polymer compound. The molar number as used herein is defined as a number of structural unit derived from a monomer containing an anionic group for forming the polyanion dopant and a number of structural unit derived from a monomer, for example, pyrrole, thiophene or aniline for forming the organic conductive polymer compound. When the content of polyanion dopant is 0.1 mol or more per mole of the organic conductive polymer compound, the doping effect for the organic conductive polymer compound becomes large to sufficiently exhibit the conductivity. In addition, dispersibility or solubility in a solvent increases to easily prepare a uniform dispersion. When the content of polyanion dopant is 10 mol or less per mole of the organic conductive polymer compound, the organic conductive polymer compound can be contained in a large amount to easily obtain sufficient conductivity.

The total content of the organic conductive polymer compound and polyanion dopant in the composition for forming antistatic layer is preferably from 6 to 70% by weight, more preferably from 6 to 50% by weight, most preferably from 10 to 40% by weight, based on the total solid content of the composition. When the total content of the organic conductive polymer compound and polyanion dopant is 6% by weight or more, sufficient conductivity is obtained and when it is 70% by weight or less, deterioration of the adhesion property or surface state of the coated layer hardly occur.

### (Solubility in Organic Solvent)

It is preferred that the organic conductive polymer compound is soluble in an organic solvent from the standpoint of coating property or provision of affinity with other components.

More specifically, it is preferred that the conductive polymer according to the invention is soluble at least 1.0% by weight in an organic solvent having a water content of 5% by weight or less and a dielectric constant from 2 to 30.

The term “soluble” as used herein indicates a state where the organic conductive polymer compound exists in the form of a single molecule or an association of plural single molecules in the organic solvent or a state where the organic conductive polymer compound is dispersed as a particle having a particle size of 300 nm or less in the organic solvent.

In general, the organic conductive polymer compound has a high hydrophilicity and is conventionally soluble in a solvent having water as the main component. In order to solubilize such an organic conductive polymer compound in an organic solvent, a method is exemplified where a compound which increases affinity with the organic solvent or a dispersant in the organic solvent is added to a composition containing the organic conductive polymer compound. Also, when the organic conductive polymer compound is used together with the polyanion dopant, it is preferred to conduct hydrophobilizing treatment of the polyanion dopant as described below.

Further, a method is also used where the organic conductive polymer compound is used in an undoped state to increase the solubility in organic solvent and after the formation of a layer the dopant is added to generate conductivity.

In addition to the above, methods described in the references described below are also preferably used as the method of increasing the solubility in organic solvent.

For instance, in JP-A-2002-179911 a method is described where a polyaniline composition is dissolved in an organic solvent in an undoped state, the material is coated on a base material and dried, and then subjected to oxidation and doping treatments with a solution in which a protonic acid and an oxidizing agent are dissolved or dispersed to generate conductivity.

Also, in WO 05/035626 a method of producing a conductive polyaniline capable of being stably dispersed in an organic solvent is described where in oxidation polymerization of aniline or a derivative thereof in a mixed phase composed of an aqueous phase and an organic phase in the presence of at least one of a sulfonic acid and a water-insoluble organic polymer compound having a protonic acid group, a molecular weight modifier and, if desired, a phase-transfer catalyst are caused to coexist.

As the organic solvent, for example, an alcohol, an aromatic hydrocarbon, an ether, a ketone and an ester are preferred. Specific examples of the organic solvent are set forth below. The dielectric constant of each organic solvent is also shown in parentheses.

The alcohol includes, for example, a monohydric alcohol and a dihydric alcohol. The monohydric alcohol is preferably a saturated aliphatic alcohol having from 2 to 8 carbon atoms. Specific examples of such an alcohol include ethyl alcohol (25.7), n-propyl alcohol (21.8), isopropyl alcohol (18.6), n-butyl alcohol (17.1), sec-butyl alcohol (15.5) and tert-butyl alcohol (11.4).

Specific examples of the aromatic hydrocarbon include benzene (2.3), toluene (2.2) and xylene (2.2). Specific examples of the ether include tetrahydrofuran (7.5), ethylene glycol monomethyl ether (16), ethylene glycol monomethyl ether acetate (8), ethylene glycol monoethyl ether (14), ethylene glycol monoethyl ether acetate (8) and ethylene glycol monobutyl ether (9). Specific examples of the ketone include acetone (21.5), diethyl ketone (17.0), methyl ethyl ketone (15.5), diacetone alcohol (18.2), methyl isobutyl ketone (13.1) and cyclohexanone (18.3). Specific examples of the ester include methyl acetate (7.0), ethyl acetate (6.0), propyl acetate (5.7) and butyl acetate (5.0).

From the standpoint that both the organic conductive polymer compound and the fluorine-containing curable compound can be dissolved or dispersed, the dielectric constant is preferably from 2.2 to 25.4, more preferably from 2.3 to 24, still more preferably from 4.0 to 21, and most preferably from 5.0 to 21. For example, isopropyl alcohol, acetone, propylene glycol monoethyl ether, cyclohexanone and methyl acetate are preferred and isopropyl alcohol, acetone, propylene glycol monoethyl ether are particularly preferred.

The dielectric constant as used herein is a value measures at 20° C.

In the invention, the organic solvent having a dielectric constant from 2 to 30 may be used as a mixture of two or more thereof. Although an organic solvent having a dielectric constant higher than 30 or not more than 5% by weight of water may be used together with the above-described organic solvent, it is preferred that in a mixed organic solvent system containing the above-described organic solvent, a weight average dielectric constant of plural organic solvent and water is not exceed 30 (30 or less). In the range described above, a coating composition containing both the organic conductive polymer compound and the fluorine-containing curable compound dissolved or dispersed therein can be formed, thereby preparing a laminate having a good surface state of the coated layer.

According to the invention, the organic conductive polymer compound is soluble at least 1.0% by weight in the organic solvent.

In the organic solvent, the organic conductive polymer compound may be present in the form of particle. In this case, an average particle size of the particle is preferably 300 nm or less, more preferably 200 nm or less, and still more preferably 100 nm or less. By controlling the average particle size to the range described above, sedimentation of the particle can be prevented. The lower limit of the particle size is not particularly restricted.

In order to remove coarse particles or to promote dissolution, a high pressure disperser may be used. Examples of the high pressure disperser include Gaulin (produced by APV Gaulin), Nanomizer (produced by Nanomizer Inc.), Microfluidizer (produced by Microfluidics Corp.), Multimizer (produced by Sugino Machine Ltd.) and DeBEE (produced by BEE). The particle size is determined by skimming the organic solvent solution with a grid for an electron microscope and observing after the volatilization of the solvent.

In the case of using the polyanion dopant together with the organic conductive polymer compound as described above, it is preferred that the composition containing the organic conductive polymer compound and the polymer dopant is subjected to a hydrophobilizing treatment. By performing the hydrophobilizing treatment of the composition, solubility of the organic conductive polymer compound in an organic solvent can be increased to improve the affinity to the fluorine-containing curable compound (B). The hydrophobilizing treatment can be performed by modifying an anionic group of the polyanion dopant.

Specifically, a first method of the hydrophobilizing treatment includes, for example, a method of esterification, etherification, acetylation, tosylation, tritylation, alkylsilylation or alkylcarbonylation of the anionic group. Among them, the esterification or etherification is preferred. The method of hydrophobilization by the esterification includes a method where an anionic group of the polyanion dopant is chlorinated with a chlorinating agent and then esterified with an alcohol, for example, methanol or ethanol. Also, using both a compound having a hydroxy group or a glycidyl group and an unsaturated double bond group, esterification is conducted with a sulfo group or a carboxyl group to hydrophobilize.

In the invention, heretofore known various methods can be used and examples thereof are specifically described, for example, in JP-A-2005-314671 and JP-A-2006-28439.

A second method of the hydrophobilizing treatment includes a method of connecting a basic compound to an anionic group of the polyanion dopant to conduct hydrophobilization. The basic compound is preferably an amine compound and includes, for example, a primary amine, a secondary amine, a tertiary amine or an aromatic amine. Specific examples thereof include a primary, secondary or tertiary amine substituted with an alkyl group having from 1 to 20 carbon atoms, imidazole substituted with an alkyl group having from 1 to 20 carbon atoms and pyridine. For the purpose of increasing solubility in organic solvent, a molecular weight of the amine compound is preferably from 50 to 2,000, more preferably from 70 to 1,000, and most preferably from 80 to 500.

An amount of the amine compound as the basic hydrophobilizing agent is preferably from 0.1 to 10.0 molar equivalents, more preferably from 0.5 to 2.0 molar equivalents, particularly preferably from 0.85 to 1.25 molar equivalents, based on the anionic groups of polyanion dopant which do not contribute to doping of the organic conductive polymer compound. In the range described above, the solubility in organic solvent, conductivity and strength of the coated layer can be fulfilled.

Further, with respect to the details of the hydrophobilizing treatment, descriptions, for example, in JP-A-2008-115215 and JP-A-2008-115216 can be referred to.

### (Solubilization Aid)

The organic conductive polymer compound may be used together with a compound (hereinafter referred to as a solubilization aid) containing a hydrophilic moiety and a hydrophobic moiety and preferably, an ionizing radiation curable functional group in its molecule.

By using the solubilization aid, the solubilization of the organic conductive polymer compound in an organic solvent having a low water content is assisted and further improvement in the surface state of the coated layer and increase in the strength of the cured layer are achieved in the layer formed from the composition according to the invention.

The solubilization aid is preferably a copolymer containing a hydrophilic moiety, a hydrophobic moiety and an ionizing radiation curable functional group, and particularly preferably a block type or graft type copolymer wherein these moieties are separately present as respective segments. Such a copolymer may be obtained by living anion polymerization, living radical polymerization or polymerization using a macromonomer having the moiety described above.

The solubilization aid is described, for example, in Paragraph Nos. [0022] to [0038] of JP-A-2006-176681.

### (Low Molecular Weight Dopant)

According to the invention, a low molecular weight dopant is preferably used in addition to the polyanion dopant. The low molecular weight dopant is a compound having a molecular weight of 1,000 or less and two or less anionic groups in its molecule. Among them, it is preferred to contain at least one compound selected from 2-acrylamido-2-methyl-1-propanesulfonic acid, sodium 1,1-oxybistetrapropylene derivative benzenesulfonate and vinylallylsulfonic acid. An amount of the low molecular weight dopant is preferably from 0.01 to 5% by mole, more preferably from 0.1 to 3% by mole, per mole of the π-conjugated system conductive polymer.

### (Preparation Method of Solution Containing Organic Conductive Polymer Compound)

The organic conductive polymer compound is prepared in the form of a solution thereof using the organic solvent described above.

Although several methods are known for the preparation of a solution of the organic conductive polymer compound, three methods shown below are preferred.

A first method is a method comprising polymerizing a organic conductive polymer compound in water in the presence of a polyanion dopant, then, if desired, treating by adding the solubilization aid or basic hydrophobilizing agent described above, and thereafter replacing the water with the organic solvent. A second method is a method comprising polymerizing a organic conductive polymer compound in water in the presence of a polyanion dopant, then, if desired, treating by adding the solubilization aid or basic hydrophobilizing agent described above, evaporating the water to dryness, and thereafter adding the organic solvent to solubilize. A third method is a method comprising preparing separately a π-conjugated system conductive polymer and a polyanion dopant, mixing and dispersing the both in a solvent to prepare a dope of a conductive polymer composition, and replacing water with the organic solvent when the solvent contains the water.

In the methods described above, an amount of the solubilization aid used is preferably from 1 to 100% by weight, more preferably from 2 to 70% by weight, most preferably from 5 to 50% by weight, based on the total amount of the organic conductive polymer compound and polyanion dopant. In the first method, the method of replacing water with the organic solvent is preferably a method of adding a highly water-miscible solvent, for example, ethanol, isopropyl alcohol or acetone to prepare a uniform solution and removing the water by ultrafiltration. Also, a method of lowering the water content to some extent by adding a highly water-miscible solvent, mixing a more hydrophobic solvent and removing the highly volatile component under a reduced pressure to prepare a solvent composition is exemplified. Further, it is also possible that when the hydrophobilization is sufficiently conducted using the basic hydrophobilizing agent, an organic solvent of low miscibility with water is added to form a separated two phases system and the organic conductive polymer compound in the aqueous phase is extracted to the organic solvent phase.

### [(C) Fluorine-Containing Curable Compound]

According to the invention, a fluorine-containing curable compound (C) may be used in addition to the conductive polymer (A) in the antistatic layer as a binder component of the antistatic layer or for the purpose of increasing the uneven distribution ratio of the conductive polymer in the antistatic layer to increase the conductivity (to reduce log SR). Also, in order to improve the antireflective performance of the laminate according to the invention, it is preferred to reduce the refractive index of the layer by the fluorine-containing curable compound. Specifically, the antistatic layer preferably contains a cured compound of the fluorine-containing curable compound (C).

The fluorine-containing curable compound according to the invention may be any of a polymer and a monomer. In case of using the fluorine-containing polymer, a polymer having a molecular weight of 1,000 or more and containing a fluorine-containing moiety and a moiety having a functional group capable of being involved in a crosslinking reaction is preferred. On the other hand, in case of using the fluorine-containing monomer, a polymerizable group of a polyfunctional fluorine-containing monomer is preferably any one group selected from an acryloyl group, a methacryloyl group and —C(O)OCH═H₂.

Also, the fluorine-containing polymer and the fluorine-containing monomer may be used in combination. The fluorine-containing polymer and the fluorine-containing monomer will be described in detail below.

### [Fluorine-Containing Polymer]

The fluorine-containing polymer preferably has a structure represented by formula (10) shown below.

(MF1)ₐ-(MF2)_{b}-(MF3)_{c}-(MA)_{d}-(MB)ₑ Formula (10)

In formula (10), a to e each represents a mole fraction of each constituting component and represents a value satisfying 30≦a+b≦70, 0≦c≦50, 5≦d≦50, 0≦e≦40, 0≦a≦70 and 0≦b≦50.

(MF1) represents a constituting component polymerized from a monomer represented by CF₂═CF-Rf₁, wherein Rf₁ represents a perfluoroalkyl group having from 1 to 5 carbon atoms.

(MF2) represents a constituting component polymerized from a monomer represented by CF₂═CF—ORf₁₂, wherein Rf₁₂ represents a fluorine-containing alkyl group having from 1 to 30 carbon atoms.

(MF3) represents a constituting component polymerized from a monomer represented by CH₂═CH—ORf₁₃, wherein Rf₁₃ represents a fluorine-containing alkyl group having from 1 to 30 carbon atoms.

(MA) represents a constituting component having at least one crosslinkable group.

(MB) represents an optional constituting component.

Monomers (compounds represented by formulae (10-1) to (10-3)) in (MF1) to (MF2) will be described below.

CF₂═CF-Rf₁ Formula (10-1)

In formula (10-1), Rf₁ represents a perfluoroalkyl group having from 1 to 5 carbon atoms.

As the compound of formula (10-1), perfluoropropylene or perfluorobutylene is preferred from the standpoint of polymerization reactivity, and perfluoropropylene is particularly preferred from the standpoint of availability.

CF₂═CF-Rf₁₂ Formula (10-2)

In formula (10-2), Rf₁₂ represents a fluorine-containing alkyl group having from 1 to 30 carbon atoms. The fluorine-containing alkyl group may have a substituent. Rf₁₂ is preferably a fluorine-containing alkyl group having from 1 to 20 carbon atoms, more preferably a fluorine-containing alkyl group having from 1 to 10 carbon atoms, and still more preferably a perfluoroalkyl group having from 1 to 10 carbon atoms. Specific examples of Rf₁₂ are set forth below, but the invention should not be construed as being limited thereto.

—CF₃, —CF₂CF₃, —CF₂CF₂CF₃, —CF₂CF(OCF₂CF₂CF₃)CF₃ CH₂═CH—ORf₁₃ Formula (10-3)

In Formula (10-3), Rf₁₃ represents a fluorine-containing alkyl group having from 1 to 30 carbon atoms. The fluorine-containing alkyl group may have a substituent. Rf₁₃ may have a straight-chain or branched structure. Also, Rf₁₃ may have an alicyclic structure (preferably a 5-membered ring or a 6-membered ring). Further, Rf₁₃ may have an ether bond between the carbon-carbon linkage. Rf₁₃ is preferably a fluorine-containing alkyl group having from 1 to 20 carbon atoms, and more preferably a fluorine-containing alkyl group having from 1 to 15 carbon atoms. Specific examples of Rf₁₃ are set forth below, but the invention should not be construed as being limited thereto.

### (Straight-Chain Structure)

—CF₂CF₃, —CH₂(CF₂)ₐH, —CH₂CH₂(CF₂)ₐF (a represents an integer from 2 to 12)

### (Branched Structure)

—CH(CF₃)₂, —CH₂CF(CF₃)₂, —CH(CH₃)CF₂CF₃, —CH(CH₃)(CF₂)₅CF₂H

### (Alicyclic Structure)

a perfluorocyclohexyl group, a perfluorocyclopentyl group, alkyl groups substituted therewith

### (Others)

—CH₂OCH₂CF₂CF₃, —CH₂CH₂OCH₂(CF₂)_{b}H, —CH₂CH₂OCH₂(CF₂)_{b}F (b represents an integer from 2 to 12), —CH₂CH₂OCF₂CF₂OCF₂CF₂H

In addition, as the monomer represented by formula (10-3), compounds described in Paragraph Nos. [0025] to [0033] of JP-A-2007-298974 are used.

(MA) in formula (10) represents a constituting component having at least one crosslinkable group (reactive group capable of being involved in crosslinking reaction).

The crosslinkable group includes, for example, a silyl group having a hydroxy group or a hydrolysable group (for example, an alkoxysilyl group or an acyloxysilyl group), a group having a reactive unsaturated double bond (for example, a (meth)acryloyl group, an allyl group or a vinyloxy group), a ring opening polymerization reactive group (for example, an epoxy group, an oxetanyl group or an oxazolyl group), a group having an active hydrogen atom (for example, a hydroxy group, a carboxyl group, an amino group, a carbamoyl group, a mercapto group, a β-ketoester group, a hydrosilyl group or a silanol group), and a group capable of being substituted with an acid anhydride or a nucleophilic agent (for example, an active halogen atom or a sulfonic acid ester).

The crosslinkable group in (MA) is preferably a group having a reactive unsaturated double bond or a ring opening polymerization reactive group, and more preferably a group having a reactive unsaturated double bond.

Preferable specific examples of the constituting component represented by (MA) in formula (10) are set forth below, but the invention should not be construed as being limited thereto.

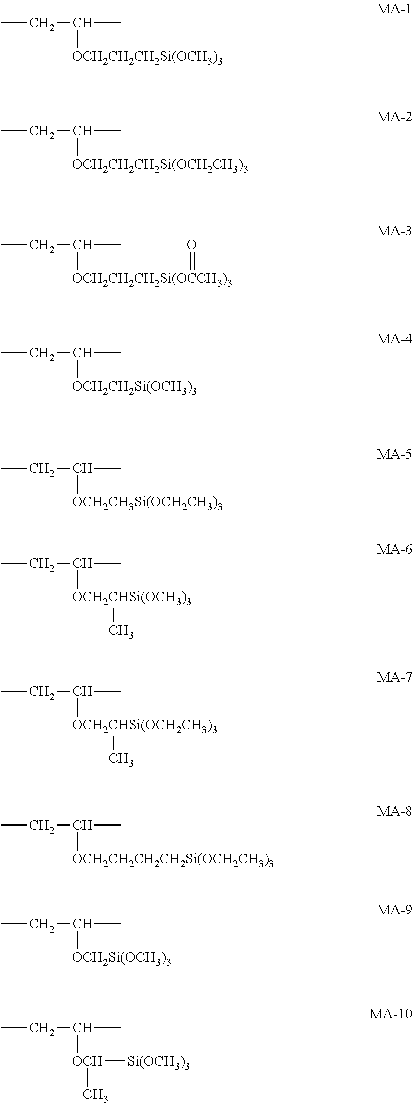

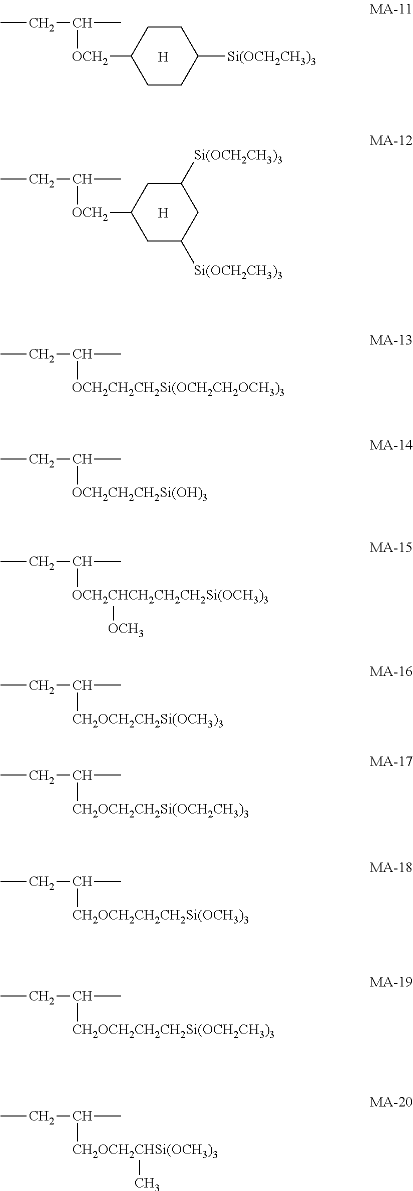

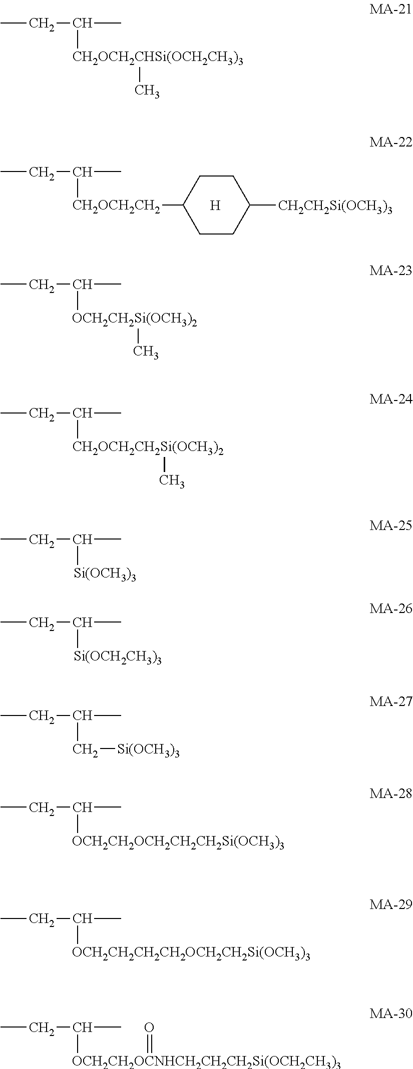

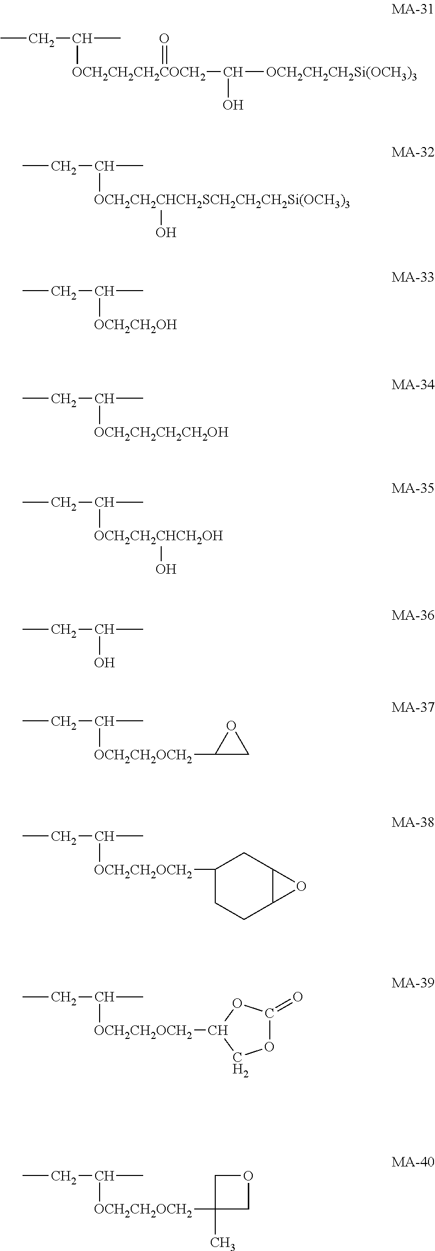

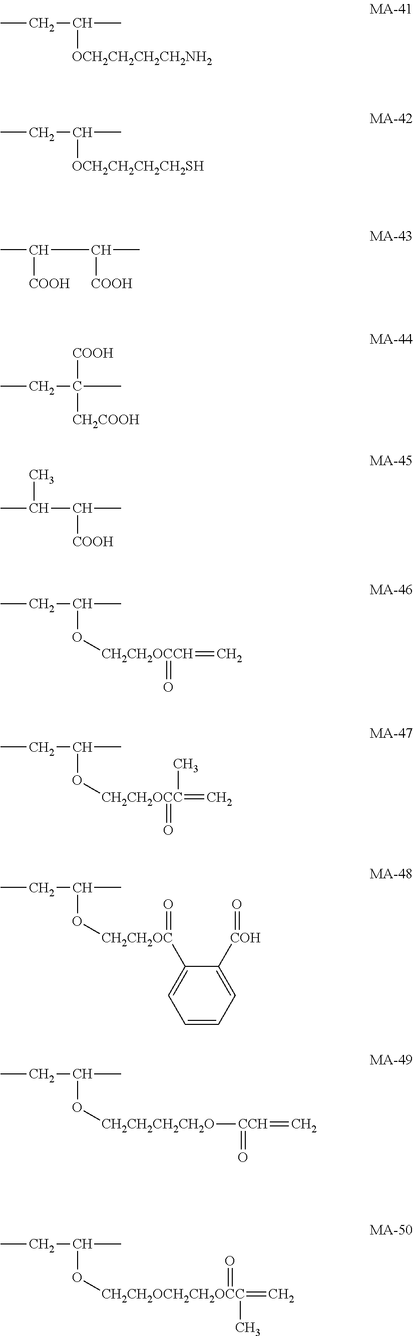

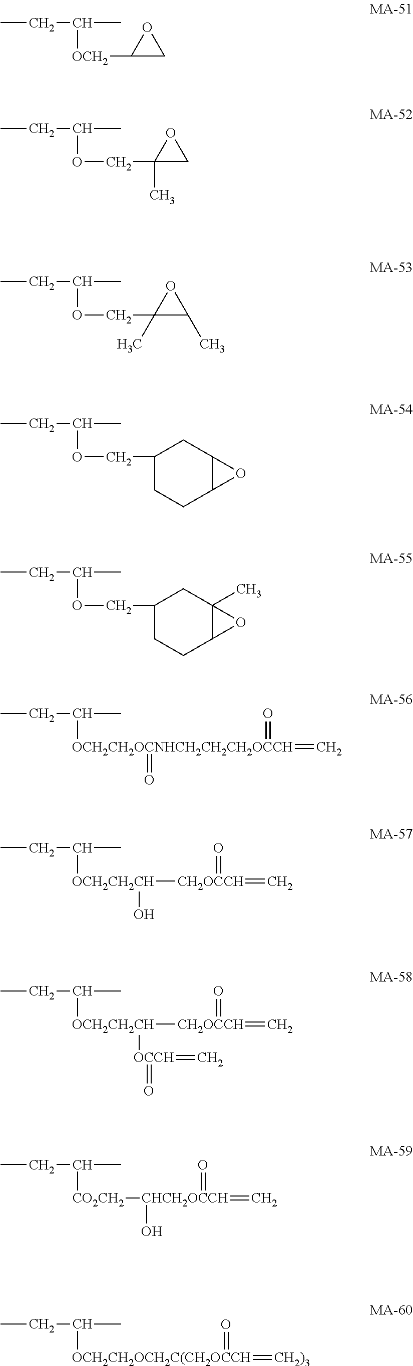

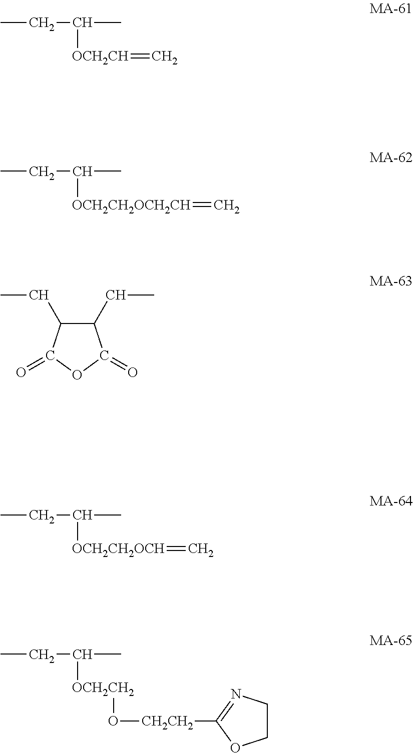

(MB) in formula (10) represents an optional constituting component. (MB) is not particularly restricted as far as it is a constituent component of a monomer copolymerizable with monomers represented by (MF1) and (MF2) and a monomer forming a constituent component represented by (MA), and can be appropriately selected in view of various points, for example, adhesion property to a base material, Tg of polymer (contributing to film hardness), solubility in a solvent, transparency, sliding property, dust resistance or antifouling property.

Examples of the monomer for forming (MB) include a vinyl ester, for example, methyl vinyl ether, ethyl vinyl ether, n-butyl vinyl ether, cyclohexyl vinyl ether or isopropyl vinyl ether and a vinyl ester, for example, vinyl acetate, vinyl propionate, vinyl butyrate or vinyl cyclohexanecarboxylate.

It is preferred that (MB) contains a constituting component having a polysiloxane structure. By introducing the polysiloxane structure into (MB), the conductive polymer can be unevenly distributed in the lower region of the optical film such as an antireflective film to improve the slipping property and antifouling property of the optical film such as an antireflective film.

More specifically, it is preferred that (MB) contains a polysiloxane repeating unit represented by formula (20) shown below in its main chain or side chain.

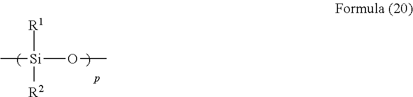

In formula (20), R′ and R² each independently represents an alkyl group or aryl group.

The alkyl group preferably has from 1 to 4 carbon atoms. Specific examples thereof include a methyl group, a trifluoromethyl group and an ethyl group.

The aryl group preferably has from 6 to 20 carbon atoms. Specific examples thereof include a phenyl group and a naphthyl group.

R¹ and R² each preferably represents a methyl group or a phenyl group, and more preferably a methyl group.

p represents an integer from 2 to 500, preferably from 5 to 350, and more preferably from 8 to 250.

The polymer having a polysiloxane structure represented by formula (20) in its side chain can be synthesized as described, for example, in J. Appl. Polym. Sci., 2000, 78, 1955 and JP-A-56-28219, by a method where into a polymer having a reactive group (for example, an epoxy group, a hydroxy group, a carboxyl group or an acid anhydride group), a polysiloxane having a counterpart reactive group (for example, an amino group, a mercapto group, a carboxyl group or a hydroxyl group for an epoxy group or an acid anhydride group) in its one terminal (for example, SILAPLANE series (produced by Chisso Corp.)) is introduced by a polymer reaction, or a method of polymerization of a polysiloxane-containing silicon macromer.

The polymer having a polysiloxane structure represented by formula (2) in its main chain can be synthesized by a method using polymer initiator, for example, an azo group-containing polysiloxaneamide described in JP-A-6-93100 (commercially available product: for example, VPS-0501 or VPS-1001, produced by Wako Pure Chemical Industries, Ltd.), a method where a reactive group derived from a polymerization initiator or a chain transfer agent (for example, a mercapto group, a carboxyl group or a hydroxyl group) is introduced into a terminal of a polymer and then, the resulting polymer is reacted with a polysiloxane containing one terminal or both terminal reactive groups (for example, an epoxy group or an isocyanate group), or a method where a cyclic siloxane oligomer, for example, hexamethylcyclotrisiloxane is copolymerized by anionic ring opening polymerization. Among them, the method of using an initiator having a polysiloxane partial structure is easy and preferred.

In formula (10), a to e each represents a mole fraction of each constituting component and represents a value satisfying 30≦a+b≦70, 0≦c≦50, 5≦d≦50, 0≦e≦40, 0≦a≦70 and 0≦b≦50.

In order to attain low refractive index, it is desired to increase the mole fractions (%) a+b of the component (MF1) and the component (MF2), however, an introduction ratio of about 50 to about 70% is an upper limit and a value higher than this is ordinarily difficult in a conventional solution type radical polymerization reaction in view of the polymerization reactivity. In the invention, a lower limit of a+b is preferably 40% or more, and more preferably 45% or more.

The introduction of (MF3) also contributes to the attainment of low refractive index. The mole fraction c of the component (MF3) is 0≦c≦50 as described above, and preferably 5≦c≦20.

The sum (a+b+c) of the mole fractions of the fluorine-containing monomer components is preferably in a range of 40≦a+b+c≦90, and more preferably in a range of 50≦a+b+c≦75.

When the proportion of the polymer unit represented by (MA) is too small, the strength of cured layer decreases. According to the invention, the mole fraction of the component (MA) is preferably in a range of 5≦d≦40, and particularly preferably in a range of 15≦d≦30.

The mole fraction e of the optional constituting component represented by (MB) is preferably in a range from 0≦e≦20, and particularly preferably in a range from 0≦e≦10.

According to the invention, it is preferred that the fluorine-containing polymer has a functional group of high polarity in its molecule from the standpoint of improvement in surface state of the coated layer, increase in conductivity and improvement in scratch resistance of the layer. Therefore, it is preferred the component (MB) has a functional group of high polarity in its molecule. As the functional group of high polarity, a hydroxy group, an alkylether group, a silanol group, a glycidyl group, an oxatanyl group, a polyalkylene oxide group or a carboxyl group is preferred, and a hydroxy group, an alkylether group or a polyalkylene oxide group is more preferred. A content of the polymerization unit having the functional group is preferably from 0.1 to 15%, more preferably from 1 to 10%, in terms of mole fraction.

As described above, it is preferred to introduce a polysiloxane structure into the fluorine-containing polymer from the standpoint of the surface state of the coated layer and scratch resistance. By introducing the polysiloxane structure into the fluorine-containing polymer, the upper region segregation of the fluorine-containing polymer can be increased and as a result, the lower region segregation of the organic conductive compound is accelerated to result in increase in the conductivity. A content of the polysiloxane structure in the fluorine-containing polymer is preferably from 0.5 to 15% by weight, more preferably from 1 to 10% by weight, in the polymer.

A number average molecular weight of the fluorine-containing polymer is preferably from 1,000 to 1,000,000, more preferably 5,000 to 500,000, and still more preferably from 10,000 to 100,000.

The number average molecular weight as used herein is a molecular weight determined by a differential refractive index detector using a GPC analyzer with a column of TSKgel GMHxL, TSKgel G40001HxL, TSKgel G2000HxL (produced by Tosoh Corp.) and THF as a solvent and calculated in terms of polystyrene.

Specific examples of the copolymer represented by formula (10) are set forth below, but the invention should not be construed as being limited thereto. In Table 1 below, there are described combinations of monomers (MF1), (MF2), (MF3), (MA) and (MB) which form the fluorine-containing polymer represented by formula (10) by polymerization. Also, a to e each represents a mole ratio (%) of monomer of each component. Further, with respect to the component(s) other than EVE in the column of “(MB)”, content(s) (percent by weight: wt %) of the component(s) in the polymer are indicated in the order from the left to the right in the column “e”.

TABLE 1

| | | | | | | | | | | | Molecular |
|---|---|---|---|---|---|---|---|---|---|---|---|
| | | | | | | | | | | | Weight |
| | (MF1) | (MF2) | (MF3) | (MA) | (MB) | a | b | c | d | e | (×10⁴) |
| P-1 | HFP | — | — | MA-33 | EVE | 50 | 0 | 0 | 20 | 30 | 3.1 |
| P-2 | HFP | — | — | MA-33 | EVE/VPS-1001 | 50 | 0 | 0 | 20 | 30/4 wt % | 3.2 |
| P-3 | HFP | — | — | MA-33 | EVE/FM-0721 | 50 | 0 | 0 | 20 | 30/4 wt % | 2.9 |
| P-4 | HFP | — | — | MA-33 | EVE/VPS-1001/NE-30 | 50 | 0 | 0 | 20 | 30/4 wt %/1 wt % | 3.4 |
| P-5 | HFP | FFVE | — | MA-33 | EVE/VPS-1001/NE-30 | 40 | 10 | 0 | 20 | 30/4 wt %/1 wt % | 3.2 |
| P-6 | HFP | FFVE | — | MA-35 | EVE/VPS-1001 | 40 | 10 | 0 | 15 | 35/4 wt % | 2.7 |
| P-7 | HFP | FFVE | — | MA-34 | EVE/VPS-1001/NE-30 | 40 | 10 | 0 | 25 | 25/4 wt %/1 wt % | 3.1 |
| P-8 | HFP | FFVE | MF3-1 | MA-33 | EVE/NE-30 | 40 | 10 | 10 | 25 | 15/1 wt % | 3.3 |
| P-9 | HFP | FFVE | MF3-2 | MA-33 | EVE/FM-0721 | 40 | 10 | 10 | 25 | 15/4 wt % | 3.4 |
| P-10 | HFP | — | — | MA-37 | EVE/VPS-1001 | 50 | 0 | 0 | 25 | 25/4 wt % | 3.2 |
| P-11 | HFP | — | — | MA-46 | — | 50 | 0 | 0 | 50 | 0 | 3.3 |
| P-12 | HFP | — | — | MA-33/MA-46 | — | 50 | 0 | 0 | 15/35 | 0 | 3.2 |
| P-13 | HFP | — | — | MA-33/MA-46 | EVE | 50 | 0 | 0 | 10/35 | 5 | 3.5 |
| P-14 | HFP | — | — | MA-33/MA-46 | EVE/VPS-1001 | 50 | 0 | 0 | 10/35 | 5/4 wt % | 3.6 |
| P-15 | HFP | — | — | MA-33/MA-46 | EVE/VPS-1001/NE-30 | 50 | 0 | 0 | 10/35 | 5/1 wt %/4 wt % | 3.4 |
| P-16 | HFP | FFVE | — | MA-33/MA-46 | EVE/VPS-1001 | 40 | 10 | 0 | 10/35 | 5/4 wt % | 3.1 |
| P-17 | HFP | FFVE | MF3-1 | MA-33/MA-46 | EVE/VPS-1001 | 40 | 10 | 5 | 5/35 | 5/4 wt % | 3.5 |
| P-18 | HFP | FFVE | MF3-1 | MA-33/MA-46 | EVE/FM-0721/NE-30 | 40 | 10 | 5 | 5/35 | 5/1 wt %/4 wt % | 3.0 |
| P-19 | HFP | — | — | MA-35/MA-58 | EVE/VPS-1001 | 50 | 0 | 0 | 5/35 | 10/4 wt % | 3.3 |
| P-20 | HFP | — | — | MA-33/MA-56 | EVE/VPS-1001 | 50 | 0 | 0 | 5/35 | 10/4 wt % | 3.4 |

The abbreviations used in Table 1 are explained below. Component (MF1)

HFP: Hexafluoropropylene

### Component (MF2)

FPVE: Perfluoropropyl vinyl ether

### Component (MF3)

MF3-1: CH₂═CH—O—CH₂CH₂—O—CH₂(CF₂)₄H

MF3-2: CH₂═CH—O—CH₂CH₂(CF₂)₈F

### Component (MB)

EVE: ethyl vinyl ether

VPS-1001: Azo group-containing polydimethylsiloxane (molecular weight of polysiloxane portion: about 10,000), produced by Wako Pure Chemical Industries, Ltd.

FM-0721: Methacryloyl-modified dimethylsiloxane (average molecular weight: 5,000), produced by Chisso Corp.

NE-30: Reactive nonionic emulsifier containing an ethylene oxide portion, produced by ADEKA Corp.

When the fluorine-containing polymer contains a silyl group having a hydrolyzable group (a hydrolyzable silyl group) as the crosslinkable group, a known acid or base catalyst may be incorporated as a catalyst for a sol gel reaction. The amount of the curing catalyst may be varied depending on the kind of the catalyst or difference of the curing-reactive moiety and in general, it is preferably form about 0.1 to about 15% by weight, more preferably from about 0.5 to about 5% by weight, based the total solid content of the coating composition.

Also, when the fluorine-containing polymer contains a hydroxy group as the crosslinkable group, the composition according to the invention preferably contains a compound (curing agent) capable of reacting with the hydroxy group in the fluorine-containing polymer.

The curing agent has preferably two or more, more preferably four or more, moieties reacting with the hydroxy group.

The structure of the curing agent is not particularly restricted as far as it has the above-described number of functional groups capable of reacting with a hydroxy group. Examples thereof include a polyisocyanate, a partial condensate or multimer of isocyanate compound, an addition product with a polyhydric alcohol or a low molecular weight polyester film, a blocked polyisocyanate compound in which an isocyanate group is blocked with a blocking agent, for example, phenol, an aminoplast, a polybasic acid or anhydride thereof.

As the curing agent, an aminoplast capable of undergoing a crosslinking reaction with a hydroxy group-containing compound under an acidic condition is preferred from the standpoint of compatibility between stability in preservation and activity of crosslinking reaction and the standpoint of strength of the layer formed. The aminoplast is a compound containing an amino group which is capable of reacting with a hydroxy group present in the fluorine-containing polymer, specifically, a hydroxyalkylamino group or an alkoxyalkylamino group, or a carbon atom adjacent to a nitrogen atom and substituted with an alkoxy group. Specifically, for example, a melamine compound, a urea compound or a benzoguanamine compound is exemplified.

The melamine compound is ordinarily known as a compound having a skeleton in which a nitrogen atom is connected to a triazine ring, and specifically includes melamine, alkylated melamine, methylolmelamine and alkoxylated methylmelamine. In particular, methylolated melamine and alkoxylated methylmelamine obtained by reacting melamine and formaldehyde under a basic condition and derivatives thereof are preferred, and alkoxylated methylmelamine is particularly preferred from the standpoint of preservation stability. The methylolated melamine and alkoxylated methylmelamine are not particularly restricted, and various kinds of resins obtained by a method as described, for example, in Plascic Zairyo kouza, (Plastic Material Course) [8 ] Urea•Melamine Resin, The Nikkan Kogyo Shimbun Ltd. may also be used.

As the urea compound, in addition to urea, polymethylolated urea and alkoxylated methyl urea which is a derivative thereof, and a compound having a glycol uryl skeleton or 2-imidazolidinone skeleton which is a cyclic urea structure are also preferred. With respect to the amino compound, for example, the urea derivative, various resins described, for example, in Urea•Melamine Resin described above may be used.

As a compound which is suitably used as the curing agent, a melamine compound and a glycol uryl compound are particularly preferred from the standpoint of compatibility with the fluorine-containing polymer. In particular, it is preferred from the standpoint of reactivity that the curing agent is a compound containing a nitrogen atom and two or more carbon atoms substituted with an alkoxy group adjacent to the nitrogen atom. Particularly preferable compounds are compounds having structures represented by H-1 and H-2 shown below, and partial condensates thereof.

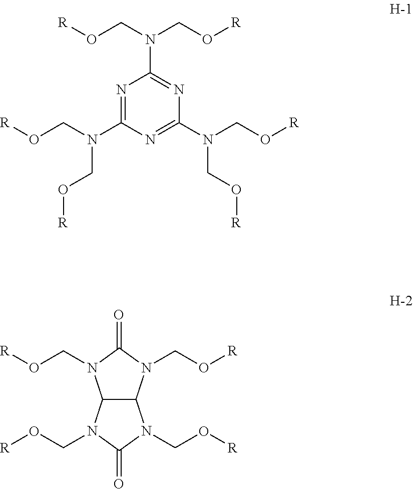

In the formulae, R represents an alkyl group having from 1 to 6 carbon atoms or a hydroxy group.

The amount of the aminoplast to the fluorine-containing polymer is preferably from 1 to 50 parts by weight, more preferably from 3 to 40 parts by weight, still more preferably from 5 to 30 parts by weight, based on 100 parts by weight of the fluorine-containing polymer. When the amount is 1 part by weight or more, durability as a thin layer can be sufficiently exhibited, whereas when it is 50 parts by weight or less, a low refractive index can be maintained and thus, the above-described range is preferred.

In the reaction of the fluorine-containing polymer containing a hydroxy group and the curing agent, it is preferred to use a curing catalyst. In the system, since the curing is promoted by an acid, it is desired to use an acidic substance as the curing catalyst. However, when a conventional acid is added, the crosslinking reaction also progresses in the coating solution to cause failure (for example, unevenness or repellency). Therefore, in order to achieve both the preservation stability and curing activity in the thermo-curing system, it is more preferred to add a compound generating an acid by heating or a compound generating an acid by light as the curing catalyst. Specific compounds are described in Paragraph Nos. [0220] to [0230] of JP-A-2007-298974.

### [Fluorine-Containing Monomer]

The fluorine-containing monomer is a compound having an atomic group (hereinafter, also referred to as a “fluorine-containing core portion”) mainly composed of plural fluorine atoms and carbon atoms (provided that oxygen atom(s) and/or hydrogen atom(s) may partially contained), which is not substantially involved in polymerization, and a polymerizable group, for example, a radical polymerizable group, an ionic polymerizable group or a condensation polymerizable group, through a connecting group, for example, an ester bond or an ether bond. The fluorine-containing monomer is preferred to have two or more polymerizable groups.

The fluorine-containing monomer is preferably a compound (polymerizable fluorine-containing compound) represented by formula (1) shown below.

Rf{-(L)ₘ-Y}ₙ Formula (I)

In formula (I), Rf represents an n-valent chained or cyclic group containing at least a carbon atom and a fluorine atom, which may contain any of an oxygen atom and a hydrogen atom, n represents an integer of 2 or more, L represents a single bond or a divalent connecting group, m represents 0 or 1, and Y represents a polymerizable group.

In formula (I), Y represents a polymerizable group. Y is preferably a radical polymerizable group, an ionic polymerizable group or a condensation polymerizable group, more preferably a polymerizable unsaturated group or a ring-opening polymerizable group, and still more preferably a polymerizable unsaturated group. Specifically, a group selected from a (meth)acryloyl group, an allyl group, an alkoxysilyl group, an α-fluoroacryloyl group, an epoxy group and —C(O)OCH═CH₂ is further more preferred. Among them, from the standpoint of polymerizability, a (meth)acryloyl group, an ally group, an α-fluoroacryloyl group, an epoxy group or —C(O)OCH═CH₂ each having radical polymerizability or ionic polymerizability is more preferred, a (meth)acryloyl group, an allyl group, an α-fluoroacryloyl group or —C(O)OCH═CH₂ each having radical polymerizability is particularly preferred, and a (meth)acryloyl group or —C(O)OCH═CH₂ is most preferred.

The polymerizable fluorine-containing compound may be a crosslinking agent in which the polymerizable group is a crosslinkable group.

The crosslinkable group includes, for example, a silyl group having a hydroxy group or a hydrolyzable group (for example, an alkoxysilyl group or acyloxysilyl group), a group having a reactive unsaturated double bond (for example, a (meth)acryloyl group, an allyl group or a vinyloxy group), a ring opening polymerization reactive group (for example, an epoxy group, an oxetanyl group or an oxazolyl group), a group having an active hydrogen atom (for example, a hydroxy group, a carboxyl group, an amino group, a carbamoyl group, a mercapto group, a β-ketoester group, a hydrosilyl group or a silanol group), and a group capable of being substituted with an acid anhydride or a nucleophilic agent (for example, an active halogen atom or a sulfonic acid ester).

L represents a single bond or a divalent connecting group, and is preferably an alkylene group having from 1 to 10 carbon atoms, an arylene group having from 6 to 10 carbon atoms, —O—, —S—, —N(R)— or a divalent connecting group obtained by the combination of two or more of these groups. In the formula above, R represents a hydrogen atom or an alkyl group having from 1 to 5 carbon atoms.

When L represents an alkylene group or an arylene group, the alkylene group or arylene group represented by L is preferably substituted with a halogen atom, and more preferably substituted with a fluorine atom.

The term “calculated value of intercrosslink molecular weight” means a total atomic weight of all atomic groups sandwiched between (a) and (a), (b) and (b), or (a) and (b), when all polymerizable groups in the polymerizable fluorine-containing compound undergo polymerization to form a polymer, wherein (a) is a carbon atom substituted with 3 or more carbon atoms and/or silicon atoms and/or oxygen atoms in total and (b) is a silicon atom substituted with 3 or more carbon atoms and/or oxygen atoms in total. When the calculated value of intercrosslink molecular weight increases, the fluorine content in the fluorine-containing monomer can be increases to reduce the reflectance and to improve the conductivity and antifouling property, although the strength and hardness of the coated layer decrease to lead insufficient scratch resistance and abrasion resistance of the surface of the coated layer. On the other hand, when the calculated value of intercrosslink molecular weight decreases, the intercrosslink density increases to improve the layer strength, although the fluorine content decreases to lead increase in the reflectance. From the standpoint of crosslink density and fluorine content, thus, the calculated value of intercrosslink molecular weight when all polymerizable groups in the polymerizable fluorine-containing compound undergo polymerization is preferably 2,000 or less, more preferably less than 1,000, and most preferably more than 50 and less than 800. The polymerizable fluorine-containing compound preferably contains a carbon atom substituted with 3 or more carbon atoms and/or silicon atoms and/or oxygen atoms in total (exclusive of an oxygen atom of a carbonyl group) in its molecule. The inclusion of the carbon atom makes it possible to build a sophisticated crosslink network structure at the curing, thereby tending to increase the hardness of the coated layer.

A more preferable embodiment of the polymerizable fluorine-containing compound represented by formula (I) includes a compound represented by formula (I-1), (I-2) or (I-3) shown below.

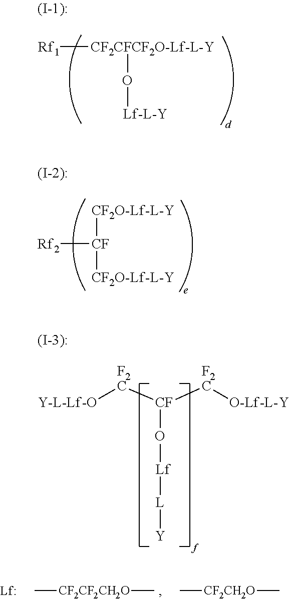

In formulae (I-1), (I-2) and (I-3), Rf₁ represents an oxygen atom, a d-valent organic group substantially constituting from only a carbon atom and a fluorine atom or a d-valent organic group constituting from only a carbon atom, a fluorine atom and an oxygen atom. Rf₂ represents an oxygen atom, an e-valent organic group substantially constituting from only a carbon atom and a fluorine atom or an e-valent organic group constituting from only a carbon atom, a fluorine atom and an oxygen atom. Lf represents —CF₂CF₂CH₂O— or —CF₂CH₂O— (connecting to the oxygen atom on the carbon atom side). L and Y have the same meanings as L and Y defined in Formula (I), respectively. d and e each independently represents an integer of 2 or more. f represents an integer of 1 or more.

A number of carbon atoms included in Rf₁ or Rf₂ is preferably from 0 to 30, and more preferably from 0 to 10.

A still more preferable embodiment of the polymerizable fluorine-containing compound represented by formula (I-1), (I-2) or (1-3) includes a compound represented by formula (I-1′), (I-2′) or (I-3′) shown below.

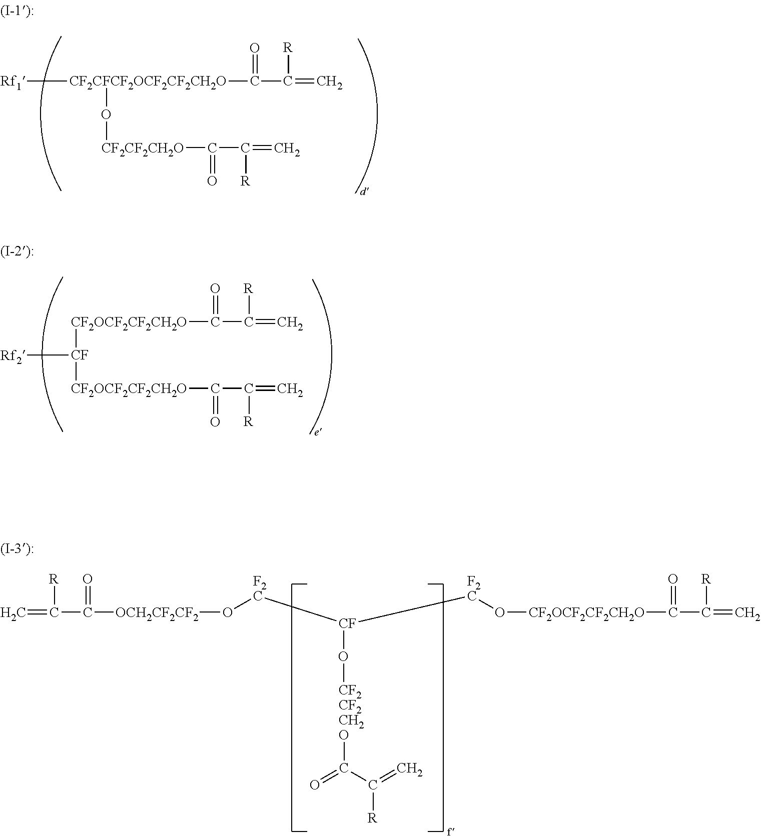

In formulae (I-1′), (I-2′) and (I′-3), Rf₁′ represents an oxygen atom, a d′-valent organic group substantially constituting from only a carbon atom and a fluorine atom or a d′-valent organic group constituting from only a carbon atom, a fluorine atom and an oxygen atom. Rf₂′ represents an oxygen atom, an e′-valent organic group substantially constituting from only a carbon atom and a fluorine atom or an e′-valent organic group constituting from only a carbon atom, a fluorine atom and an oxygen atom. R represents a hydrogen atom, a fluorine atom, an alkyl group (preferably an alkyl group having from 1 to 5 carbon atoms) or a fluoroalkyl group (preferably a perfluoroalkyl group having from 1 to 5 carbon atoms). d′ and e′ each independently represents an integer of 2 or 3. f′ represents an integer from 1 to 4.

A number of carbon atoms included in Rf₁′ or Rf₂′ is preferably from 0 to 30, and more preferably from 0 to 10.

Specific examples of the polymerizable fluorine-containing compound represented by formula (I) according to the invention are set forth below, but the invention should not be construed as being limited thereto.

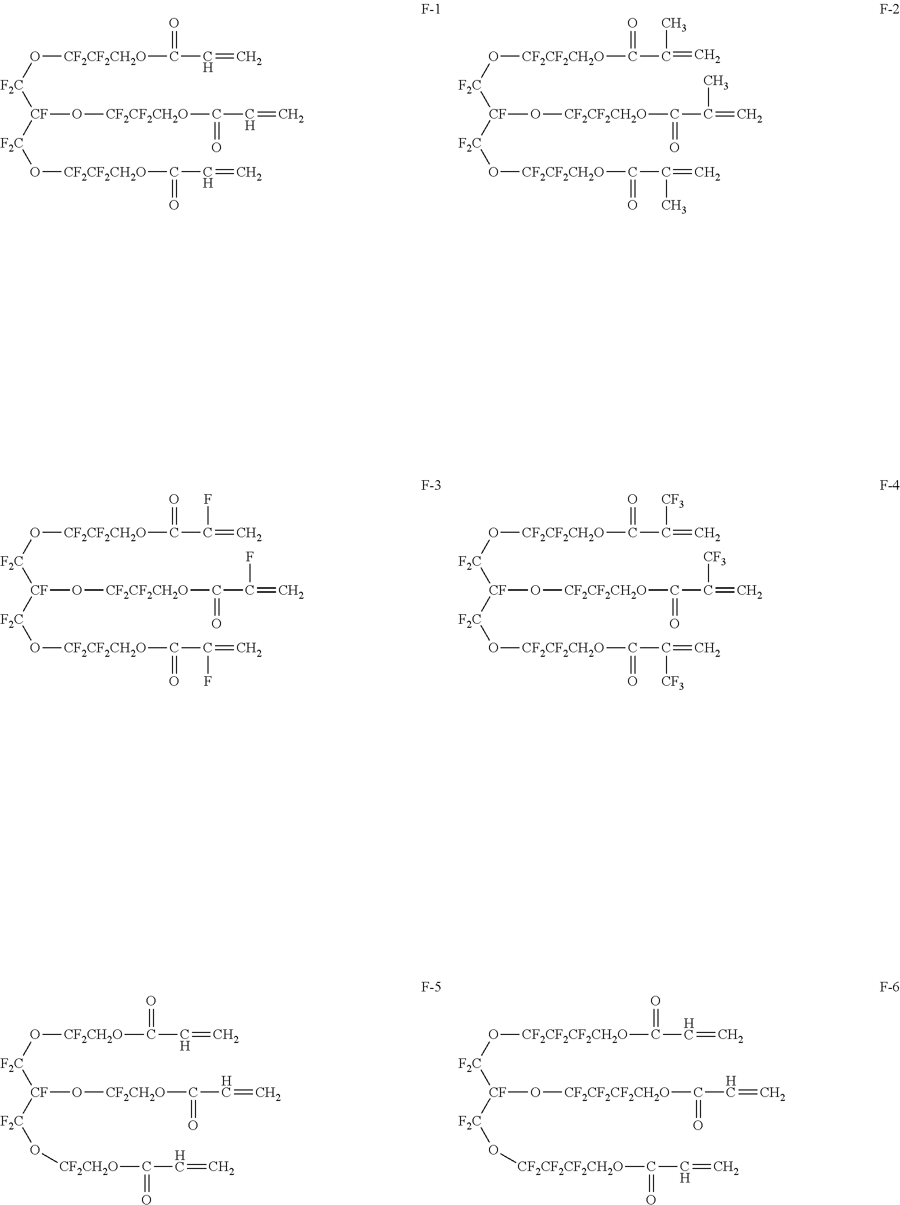

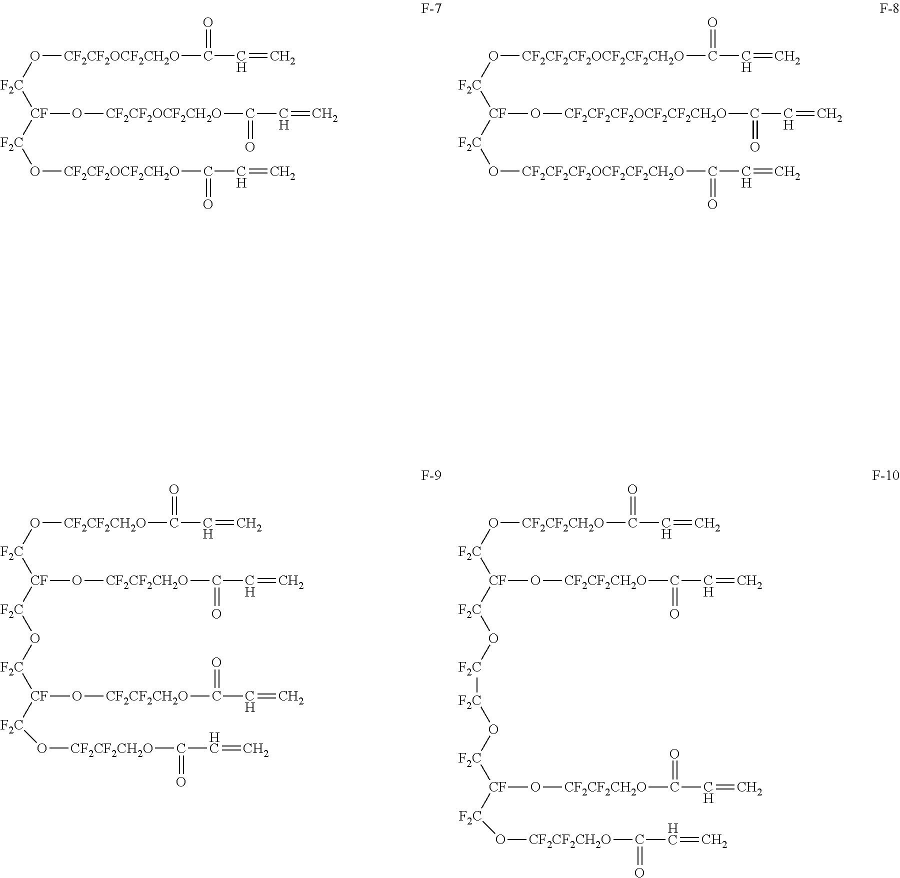

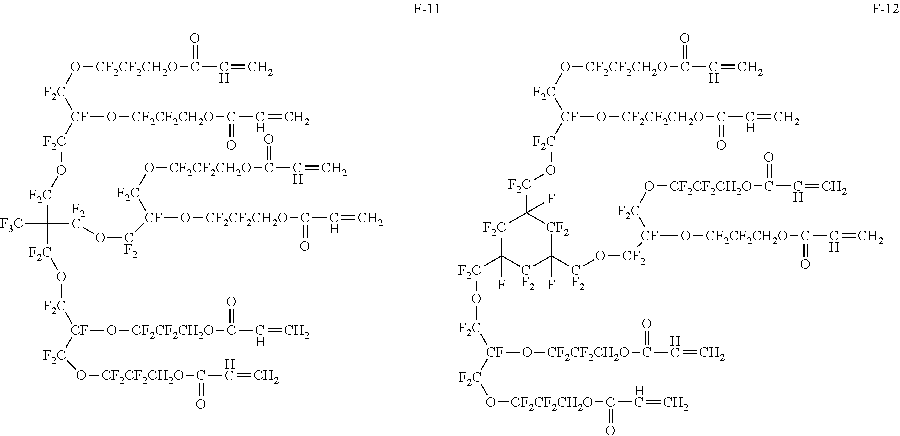

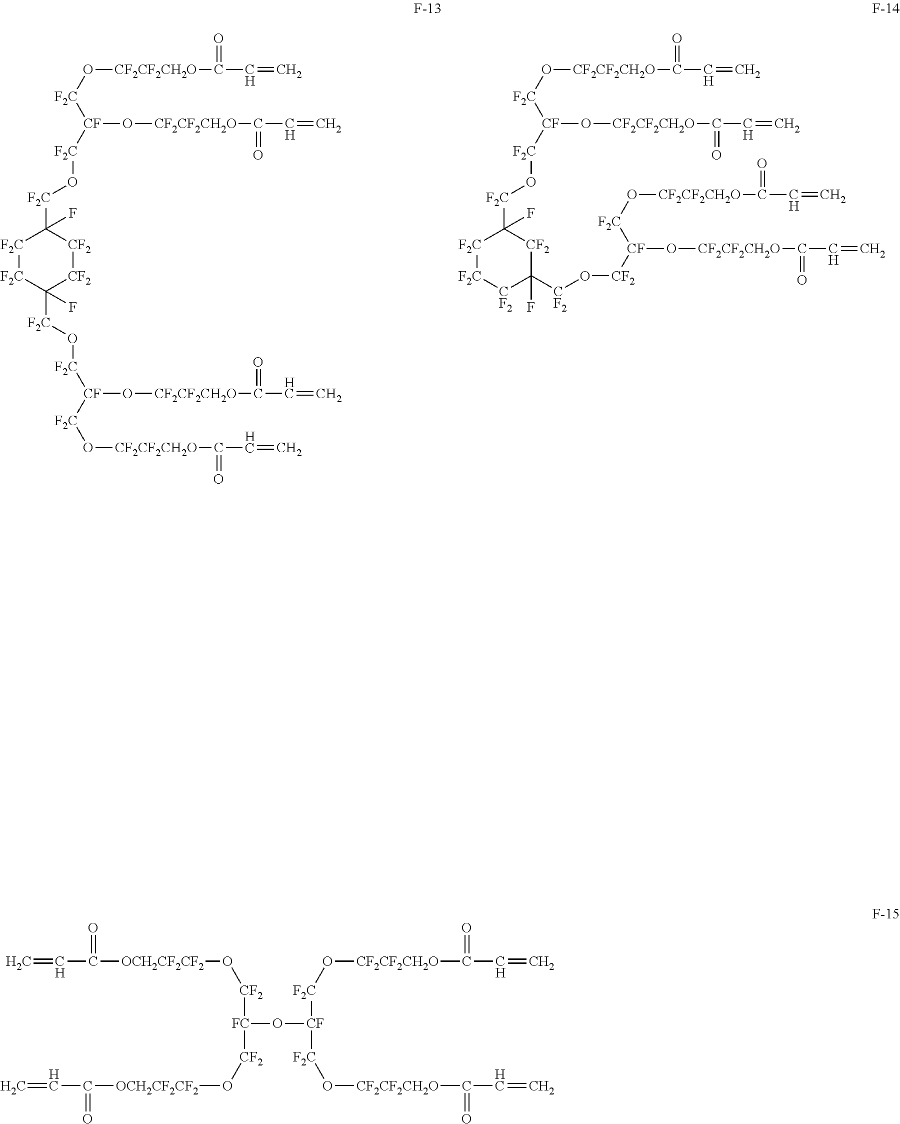

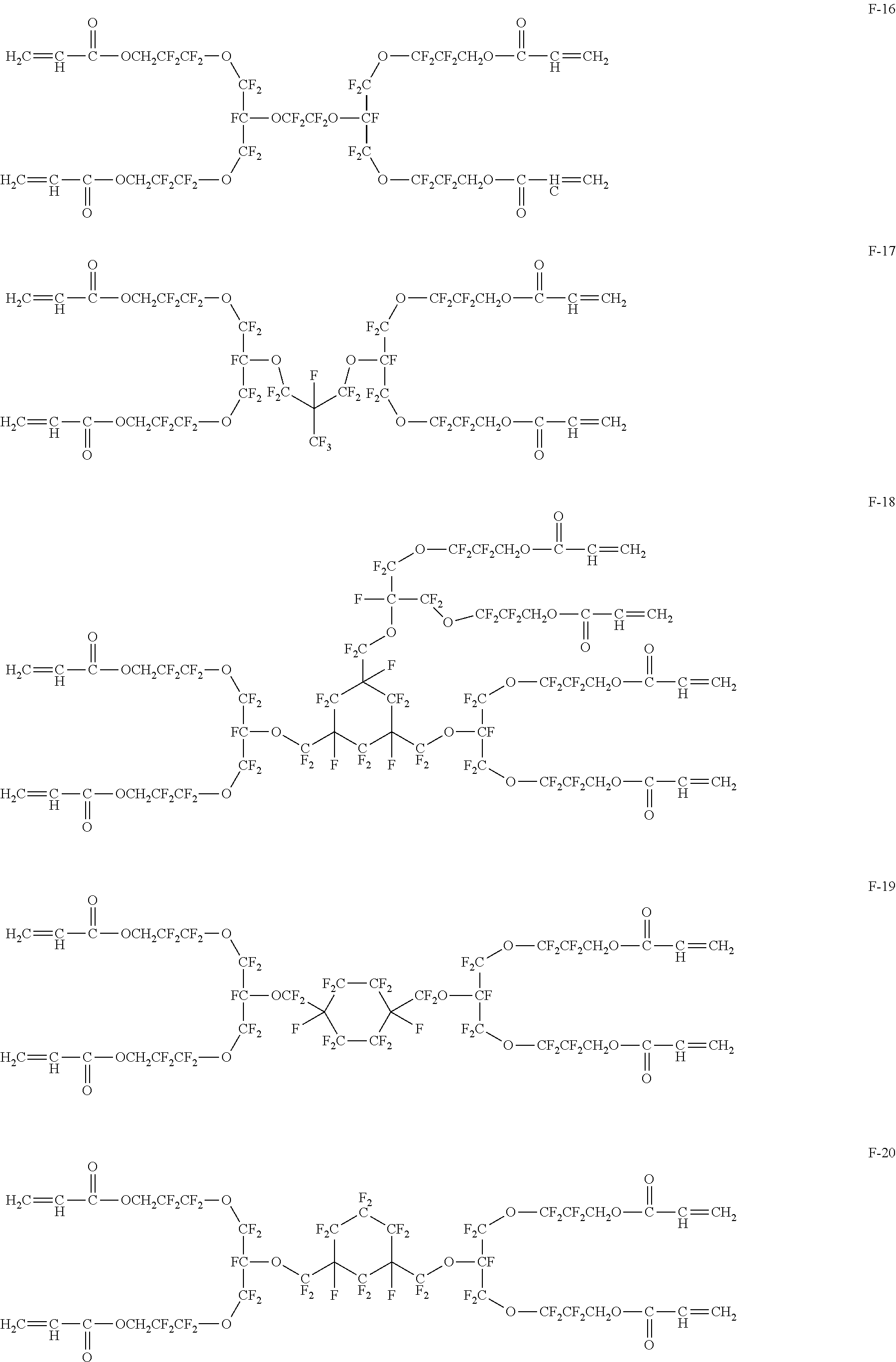

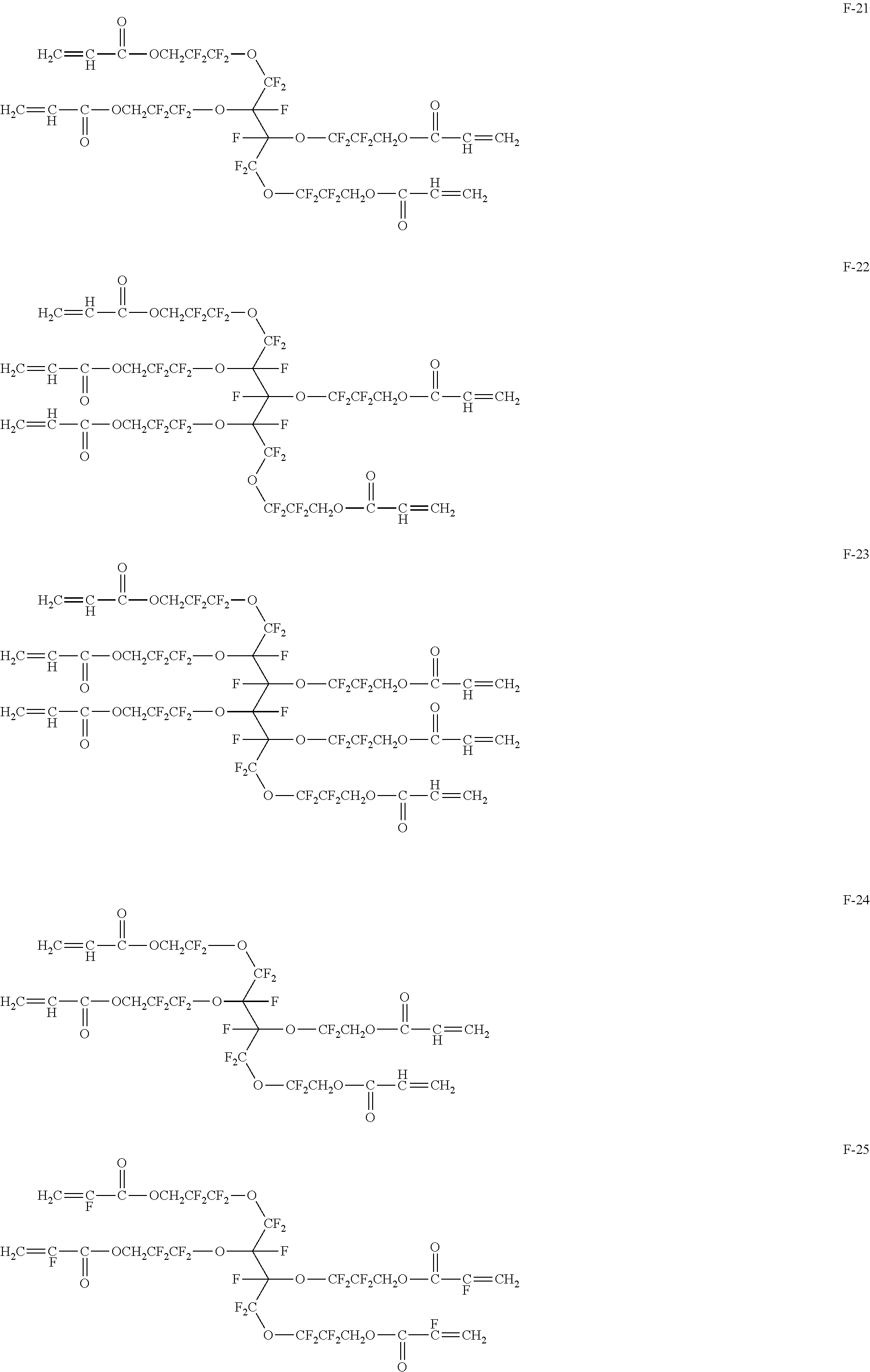

The production method of the fluorine-containing compound represented by formula (1) according to the invention is not particularly restricted and the fluorine-containing compound can be produced, for example, a combination of known methods as described below. In the following description, the symbols same as those used hereinbefore have the same meanings as defined above unless otherwise particularly indicated.

Step 1: A step of obtaining a methyl ester represented by Rf(CO₂CH₃)ₐ by an aqueous phase fluorination reaction of a compound represented by Rh(CO₂R₁)ₐ or Rh(CH₂OCOR₂)ₐ described in U.S. Pat. No. 5,093,432 and WO 00/56694 and a subsequent reaction with methanol. In the formula above, R₁ represents a lower alkyl group, for example, a methyl group or an ethyl group, R₂ represents an alkyl group, preferably a fluorine-containing alkyl group, more preferably a perfluoroalkyl group, and Rh represents a group capable of forming Rf by the aqueous phase fluorination reaction.
Step 2: A step of obtaining an alcohol represented by Rf(CH₂OH)ₐ by reducing the compound represented by Rf(CO₂CH₃)ₐ with a reducing agent, for example, hydrogenated lithium aluminum or halogenated boron sodium.
Step 3: A step of obtaining a compound represented by Rf(CH₂O-L-H)ₐ by adding as a block or at random at least one of ethylene carbonate, ethyleneoxide and glycidyl alcohol to the compound represented by Rf(CH₂OH)ₐ. Step 3 is not necessary when both b and c are 0.
Step 4: A step of obtaining a compound Rf(CH₂O-L-Y)ₐ represented by formula (1) by introducing a polymerizable group to the compound represented by Rf(CH₂O-L-F)ₐ.

When Y is —COC(R₀)═CH₂, as the reaction of introducing a polymerizable group, an esterification reaction of the alcohol of Rf(CH₂O-L-H)ₐ with an acid halide of XCOC(R₀)═CH₂ (wherein X represents a halogen atom, preferably a chlorine atom) or dehydration condensation of the alcohol of Rf(CH₂O-L-H)ₐ with a carboxylic acid of HOCOC(R₀)═CH₂ can be utilized. When Y is other polymerizable group, for example, a nucleophilic substitution reaction of the alcohol of Rf(CH₂O-L-H)ₐ with a corresponding halide can be utilized.

Preferable specific examples of the fluorine-containing monomer are set forth below, but the invention should not be construed as being limited thereto.

Further, from the standpoint of improvement in the surface state of the coated layer, increase in the conductivity and improvement in the scratch resistance of the layer in case of using together with the π-conjugated system conductive polymer, in addition to X-2 to X-4, X-6, X-8 to X-14 and X-21 to X-32 described in Paragraph Nos. [0023] to [0027] of JP-A-2006-28409, Compound (X-33) shown below is also preferably used as the fluorine-containing monomer.

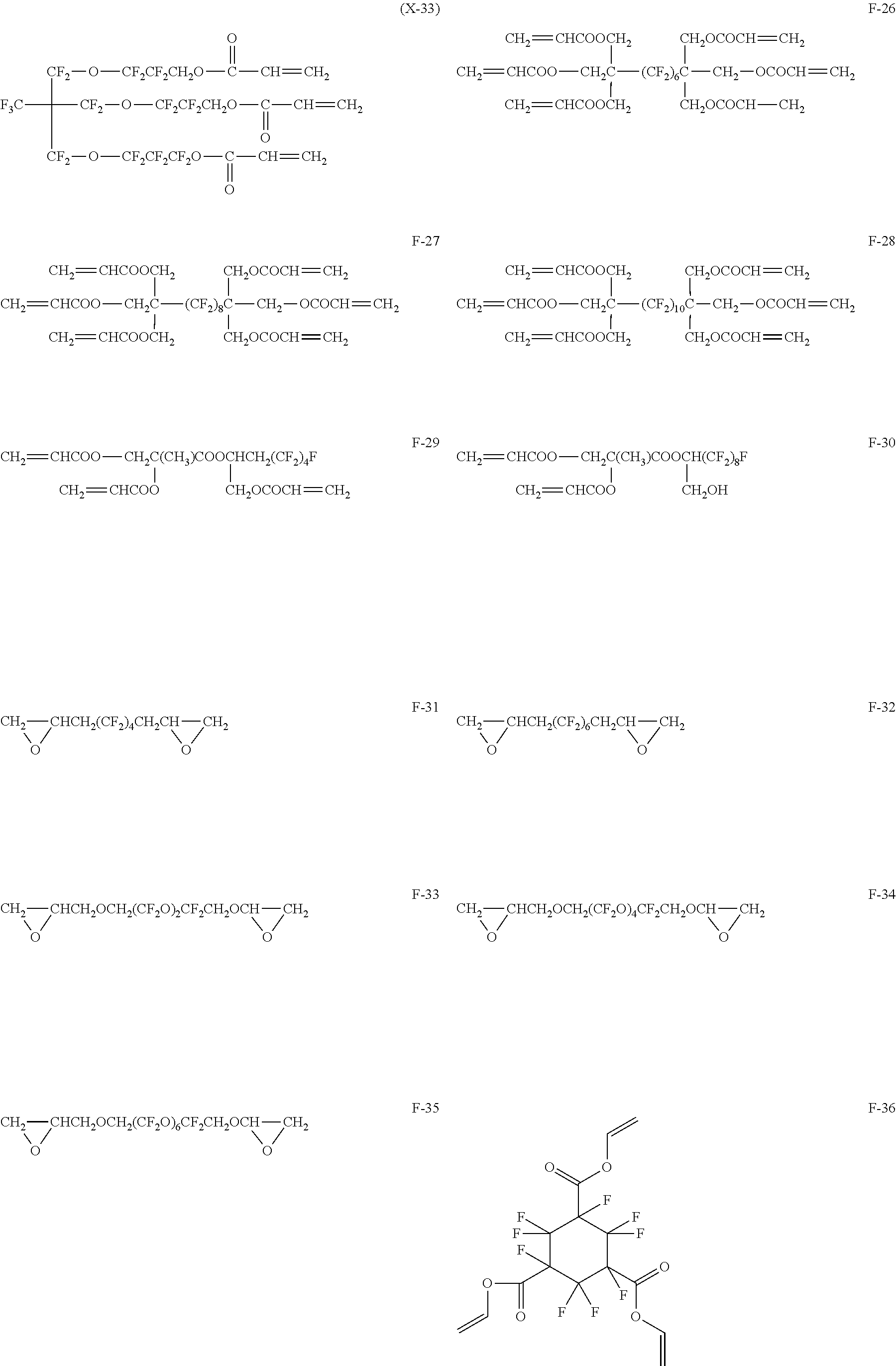

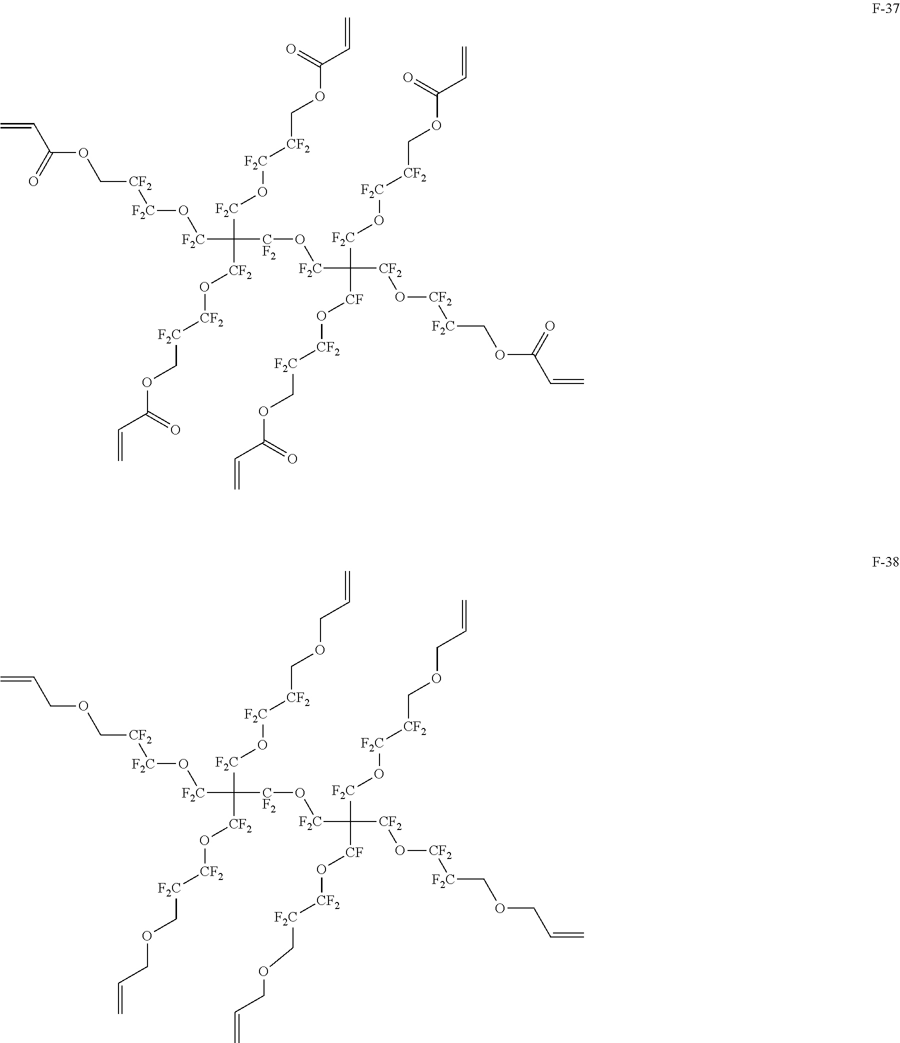

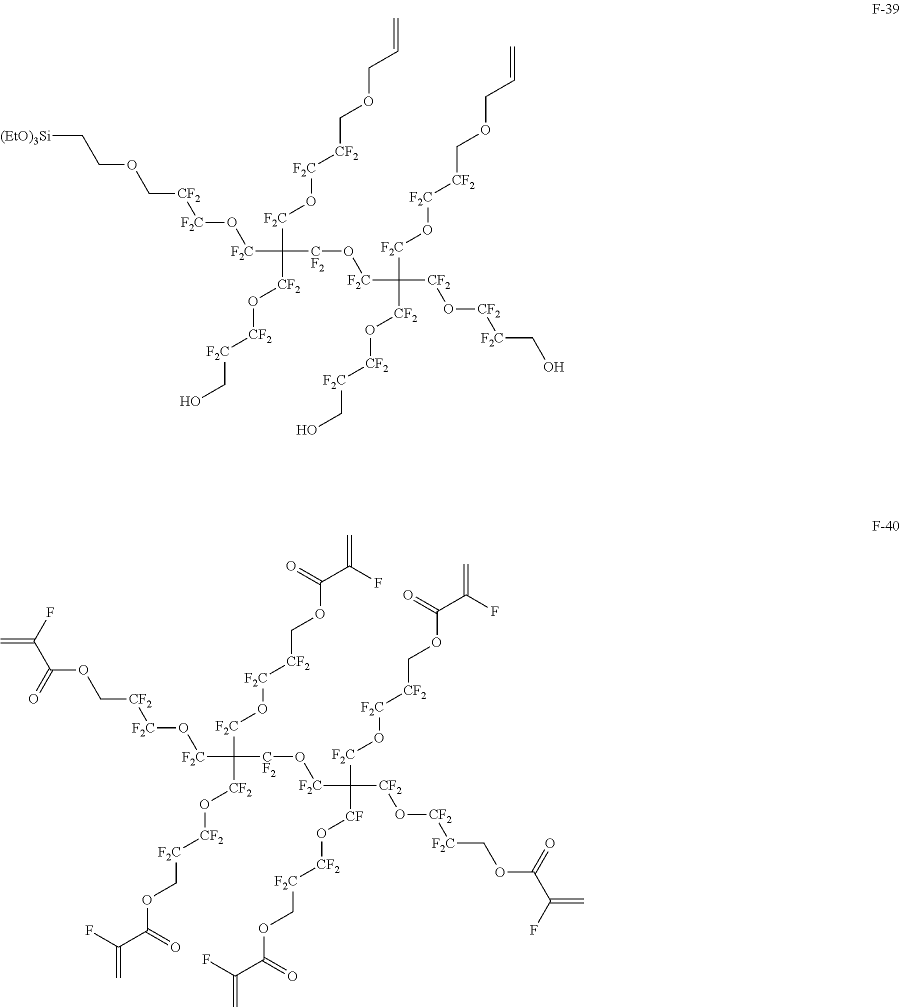

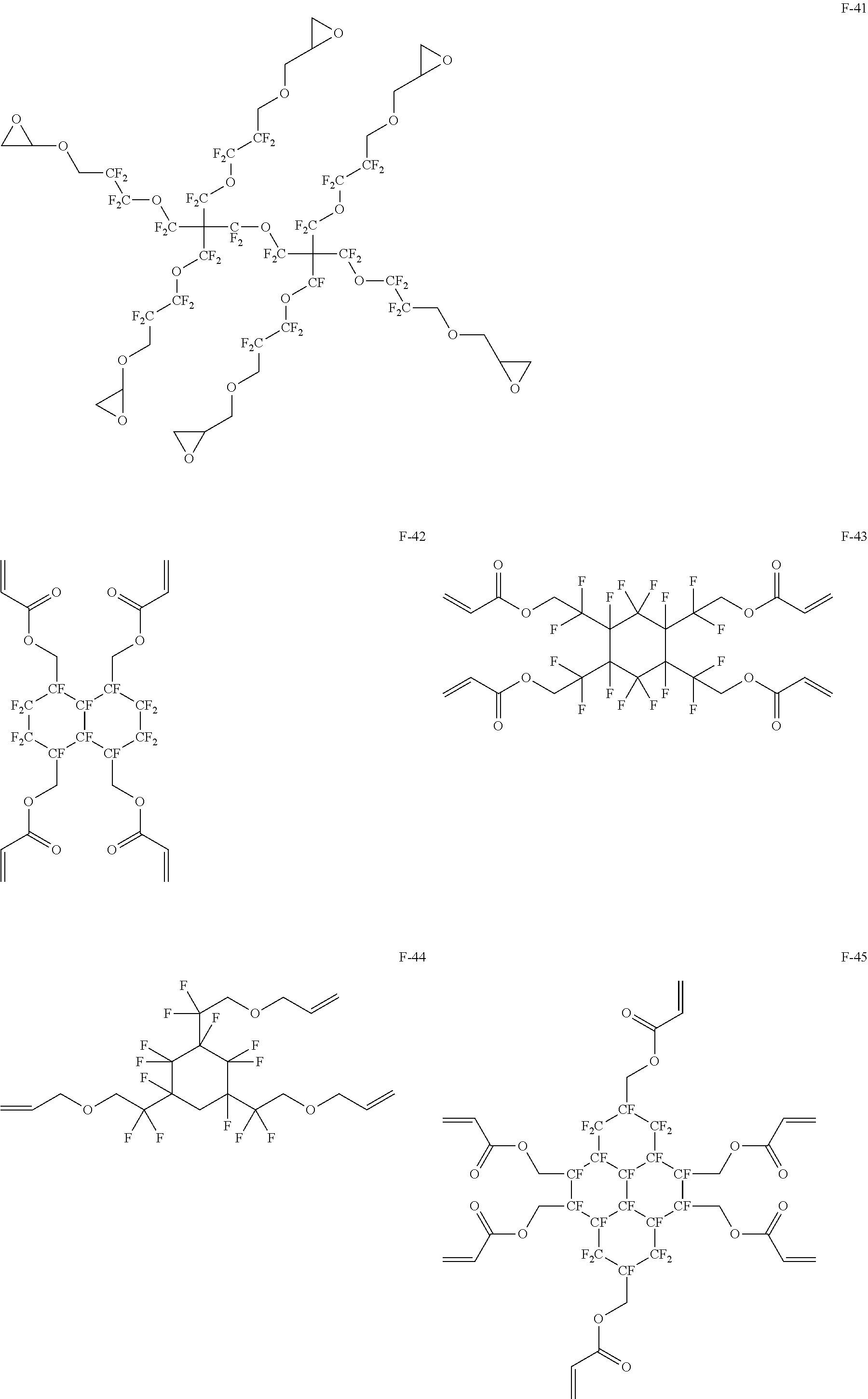

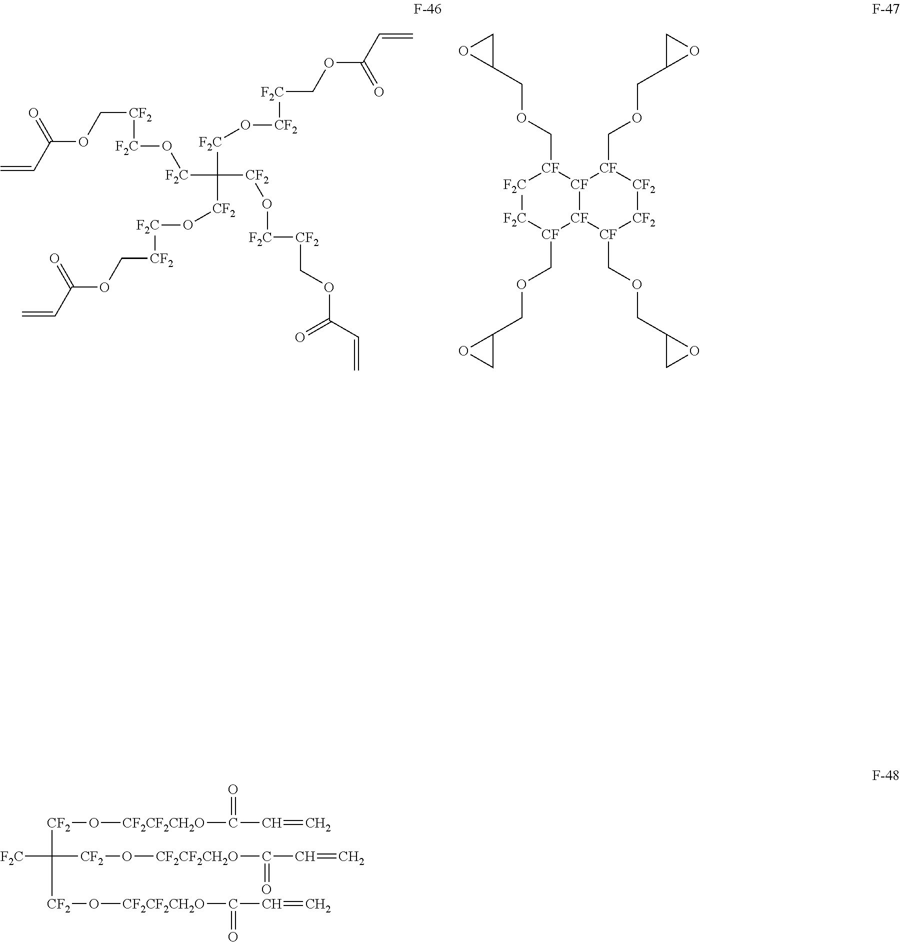

Moreover, the compounds shown below are also preferably used.

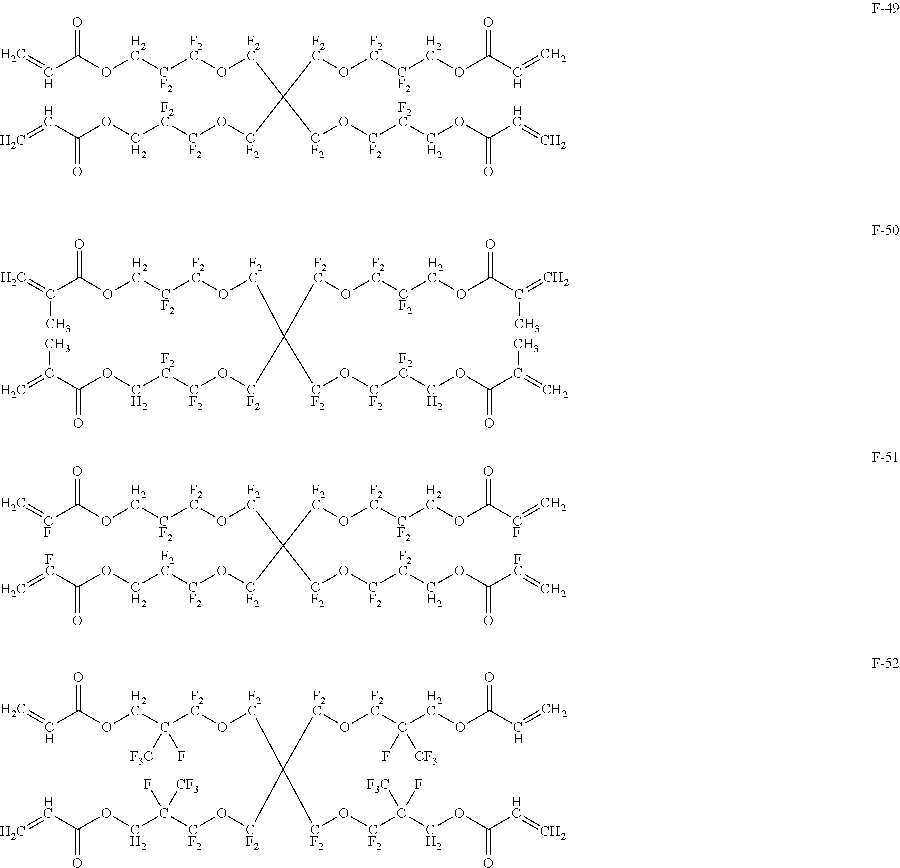

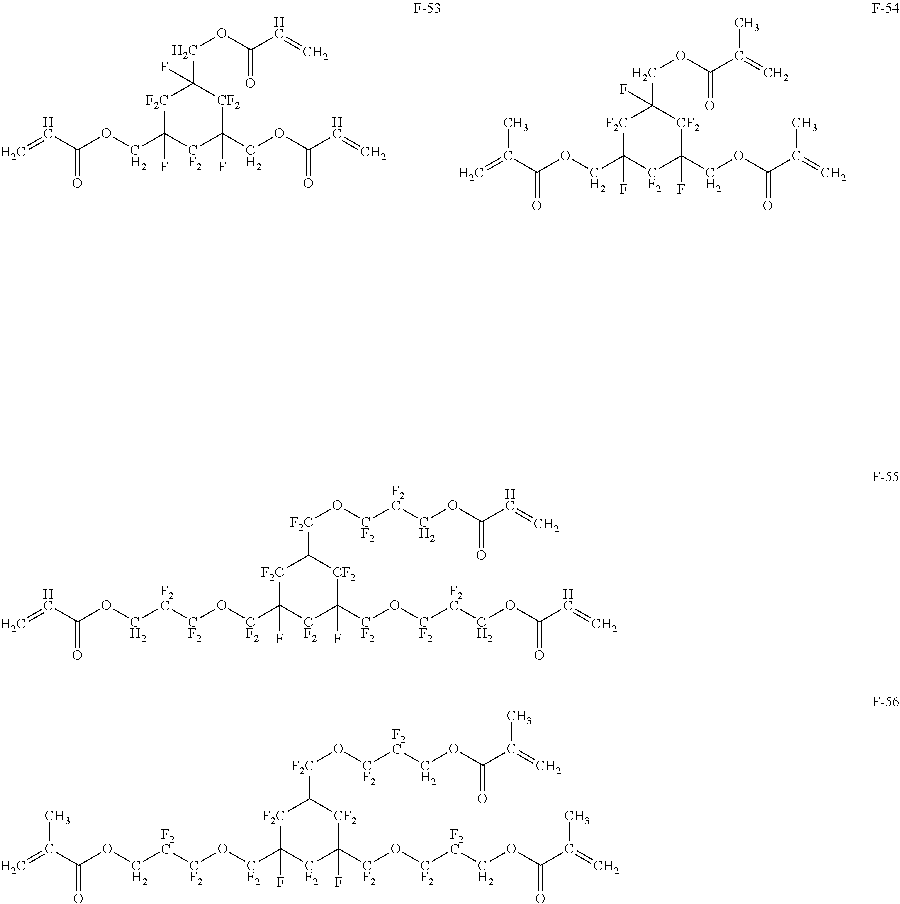

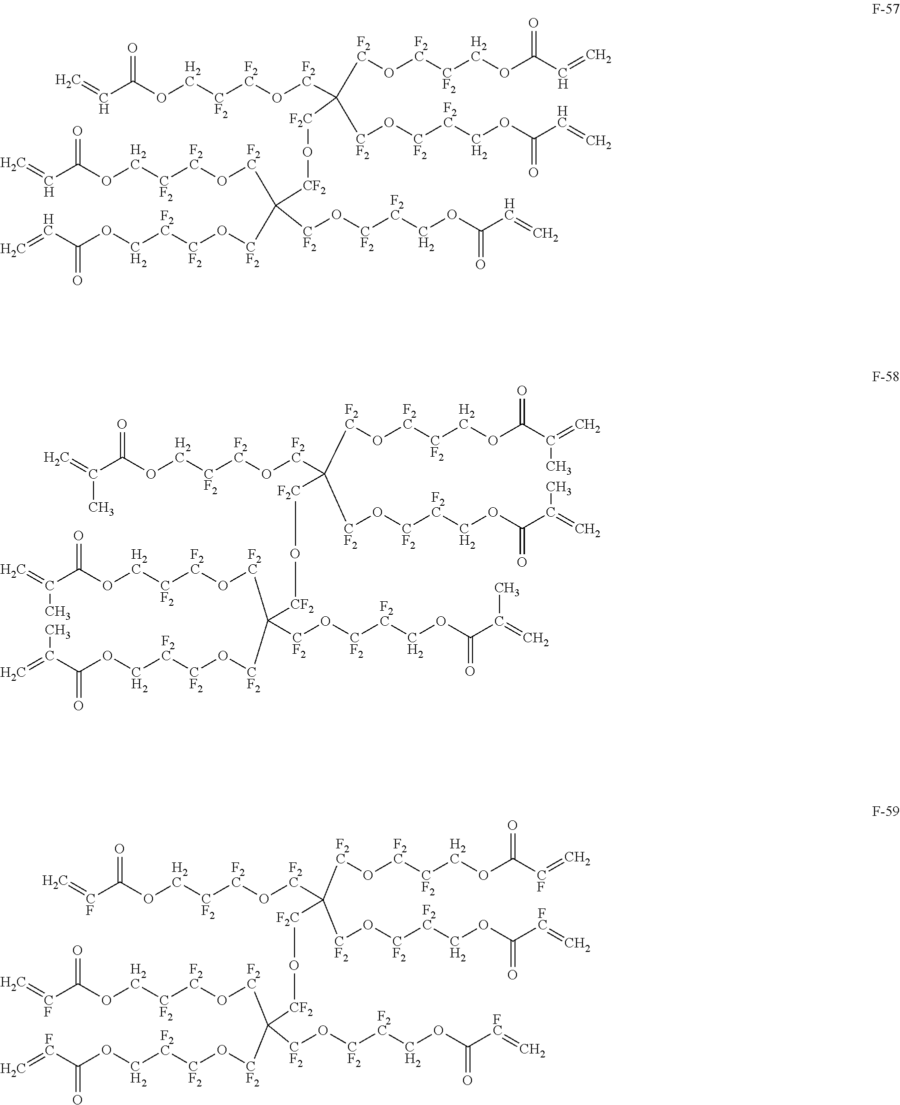

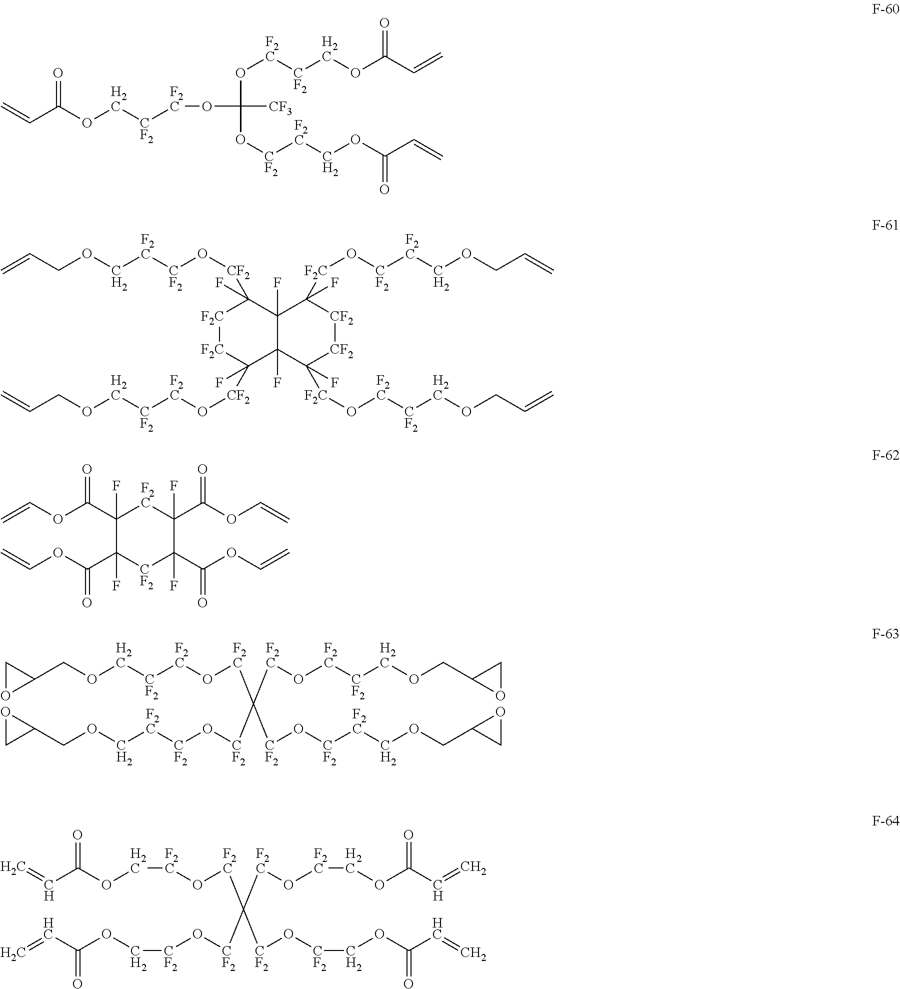

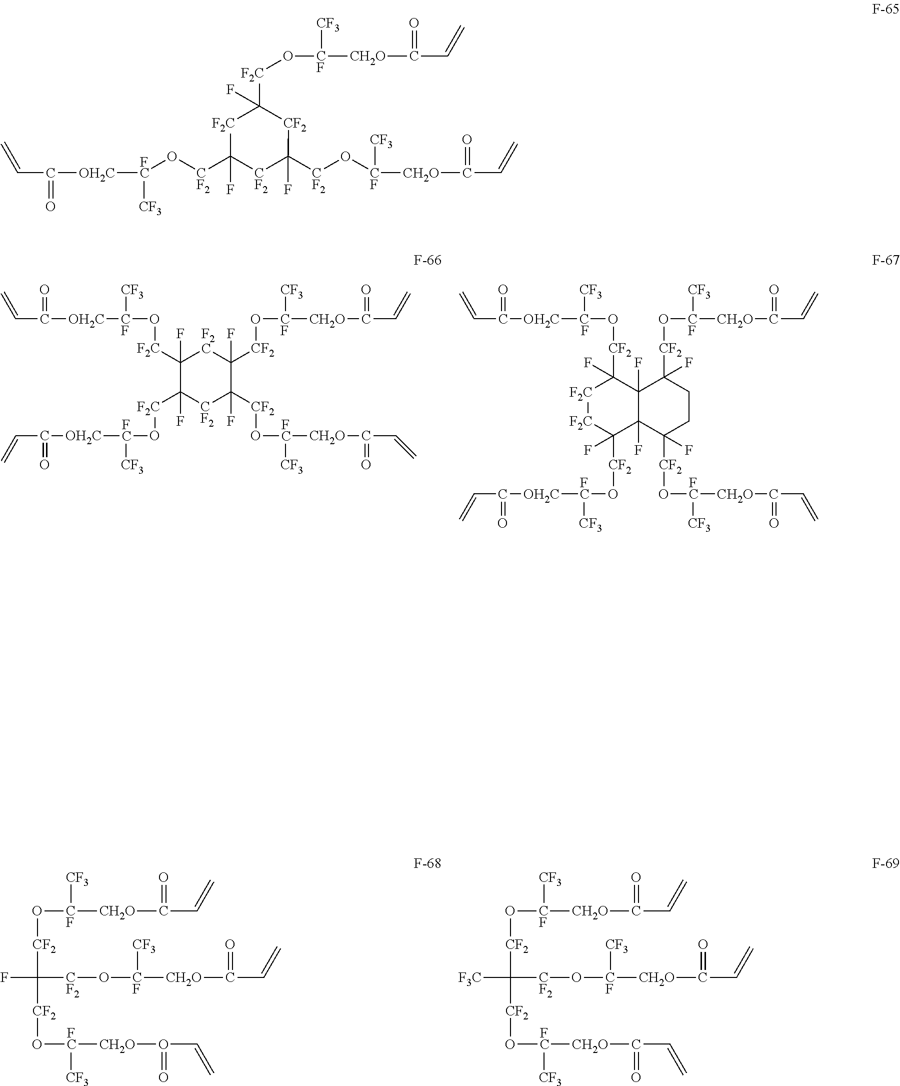

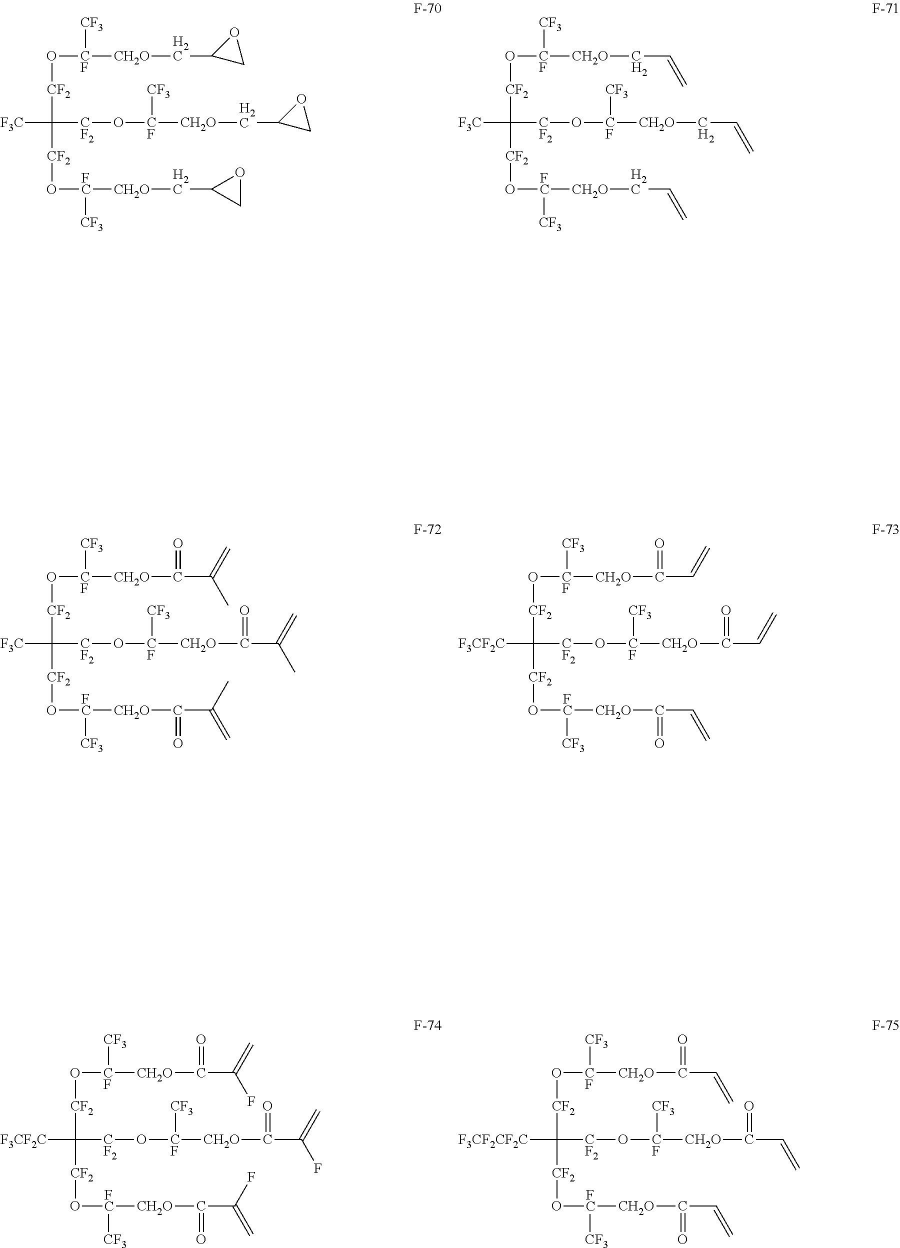

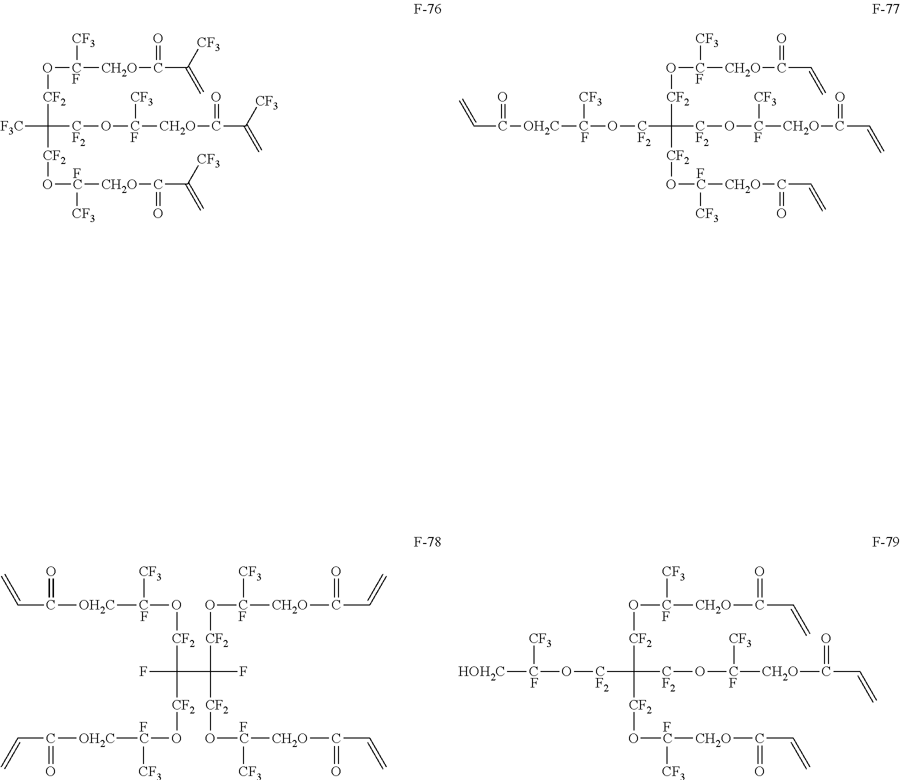

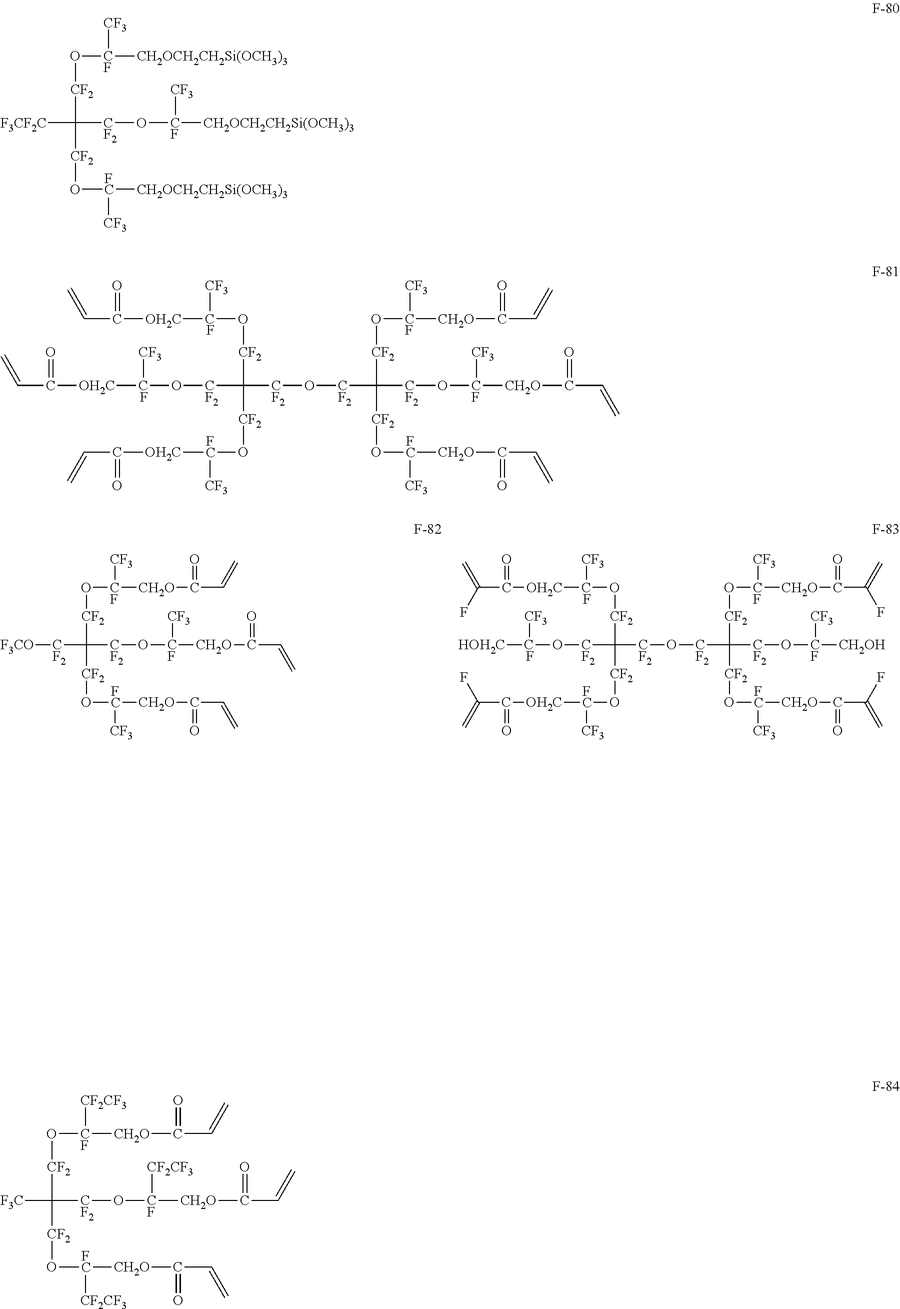

Furthermore, from the standpoint of compatibility with other binder or a non-fluorine-containing monomer, a monomer having a repeating unit of an alkyl chain substituted with a fluorine atom through an ether bond, represented by formula (II) shown below is used as the fluorine-containing monomer.

Y—(CF₂—CFX—O)ₙ₂—Y Formula (II)

In formula (II), X represents —F or —CF₃, n2 represents an integer from 1 to 20, and Y represents a polymerizable group.

The preferable range and specific example of Y are same as those described for Y in formula (I).

Specific examples of the fluorine-containing polyfunctional monomer represented by formula (II) are set forth below, but the invention should not be construed as being limited thereto.

### FP-1: CH₂═CH—COOCH₂(CF₂CF₂—O)₂CH₂OCOCH═CH₂

### FP-2: CH₂H—COOCH₂(CF₂CF₂—O)₄—CH₂OCOCH═CH₂

### FP-3: CH₂(CH₃)—COOCH₂(CF₂CF₂—O)₂CH₂OCOC(CH₃)═CH₂

### PF-4: CH₂(CH₃)—COOCH₂(CF₂C(CF₃)F—O)₄CH₂OCOC(CH₃)═CH₂

### PF-5: CH₂(CH₃)—COOCH₂(CF₂C(CF₃)F—O)₈CH₂OCOC(CH₃)═CH₂

Further, from the standpoint of capability of forming a crosslinking structure and high strength and hardness of the cured layer, fluorine-containing polyfunctional (meth)acrylate described below are also preferably used as the fluorine-containing monomer. Specifically, for example, 1,3-bis{(meth)acryloyloxy}-2,2-difluoropropane, 1,4-bis{(meth)acryloyloxy}-2,2,3,3-tetrafluorobutane, 1,5-bis{(meth)acryloyloxy}-2,2,3,3,4,4-hexafluoropentane, 1,6-bis{(meth)acryloyloxy}-2,2,3,3,4,4,5,5-octafluorohexane, 1,7-bis{(meth)acryloyloxy}-2,2,3,3,4,4,5,5,6,6-decafluoroheptane, 1,8-bis{(meth)acryloyloxy}-2,2,3,3,4,4,5,5,6,6,7,7-dodecafluorooctane, 1,9-bis{(meth)acryloyloxy}-2,2,3,3,4,4,5,5,6,6,7,7,8,8-tetradecafluorononane, 1,10-bis{(meth)acryloyloxy}-2,2,3,3,4,4,5,5,6,6,7,7,8,8,9,9-hexadecafluorodecane, 1,11-bis{(meth)acryloyloxy}-2,2,3,3,4,4,5,5,6,6,7,7,8,8,9,9,10,10-octadecafluoroundecane, 1,12-bis{(meth)acryloyloxy}-2,2,3,3,4,4,5,5,6,6,7,7,8,8,9,9,10,10,11,11-eicosafluorododecane, 1,8-bis{(meth)acryloyloxy}-2,7-dihydroxy-4,4,5,5-tetrafluorooctane, 1,7-bis{(meth)acryloyloxy}-2,8-dihydroxy-4,4,5,5-tetrafluorooctane, 2,7-bis{(meth)acryloyloxy}-1,8-dihydroxy-4,4,5,5-tetrafluorooctane, 1,10-bis {(meth)acryloyloxy}-2,9-dihydroxy-4,4,5,5,6,6,7,7-octafluorodecane, 1,9-bis{(meth)acryloyloxy}-2,10-dihydroxy-4,4,5,5,6,6,7,7-octafluorodecane, 2,9-bis{(meth)acryloyloxy}-1,10-dihydroxy-4,4,5,5,6,6,7,7-octafluorodecane, 1,2,7,8-tetrakis{(meth)acryloyloxy}-4,4,5,5-tetrafluorodecane, 1,2,8,9-tetrakis{(meth)acryloyloxy}-4,4,5,5,6,6-hexafluorononane, 1,2,9,10-tetrakis{(meth)acryloyloxy}-4,4,5,5,6,6,7,7-octafluorodecane, 1,2,10,11-tetrakis {(meth)acryloyloxy}-4,4,5,5,6,6,7,7,8,8-decafluoroundecane, 1,2,11,12-tetrakis {(meth)acryloyloxy}-4,4,5,5,6,6,7,7,8,8,9,9-dodecafluorododecane, 1,10-bis(α-fluoroacryloyloxy)-2,9-dihydroxy-4,4,5,5,6,6,7,7-octafluorodecane, 1,9-bis(α-fluoroacryloyloxy)-2,10-dihydroxy-4,4,5,5,6,6,7,7-octafluorodecane, 2,9-bis(α-fluoroacryloyloxy)-1,10-dihydroxy-4,4,5,5,6,6,7,7-octafluorodecane, 1,2,9,10-tetrakis(α-fluoroacryloyloxy)-4,4,5,5,6,6,7,7-octafluorodecane and 1,2,11,12-tetrakis(α-fluoroacryloyloxy)-4,4,5,5,6,6,7,7,8,8,9,9-dodecafluorododecane are exemplified.

The fluorine-containing polyfunctional (meth)acrylate can be produced according to a known method. For instance, it is produced by a ring-opening reaction of a corresponding fluorine-containing epoxy compound with (meth)acrylic acid or an esterification reaction of a corresponding fluorine-containing polyhydric alcohol or a fluorine-containing meth(acrylate) having a hydroxy group obtained as an intermediate compound in the ring-opening reaction described above with (meth)acrylic chloride.

### (Fluorine Content in Fluorine-Containing Monomer)

The fluorine content in the fluorine-containing monomer is preferably 25.0% by weight or more, more preferably from 45.0 to 80.0% by weight, most preferably from 50.0 to 80.0% by weight, based on the molecular weight of the fluorine-containing monomer, from the standpoint of reducing the refractive index of the antistatic layer. When the fluorine content exceeds 80.0% by weight, the strength and hardness of the coated layer decrease to lead insufficient scratch resistance and abrasion resistance of the surface of the coated layer, although the content of fluorine atom in the cured layer is high.

As the fluorine-containing curable compound used as component (C) according to the invention, a polymer is preferred from the standpoint of stability of the surface state of the coated layer. On the other hand, from the standpoint of improvement in the solubility of the coating composition and improvement in the adhesion property, a fluorine-containing curable monomer is preferred. The use of the polymer together with the monomer is particularly preferred because these properties can be achieved at a high level.

The content of the fluorine-containing curable compound (C) in the composition for antistatic layer is preferably from 3 to 94% by weight, more preferably from 5 to 90% by weight, most preferably from 10 to 80% by weight, based on the total solid content of the composition.

When the content of the fluorine-containing curable compound is in the range described above, the laminate has low reflection and is excellent in the surface state stability of the coated layer and the generation of sea-island phase separation structure of the conductive polymer is apt to occur to increase the conductivity (to reduce log SR).

Further, in the antistatic layer according to the invention, a non-fluorine-containing polyfunctional monomer which does not contain a fluorine atom may be used together as the curable binder of the antistatic layer. In the laminate according to the invention, although segregation of the conductive polymer occurs in the antistatic layer, by using together a non-fluorine-containing curable compound having high affinity to the conductive polymer, the density of the curable group in the vicinity of the conductive polymer unevenly distributed can be increased to cure the antistatic layer in a proper balance, thereby improving the adhesion property and scratch resistance of the laminate. Also, since appropriate control of compatibility of the conductive polymer (A) with the fluorine-containing curable compound (C) in the composition for forming the antistatic layer and the antistatic layer can be easily conducted, the non-fluorine-containing polyfunctional monomer is preferably used together.

### (Non-Fluorine-Containing Polyfunctional Monomer)

The non-fluorine-containing polyfunctional monomer includes a compound which does not contain a fluorine atom and has two or more polymerizable groups in its molecule. The polymerizable groups include those described with respect to the fluorine-containing monomer described above and the preferred ranges are also same. In particular, a (meth)acryloyl group is particularly preferred. When the fluorine content in the monomer for forming a binder is increased in order to decrease the refractive index of the layer, the density of the crosslinkable group is decreased in the layer and the strength of the coated layer deteriorates, thereby tending to decrease the scratch resistance. Further, the fluorine-containing monomer and the organic conductive compound are poor in affinity with each other because the polarities of both compounds are largely different. This is particularly remarkable when the organic conductive compound is a polymer compound. Therefore, in the formation of layer by coating and drying the coating solution containing an organic solvent, interfacial bond between the organic conductive compound and the fluorine-containing monomer is weak to tend to deteriorate the strength of the coated layer after curing. In particular, when the composition is used for a low refractive index layer which forms the outermost surface of an antireflective film, it is easily affected by the polymerization inhibition due to oxygen, thereby tending to moreover deteriorate the curing. In response, by using together the non-fluorine-containing polyfunctional monomer, the affinity between the organic conductive compound and the fluorine-containing monomer is further improved to increase the strength of the coated layer, thereby improving the scratch resistance.

The non-fluorine-containing polyfunctional monomer having two or more (meth)acryloyl groups includes, for example, a (meth)acrylic acid diester of polyhydric alcohol and a (meth)acrylic acid diester of ethyleneoxide or propyleneoxide adduct. Specific examples thereof are described in Paragraph No. [0116] of JP-A-2009-98658 and they are preferably used in the invention.

Further, an epoxy (meth)acrylate, a urethane (meth)acrylate and a polyester (meth)acrylate are also preferably used as a photopolymerizable polyfunctional monomer.

Among them, an ester of polyhydric alcohol and (meth)acrylic acid is preferred and a polyfunctional monomer having three or more (meth)acryloyl groups in its molecule is more preferred.

Of the compounds, those having a hydroxy group, an amido group, an ethyleneoxide group or a propyleneoxide group in the molecules thereof are preferred. The compound having such a functional group is excellent in the affinity with both the organic conductive compound and the fluorine-containing monomer to achieve improvement in the surface state of the coated layer, improvement in the time-lapse stability of a coating solution, increase in the hardness of the layer and improvement in the scratch resistance.

As the polyfunctional acrylate compound having a (meth)acryloyl group, commercially available products may also be used. For example, DPHA produced by Nippon Kayaku Co., Ltd. is exemplified. Also, the compounds described in Paragraph No. [0119] of JP-A-2009-98658 are preferably used.

Of the compounds having a polymerizable unsaturated group, those having both of a glycidyl group and/or a hydroxy group and at least one group selected from a methacryl group, an acryl group, a methacrylamido group and an acrylamido group are preferably used from the standpoint of improvement in the affinity with both the organic conductive compound and the fluorine-containing monomer. Specific examples of such a compound include compounds shown below.

Examples of the compound having a glycidyl group and a methacryl group (acryl group) include glycidyl methacrylate and glycidyl acrylate are exemplified. Examples of the compound having a hydroxy group and any one of a methacryl group, an acryl group, a methacrylamido group and an acrylamido group include 2-hydroxyethyl methacrylate, 2-hydroxyethyl acrylate, 2-hydroxypropyl methacrylate, 2-hydroxypropyl acrylate, 4-hydroxybutyl methacrylate, 4-hydroxybutyl acrylate, ethyl α-(hydroxymethyl)acrylate, pentaerythritol acrylate, dipentaerythritol monohydroxy pentaacrylate, 2-hydroxyethylacrylamide and 2-hydroxyethylmethacrylamide. The compounds may be used either individually or as a mixture of two or more thereof. Of the examples of the compound, 2-hydroxyethylacrylamide, 2-hydroxyethylmethacrylamide, 2-hydroxyethyl acrylate or dipentaerythritol monohydroxy pentaacrylate is preferred, and 2-hydroxyethylacrylamide is more preferred, in view of high affinity with the conductive polymer composition according to the invention. The compound is excellent in the surface state of the coated layer, can increase crosslink density in the transparent conductive layer and can improve the heat resistance, high temperature and high humidity resistance and scratch resistance.

Moreover, a resin having three or more (meth)acryloyl groups, for example, a relatively low molecular weight polyester resin, polyether resin, acrylic resin, epoxy resin, urethane resin, alkyd resin, spiroacetal resin, polybutadiene resin or polythiolpolyene resin, or an oligomer or prepolymer of a polyfunctional compound, for example, a polyhydric alcohol is exemplified.

As the non-fluorine-containing polyfunctional monomer, a dendrimer described, for example, in JP-A-2005-76005 and JP-A-2005-36105, or a norbornene ring-containing monomer as described, for example, in JP-A-2005-60425 may also be used.

Two or more kinds of the non-fluorine-containing polyfunctional monomers may be used in combination.

The amount of the non-fluorine-containing polyfunctional monomer added to the composition for antistatic layer is preferably from 1 to 90% by weight, more preferably from 2 to 85% by weight, particularly preferably from 5 to 75% by weight, based on the total solid content of the composition. In case of using together with the fluorine-containing curable compound, the amount is preferably from 1 to 50% by weight, more preferably from 2 to 30% by weight, particularly preferably from 2 to 20% by weight, based on the total solid content of the antistatic layer. In the range of amount described above, increase in the hardness of the layer, immobilization of the antifouling agent described hereinafter in the surface layer and improvement in the interfacial adhesion to an adjacent layer are achieved.

Further, an oligomer or polymer having a polymerizable group may also be used.

### [(F) Inorganic Particle]

When reduction of the refractive index and improvement in the scratch resistance are intended in the antistatic layer formed from the composition containing component (A), it is preferred to use an inorganic particle, more preferably an inorganic oxide particle. The inorganic particle is not particularly restricted as long as it has an average particle size from 1 to 200 nm. From the standpoint of the reduction of refractive index, an inorganic low refractive index particle is preferred.

The inorganic particle includes a magnesium fluoride fine particle or a silica fine particle because of its low refractive index. In particular, from the standpoint of refractive index, dispersion stability and cost, a silica fine particle is preferred. The size (primary particle size) of the inorganic particle is preferably from 1 to 200 nm, more preferably from 5 to 150 nm, still more preferably from 20 to 100 nm, and most preferably from 40 to 90 nm.

When the particle size of the inorganic fine particle is too small, the effect of improving the scratch resistance decreases, whereas when it is too large, fine irregularities are generated on the surface of the layer and the appearance, for example, dense blackness or the integrated reflectivity may be deteriorated. The inorganic fine particle may be crystalline or amorphous, and it may be a monodisperse particle or an aggregate particle as long as the predetermined particle size is satisfied. The shape thereof is most preferably sphere, but it may be an amorphous form.

The coating amount of the inorganic fine particle is preferably from 1 to 100 mg/m², more preferably from 5 to 80 mg/m², and still more preferably from 10 to 60 mg/m². When the coating amount is too small, the effect of improving the scratch resistance decreases, whereas when it is too large, fine irregularities are generated on the surface of the layer and the appearance, for example, dense blackness or the integrated reflectivity may be deteriorated. The content of the inorganic fine particle in the antistatic layer is preferably from 0.1 to 70% by weight, more preferably from 1 to 60% by weight, still more preferably from 5 to 50% by weight, based on the total solid content of the antistatic layer.

### (Fine Particle Having Porous or Hollow Structure)

For the purpose of reducing the refractive index, the inorganic fine particle (D) is preferably a porous inorganic fine particle or an inorganic fine particle having a hollow structure inside. Particularly, a silica fine particle having a hollow structure inside is preferably used. The void percentage of the fine particle having a hollow structure is preferably from 10 to 80%, more preferably from 20 to 60%, and most preferably from 30 to 60%. The void percentage of the hollow fine particle in the range described above is preferred from the standpoint of reducing the refractive index and maintaining the durability of the particle.

In the case where the porous or hollow particle is a silica fine particle, the refractive index of the fine particle is preferably from 1.10 to 1.40, more preferably from 1.15 to 1.35, and most preferably from 1.15 to 1.30. The refractive index as used herein indicates a refractive index of the particle as a whole, and does not indicate a refractive index of only silica in the outer shell forming the silica particle.

The coating amount of the porous or hollow silica particle is preferably from 1 to 100 mg/m², more preferably from 5 to 80 mg/m², and still more preferably from 10 to 60 mg/m². When the coating amount is too small, the effect of reducing the refractive index or improving the scratch resistance decreases, whereas when it is too large, fine irregularities are generated on the surface of the layer and the appearance, for example, dense blackness or the integrated reflectivity may be deteriorated.

When the particle size of the silica fine particle is too small, a rate of void region decreases and the reduction of refractive index is not expected, whereas when it is too large, fine irregularities are generated on the surface of the layer and the appearance, for example, dense blackness or the integrated reflectivity may be deteriorated. The silica fine particle may be crystalline or amorphous. The silica fine particle is preferably a monodisperse particle. The shape thereof is most preferably sphere, but it may be an amorphous form.

Two or more hollow silica particles having average particle sizes different from each other may be used together. The average particle size of the hollow silica particle can be determined from electron micrographs.

The specific surface area of the hollow silica particle is preferably from 20 to 300 m²/g, more preferably from 30 to 120 m²/g, and most preferably from 40 to 90 m²/g. The surface area can be determined by a BET method using nitrogen.

In the invention, a void-free silica particle may be used together with the hollow silica particle. The particle size of the void-free silica particle is preferably from 30 to 150 nm, more preferably from 35 to 100 nm, and most preferably from 40 to 80 nm.

Preferred embodiments of the inorganic fine particle and porous or hollow fine particle, preparation method, surface treatment method, and organosilane compound and metal chelate compound used in the surface treatment method are described in Paragraph Nos. [0033] to [0078] of JP-A-2009-98658, and they may also be used in the invention.

### [Antifouling Agent]

The composition according to the invention preferably contain an antifouling agent for the purposes of imparting a property, for example, an antifouling property, water resistance, chemical resistance or a slipping property and accelerating the local uneven distribution of the organic conductive compound in the layer thickness direction. As the antifouling agent, (D) a silicone-based antifouling agent or (E) a fluorine-containing antifouling agent or is preferred.

The fluorine-containing antifouling agent preferably contains a polymerizable unsaturated group. By using such an antifouling agent, prevention the fluorine-containing antifouling agent from transferring to the rare surface during the preservation of the coated film in the form of roll, improvement in the scratch resistance of the coated layer and improvement in the durability against the repetition of wiping off of stain can be achieved.

The amount of the antifouling agent added is preferably in a range from 0.01 to 20% by weight, more preferably from 0.05 to 10% by weight, particularly preferably from 0.1 to 5% by weight, based on the total solid content of the composition.

The fluorine-containing antifouling agent preferably contains a polymerizable unsaturated group. By using such an antifouling agent, prevention the fluorine-containing antifouling agent from transferring to the rare surface during the preservation of the coated film in the form of roll, improvement in the scratch resistance of the coated layer and improvement in the durability against the repetition of wiping off of stain can be achieved.

Preferred embodiments and specific examples of the fluorine-containing antifouling agent are described in Paragraph Nos. [0218] to [0219] of JP-A-2007-301970, and they may also be used in the invention.

The silicone-based antifouling agent is used for the purposes of imparting a slipping property to improve the scratch resistance and imparting the antifouling property and is preferably a compound having a polysiloxane structure. Preferred embodiments and specific examples of the silicone-based antifouling agent are described in Paragraph Nos. [0212] to [0217] of JP-A-2007-301970, and they may also be used in the invention.

### [Polymerization Initiator]

The composition according to the invention preferably contains a polymerization initiator. As the polymerization initiator, various kinds of polymerization initiators may be used and a photopolymerization initiator is preferred. Examples of the photopolymerization initiator includes an acetophenone, a benzoin, a benzophenone, a phosphine oxide, a ketal, an anthraquinone, a thioxanthone, an azo compound, a peroxide, a 2,3-dialkyldione compound, a disulfide compound, a fluoroamine compound, an aromatic sulfonium, a lophine dimer, an onium salt, a borate salt, an active ester, an active halogen, an inorganic complex and a coumarin.

Specific examples, preferred ranges, preferred embodiments, commercially available products and the like of the photopolymerization initiator are described in Paragraph Nos. [0131] to of JP-A-2009-98658, and they may also be used in the invention. Also, other polymerization initiators are described in Paragraph Nos. [0232] to [0236] of JP-A-2006-293329. The amount of the polymerization initiator added is preferably from 0.2 to 10% by weight, more preferably from 0.5 to 8% by weight, most preferably from 1 to 6% by weight, based on the total solid content of the layer.

### [Solvent for Coating]

The composition for forming the antistatic layer preferably contains a solvent. As the solvent, various solvents can be used which are selected by considering their properties, for example, in that they can dissolve or disperse the respective components, in that they are easily form a uniform surface state in the coating step and a drying step, in that they can ensure solution preservation property and in that they have appropriate saturated vapor pressures. The solid content concentration in the coating composition for forming the antistatic layer is preferably from 0.5 to 80% by weight, more preferably from 1 to 50% by weight, and most preferably from 1 to 20% by weight, and particularly from 1 to 10% by weight in case of using together with the fluorine-containing curable compound of component (C).

In particular, according to the invention, since the component (A) is intrinsically difficult to mix with the components (C), (D), (E) and (F), it is preferred to mix two or more good solvents for the respective components so as to be uniformly dissolved and coated.

In case of using two or more kinds of solvents as a mixture, it is preferred that at least one solvent is a good solvent for the organic conductive compound of component (A) and at least one solvent is a good solvent for the components other than the component (A). A mixing ratio (weight ratio) of the solvents is preferably from 1:9 to 9:1, and more preferably from 2:8 to 8:2. The boiling point of the solvent is not particularly restricted and is preferably from 50 to 200° C., from the standpoint of the handling property at room temperature and the reduced load for drying.

Specific examples of the solvent are set forth below, but the invention should not be construed as being limited thereto. The boiling point of each solvent is also shown in parentheses.

Specific examples of the good solvent for the conductive polymer of component (A) include tetrahydrofuran (66° C.), acetone (56° C.), ethanol (78° C.), isopropyl alcohol (82° C.), acetonitrile (82° C.), propylene glycol monomethyl ether (120° C.), propylene glycol monoethyl ether (132° C.), propylene glycol monobutyl ether (171° C.), propylene glycol monomethyl ether acetate (PGMEA) (146° C.), propylene glycol monoethyl ether acetate (PGM-AC) (145° C.), ethylene glycol monomethyl ether (124° C.), ethylene glycol monoethyl ether (135° C.), ethylene glycol monoethyl ether acetate (156° C.) and ethylene glycol diethyl ether (121° C.).

Specific examples of the good solvent for the components other than the component (A) include methyl ethyl ketone (80° C.), cyclohexanone (156° C.), methyl isobutyl ketone (116° C.), toluene (111° C.), xylene (138° C.), ethyl acetate (77° C.) and isopropyl acetate (89° C.).

In addition, the solvent further used for the formation of coating composition according to the invention includes compounds described in JP-A-2008-151866.

Another preferable example of using two or more kinds of organic solvents is to use two kinds of solvents where a difference of the boiling points thereof is larger than a specific value. The difference of the boiling points of two solvents is preferably 25° C. or more, more preferably 35° C. or more, and still more preferably 50° C. or more. When the difference of the boiling points is large, phase separation between the conductive polymer and the binder is apt to occur.

### [Method for Formation of Antistatic Layer]

With respect to the method for formation of antistatic layer, a curing condition suitable for a curable functional group contained in each component used in the layer can be selected. Preferred embodiments are described below.

### (i) System Using Compound Capable of Reacting by Heating

The curing temperature is preferably from 60 to 200° C., more preferably from 80 to 130° C., and most preferably from 80 to 110° C. In the case where the base material is liable to deteriorate at high temperature, the curing temperature is preferably low. The time required for heat curing is preferably from 30 seconds to 60 minutes, and more preferably from 1 to 20 minutes.

(ii) System Using Compound which is Cured by Irradiation of Ionizing Radiation as Trigger

In the case where the compound which is cured by irradiation of ionizing radiation as a trigger is used, it is effective to perform the curing by combining irradiation of ionizing radiation and a heat treatment before, simultaneous with or after the irradiation.

A few patterns of the production process are set forth below, but the invention should not be construed as being limited thereto.

In addition, a process of performing a heat treatment simultaneously with the ionizing radiation curing is also preferred.

TABLE 2

| | Before Irradiation | Irradiation | After Irradiation |
|---|---|---|---|
| (1) | Heat Treatment | Ionizing Radiation Curing | — |
| (2) | Heat Treatment | Ionizing Radiation Curing | Heat Treatment |
| (3) | — | Ionizing Radiation Curing | Heat Treatment |

In the table above, “-” denotes that the heat treatment is not performed.

### (Heat Treatment)

According to the invention, as described above, the heat treatment is preferably performed in combination with the irradiation of ionizing radiation. The heat treatment is not particularly limited as long as it does not impair the base material and constituting layers of laminate and is preferably from 60 to 200° C., more preferably from 80 to 130° C., and most preferably from 80 to 110° C.

### (Condition for Irradiation of Ionizing Radiation)

The layer surface temperature at the irradiation of ionizing radiation may not be particularly limited and is ordinarily from 20 to 200° C., preferably from 30 to 150° C., and most preferably from 40 to 120° C., in view of the handling property and uniformity of performance in the layer. The layer surface temperature not higher than the above-described upper limit is preferred because problems are avoided in that the flowability of the low molecular component in the binder excessively increases to deteriorate the surface state and in that the base material is damaged due to heat. The film surface temperature not lower than the above-described lower limit is also preferred because the curing reaction proceeds sufficiently and good scratch resistance of the layer is obtained.

The kind of ionizing radiation may not be particularly restricted and includes, for example, an X-ray, an electron beam, an ultraviolet ray, visible light and an infrared ray. The ultraviolet ray is widely used. For instance, in case of an ultraviolet curable layer, it is preferred to irradiate the layer with ultraviolet ray by an ultraviolet lamp in an irradiation dose from 10 to 1,000 mJ/cm² thereby performing curing. At the irradiation, the energy described above may be applied at once or dividedly. The irradiation time can be appropriately set in a range from 0.1 to 100 seconds.

### (Oxygen Concentration)

The oxygen concentration at the irradiation of ionizing radiation is preferably 3% by volume or less, more preferably 1% by volume or less, and still more preferably 0.1% by volume or less. When a step of maintaining the layer in an atmosphere having an oxygen concentration of 3% by volume or less is provided immediately before or immediately after the step of irradiating the ionizing radiation at an oxygen concentration of 3% by volume or less, the curing of the layer can be sufficiently promoted and a layer excellent in the physical strength and chemical resistance can be formed.

### [Layer Construction of Laminate]

The layer construction of the laminate according to the invention comprises a base material containing (B1) a fluorine-containing compound and/or (B2) a silicone-based compound and having thereon a layer (antistatic layer) formed from a composition containing (A) a conductive polymer.

The thickness of the antistatic layer according to the invention is preferably from 20 nm to 5 μm, more preferably from 50 nm to 3 μm, and most preferably from 70 to 900 nm. The base material containing component (B1) and/or component (B2) may be a base material formed by incorporating component (B1) and/or component (B2) at the time of formation of the base material as described hereinafter, a base material prepared by directly applying component (B1) and/or component (B2) on the base material, or a base material obtained by coating a curable resin containing component (B1) and/or component (B2) on a support and curing. From the standpoint of achieving a high degree of freedom for imparting a function, for example, hardcoat property, light scattering property or reflectance controlling property to the laminate, it is preferred to form a base material for the laminate by coating a curable resin containing component (B1) and/or component (B2) on a support and curing.

### [Base Material]

The laminate according to the invention has a construction comprising an antistatic layer containing a conductive polymer on a base material. The base material according to the invention is composed of a support having self-supporting property or a support having a laminate structure where at least one other layer (functional layer, for example, a hardcoat layer) is laminated on a support having self-supporting property.

### [Support]

As the support which can be used for the base material of the laminate according to the invention, for example, a glass substrate, an inorganic oxide material substrate, a metal material substrate, a plastic substrate, a plastic film, paper or cloth can be used. In view of the ease of post processing, ease of continuous production and large market for optical use, a transparent plastic film is preferably used. Examples of a polymer for forming the plastic film include a cellulose ester (for example, triacetyl cellulose or diacetyl cellulose, typically, for example, TAC-TD80U or TAC-TD80UF, produced by FUJIFILM Corp.), a polyamide, a polycarbonate, a polyester (for example, polyethylene terephthalate or polyethylene naphthalate), a polystyrene, a polyolefin, a norbornene resin (for example, ARTON, trade name, produced by JSR Corp.) and an amorphous polyolefin (for example, ZEONEX, trade name, produced by Zeon Corp.). Among them, triacetyl cellulose, polyethylene terephthalate or polyethylene naphthalate is preferred, and triacetyl cellulose is particularly preferred. Further, a cellulose acylate film substantially free from a halogenated hydrocarbon, for example, dichloromethane and a production method thereof are described in Journal of Technical Disclosure by The Japan Institute of Invention and Innovation (Technical Disclosure No 2001-1745, issued on Mar. 15, 2001, hereinafter referred to as “Journal of Technical Disclosure No. 2001-1745”) and the cellulose acylate described therein is also preferably used. The thickness of the support is not particularly restricted but when the application to a liquid crystal display device is considered, it is preferably from 20 to 200 μm, and more preferably from 40 to 80 μm.

According to the invention, the base material to which the antistatic layer formed from the composition containing the conductive polymer (A) is directly adjacent preferably contains a functional group described below in order to enhance the interaction with the sea region of the phase separation structure of the conductive polymer in the antistatic layer. By containing such a functional group, the affinity to the conductive polymer increases, whereby the effect of improving adhesion to the antistatic layer is obtained.

The functional group which the base material contains includes, for example, a hydroxy group, a carboxyl group, a phospho group, a sulfo group, an amido group, an amino group, a quaternary ammonium group and a silanol group. In the case of the dissociable functional group, it may form a salt. The functional group may be introduced into the base material in any form.

In the case where the base material is a support having self-supporting property per se and does not have a hardcoat layer or the like, it is preferred for the support to contain the functional group. For instance, a partially hydrophilized glass (containing a silanol group), a metal plate treated with a coupling agent (containing a hydroxy group derived from a silane coupling agent, a hydroxy group derived from a titanium coupling agent, a hydroxy group derived from a zirconium coupling agent or a hydroxy group derived from an aluminum coupling agent), a cellulose ester plastic film support (containing a hydroxy group), a cellulose ester plastic film support hydrophilized with saponification treatment (containing a hydroxy group) and a plastic support subjected to corona treatment or plasma treatment (containing a hydroxy group or a carboxyl group).

In the case where the base material comprises a support and a functional layer laminated on the support, it is preferred to introduce the above-described functional group into a binder for forming the functional layer or to incorporate filler into which the above-described functional group is introduced into the functional layer. Specifically, an acrylate monomer or silane coupling agent having the above-described functional group in its molecule is preferably used. Also, a surface of inorganic or organic filler itself or a surface subjected to modification to introduce the above-described functional group may be used.

The base material according to the invention preferably has a laminate structure where other layer is laminated on a support.

It is preferred that the base material according to the invention comprises a support and a layer formed by coating a curable resin on the support and curing, and a surface of the layer formed by coating a curable resin on the support and curing is the surface of the base material adjacent to the antistatic layer. It is particularly preferred that the layer formed by coating a curable resin on the support and curing is a hardcoat layer.

By appropriately selecting the structure and amount of component (B1) and/or component (B2) and coating together with the curable resin on a support, the state of the surface of the base material can be easily controlled. The curable resin layer adjacent to the lower side of the antistatic layer can double as various functional layers illustrated in the layer construction of the laminate described below.

The compound used in the layer includes a compound having two or more polymerizable groups in its molecule. The polymerizable group preferably includes a (meth)acryloyl group, an epoxy group, a hydroxy group and a silanol group, and is most preferably a (meth)acryloyl group. Specific examples of the compound include those described with respect to the non-fluorine-containing polyfunctional monomer which can be used in the antistatic layer.

According to the invention, various functional laminates can be formed by using a base material having a functional layer laminated on a support. Specific examples of the layer construction of the laminate according to the invention are set forth below. In the layer construction shown below, the term “antistatic layer (low refractive index layer)” means the antistatic layer also has a function of the low refractive index layer.

Support/antistatic layer

Support/antistatic layer (low refractive index layer)

Support/antistatic layer/low refractive index layer

Support/antiglare layer/antistatic layer (low refractive index layer)

Support/hardcoat layer/antistatic layer (low refractive index layer)

Support/hardcoat layer/antiglare layer/antistatic layer (low refractive index layer)

Support/hardcoat layer/high refractive index layer/antistatic layer (low refractive index layer)

Support/hardcoat layer/medium refractive index layer/high refractive index layer/antistatic layer (low refractive index layer)

Support/hard coat layer/antiglare layer/high refractive index layer/antistatic layer (low refractive index layer)

Support/hardcoat layer/antiglare layer/medium refractive index layer/high refractive index layer/antistatic layer (low refractive index layer)

Support/antiglare layer/high refractive index layer/antistatic layer (low refractive index layer)

Support/antiglare layer/medium refractive index layer/high refractive index layer/antistatic layer (low refractive index layer)

Further, a second antistatic layer (layer containing a conductive agent) may be formed in addition to the antistatic layer containing a conductive polymer according to the invention. In this case, the second antistatic layer may be provided at any position of the laminate and specific examples of the layer construction thereof containing the second antistatic layer are set forth below.

Support/second antistatic layer/antistatic layer (low refractive index layer)

Support/antiglare layer/second antistatic layer/antistatic layer (low refractive index layer)

Support/hardcoat layer/antiglare layer/second antistatic layer/antistatic layer (low refractive index layer)

Support/hardcoat layer/second antistatic layer/antiglare layer/antistatic layer (low refractive index layer)

Support/hardcoat layer/second antistatic layer/high refractive index layer/antistatic layer (low refractive index layer)

Support/second antistatic layer/hardcoat layer/medium refractive index layer/high refractive index layer/antistatic layer (low refractive index layer)

Second antistatic layer/support/hardcoat layer/medium refractive index layer/high refractive index layer/antistatic layer (low refractive index layer)

Support/second antistatic layer/antiglare layer/medium refractive index layer/high refractive index layer/antistatic layer (low refractive index layer)

Second antistatic layer/support/antiglare layer/medium refractive index layer/high refractive index layer/antistatic layer (low refractive index layer)

Second antistatic layer/support/antiglare layer/high refractive index layer/low refractive index layer/high refractive index layer/antistatic layer (low refractive index layer)

The layer constitution of the laminate according to the invention is not particularly limited to those described above. The high refractive index layer may be a light diffusible layer having no antiglare property. In the case of providing an antifouling layer, it can be provided as the uppermost layer of the above layer constitution. Further, although a laminate having another layer formed on the antistatic layer may be used, it is preferred that a common logarithm value (log SR) of surface resistivity SR (Ω/sq) of the outermost surface of the laminate is from 3.0 to 13.0.

[At Least One Compound Selected from (B1) Fluorine-Containing Compound and (B2) Silicone-Based Compound]

According to the invention, at least one compound selected from (B1) a fluorine-containing compound and (B2) a silicone-based compound is added to the surface of the base material adjacent to the antistatic layer as a low surface free energy component and the low surface free energy component is distributed at an uneven concentration in the in-plane direction of the surface of the base material so that the conductive polymer in the antistatic layer segregates at the time of coating, whereby a sea-island phase separation structure is formed in the antistatic layer.

According to the invention, when the base material is composed of only the support described above, it is preferred that at least one compound selected from (B1) a fluorine-containing compound and (B2) a silicone-based compound is added to the support and distributed in the surface of the support on the side adjacent to the antistatic layer. When the base material comprises the support and other layer provided on the support, it is preferred that at least one compound selected from (B1) a fluorine-containing compound and (B2) a silicone-based compound is added to the other layer on the support and distributed in the surface of the other layer on the side adjacent to the antistatic layer.

The concentration of the fluorine-containing compound (B1) and/or silicone-based compound (B2) in the surface of the base material adjacent to the sea region containing the conductive polymer of the antistatic layer is preferably lower than the concentration of the fluorine-containing compound (B1) and/or silicone-based compound (B2) in the surface of the base material adjacent to the island region of the antistatic layer.

Observation of the state of interface can be performed by measuring the secondary ion inherent to the fluorine-containing compound (B1) and/or silicone-based compound (B2) using, for example, the oblique cutting TOF-SIMS method described above. The terminology “the fluorine-containing compound (B1) and/or silicone-based compound (B2) is distributed at an uneven concentration” as used herein means that the local concentration of the compound has a concentration difference of 15% or more based on the average value of the concentration. The concentration difference is more preferably 30% or more.

The surface of the base material indicates the region from the outermost surface to about 10 nm in thickness of the base material on the antistatic layer side.

In the laminate according to the invention, at least one compound selected from (B1) a fluorine-containing compound and (B2) a silicone-based compound is distributed at an uneven concentration in the in-plane direction of the surface of the base material adjacent to the antistatic layer. The unevenness of the fluorine-containing compound (B1) and/or silicone-based compound (B2) has been formed in the surface of the base material prior to the coating of a coating solution for antistatic layer. Alternatively, the concentration distribution of the fluorine-containing compound (B1) and/or silicone-based compound (B2) has been even before the coating of a coating solution for antistatic layer but becomes uneven in the process of the coating of a coating solution for antistatic layer and curing.

In the process of the coating of a coating solution for antistatic layer and curing, since the conductive polymer contained in the coating solution for antistatic layer is apt to be eliminated from the part (part where the component (B1) and/or component (B2) is present in a large amount) having a low surface free energy in the surface of the base material and the conductive polymer contained in the coating solution for antistatic layer is apt to aggregate on the part (part where the component (B1) and/or component (B2) is not present or present in a small amount) having a high surface free energy in the surface of the base material, the sea-island structure described above is formed in the antistatic layer.

The formation of the in-plane unevenness of the component (B1) and/or component (B2) in the surface of the base material can be performed, for example, by conducting gravure printing of the component with change in its concentration on the base material or forming a pattern using an inkjet head on the base material before the coating of a coating solution for antistatic layer. More simply, the concentration distribution of the component having a low surface energy can also be formed in the surface of the base material by using the component having a low surface energy in an amount smaller than the amount necessary for completely covering the whole surface of the base material.

With respect to the method where the even concentration distribution of the component before the coating of a coating solution for antistatic layer makes uneven in the process of the coating of a coating solution for antistatic layer and curing, the uneven concentration distribution of the component is performed, for example, by utilizing difference in the molecular weight in case of using the components (B1) and/or components (B2) having the same structure or by utilizing difference in the elution rate of the component (B1) and/or component (B2) into a solvent contained in the coating solution for antistatic layer at the coating of antistatic layer in case of using the components (B1) and/or components (B2) having different structures. Further, since a fluoroaliphatic group-containing polymer containing 10% by weight or more of polymerization unit derived from a fluoroaliphatic group-containing monomer described hereinafter segregates on the surface of the base material at the time of coating of a coating solution containing the fluoroaliphatic group-containing polymer on the support and partially diffuses into the composition for forming the antistatic layer at the time of coating of a coating solution for antistatic layer on the layer formed the coating solution containing the fluoroaliphatic group-containing polymer, the fluoroaliphatic group-containing polymer is preferred in view of forming the unevenness of the surface free energy on the surface of the base material.

Now, the fluorine-containing compound (B1) is described in detail below.

The fluorine-containing compound is not particularly restricted as long as it can reduce surface energy and can be formed in the form of film or coated so as to be distributed on the surface of the base material. It is preferably a derivative of an aliphatic or aromatic hydrocarbon wherein the hydrogen atoms are substituted with fluorine atoms having a molecular weight from 200 to 1,000,000 and more preferably a fluorine-substituted aliphatic hydrocarbon derivative. The molecular weight of the fluorine-containing compound is a weight average molecular weight (MW) determined by a differential refractive index detector using a GPC analyzer with a column of TSKgel GMHxL, TSKgel G4000HxL, TSKgel G2000HxL (produced by Tosoh Corp.) and THF as a solvent and calculated in terms of polystyrene.

In particular, with respect to the method where the even concentration distribution of the fluorine-containing compound before the coating of a coating solution for antistatic layer makes uneven in the process of the coating of a coating solution for antistatic layer and curing, the uneven concentration distribution of the fluorine-containing compound is performed, for example, by utilizing difference in the molecular weight in case of using the fluorine-containing compounds having the same structure or by utilizing difference in the elution rate of the fluorine-containing compound into a solvent contained in the coating solution for antistatic layer at the coating of antistatic layer in case of using the fluorine-containing compounds having different structures.

In the case of utilizing difference in the elution rate of the fluorine-containing compound into a solvent contained in the coating solution for antistatic layer for forming a sea-island structure, when difference in the molecular weight is used in order to generate the difference in the elution rate, the sea-island structure of the conductive polymer can be formed at the formation of antistatic layer by using at least one low molecular weight component having approximately from 200 to less than 15,000 as a component having a high elution rate together with at least one high molecular weight component having approximately from 15,000 to 1,000,000 as a component having a low elution rate. A relative value of the amounts of the low molecular weight component and high molecular weight component is preferably from 95/5 to 35/65, more preferably from 90/10 to 40/60, most preferably from 90/10 to 50/50, in terms of a weight ratio of low molecular weight component/high molecular weight component. The value is an example in case of fluorine-containing polymers containing the same unit structure. In case of fluorine-containing polymers containing different unit structures or the like, a mixing ratio thereof can be appropriately adjusted according to the difference in the elution rate of the respective fluorine-containing polymers or the like.

Further, in order to generate the difference in the elution rate, difference in the structure of the fluorine-containing compound can also be used. For example, the elution rate can be reduced by introducing a structure having high affinity to a material coexisting with the fluorine-containing compound in the surface of the base material into the fluorine-containing compound. Specifically, the compounds having, for example, an aliphatic or aromatic hydrocarbon group containing no fluorine atom, a hydroxy group, a carboxyl group, a phospho group, a sulfo group, an amido group, an acyl group, a quaternary ammonium group, a silanol group, an alkyleneoxide group, a glycidyl group or a (meth)acryloyl group are exemplified. Further, the compound preferably has a common functional group to a material forming the surface layer of the base material. A method for introducing such a group into the fluorine-containing compound is not restricted and it is preferred to form a fluorine-containing copolymer using a polymerizable unit having such a group and a polymerizable unit having a fluorine atom. Such a group may be introduced into any of main chain and side chain of the fluorine-containing polymer.

In the case where the material forming the surface layer of the base material is a curable material, by introducing a functional group which reacts with the curable material into the fluorine-containing compound and conducting curing at the formation of base material, elution of the fluorine-containing compound is remarkably restrained at the subsequent coating of the antistatic layer. Thus, by using together a curable fluorine-containing compound with a noncurable fluorine-containing compound, concentration of the fluorine-containing compound in the in-plane direction of the surface of the base material can make uneven. As the curable functional group, a (meth)acryloyl group, an epoxy group, a hydroxy group or a silanol group is preferred and a (meth)acryloyl group is most preferred. A ratio of the curable fluorine-containing compound and the noncurable fluorine-containing compound used is preferably from 5/95 to 50/50, more preferably from 10/90 to 30/70, in terms of a weight ratio.

Of the fluorine-containing compounds, a fluoroaliphatic group-containing polymer containing 10% by weight or more of a polymerization unit derived from a fluoroaliphatic group-containing monomer described hereinafter is excellent in adhesion property between the antistatic layer and the base material and scratch resistance. In order to generate the sea-island phase separation of the conductive polymer in the antistatic layer, a layer (lower layer) containing the fluoroaliphatic group-containing polymer is immersed in a solvent of a coating solution for forming the antistatic layer and dried to increase a surface free energy of the lower layer preferably by 1 mN/m or more, more preferably by 3 mN/m or more. The increase in the surface free energy means that the fluoroaliphatic group-containing polymer is extracted with the solvent of a coating solution for forming the antistatic layer, and the in-plane fluctuation of volatilization rate of the solvent at the extraction, the unevenness of molecular weight of the fluoroaliphatic group-containing polymer in the surface of the base material or the like triggers the phase separation of the conductive polymer at the interface of the base material and the antistatic layer.

The fluoroaliphatic group-containing polymer (hereinafter, also abbreviated as a “fluorine-based polymer”) is preferably a polymer having in its side chain, a perfluoroalkyl group having 4 or more carbon atoms or a fluoroalkyl group having 4 or more carbon atoms and a —CF₂H group.

Among them, an acrylic resin or methacrylic resin containing a repeating unit (polymerization unit) corresponding to a monomer of (i) shown below and a repeating unit (polymerization unit) corresponding to a monomer of (ii) shown below and a copolymer formed from these monomers and a vinyl monomer copolymerizable with these monomers are useful. As the copolymerizable monomer, monomers described in J. Brandrup, Polymer Handbook, 2nd ed., Chapter 2, pages 1 to 483, Wiley Interscience (1975) can be used.

For example, compounds having one addition-polymerizable unsaturated bond selected from acrylic acid, methacrylic acid, acrylates, methacrylates, acrylamides, methacrylamides, ally compounds, vinyl ethers, vinyl esters and the like are exemplified.
(i) Fluoroaliphatic group-containing monomer represented by formula (2) shown below

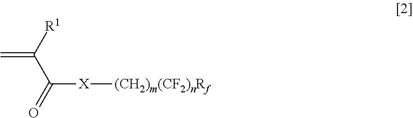

In formula (2), R¹ represents a hydrogen atom, a halogen atom or a methyl group, and preferably represents a hydrogen atom or a methyl group. X represents an oxygen atom, a sulfur atom or —N(R¹²)—, preferably represents an oxygen atom or —N(R¹²)—, and more preferably represents an oxygen atom. R¹² represents a hydrogen atom or an alkyl group having from 1 to 8 carbon atoms which may have a substituent, preferably represents a hydrogen atom or an alkyl group having from 1 to 4 carbon atoms, and more preferably represents a hydrogen atom or a methyl group. Rf represents —CF₃ or —CF₂H.

m in formula (2) represents an integer from 1 to 6, preferably represents an integer from 1 to 3, and more preferably represents 1.

n in formula (2) represents an integer from 1 to 17, preferably represents an integer from 4 to 11, and more preferably represents 6 or 7. Rf is preferably —CF₂H.

The fluorine-based polymer may contain two or more kinds of polymerization units derived from the fluoroaliphatic group-containing monomers represented by formula (2) as the constituting components.

(ii) Monomer copolymerizable with (i) above represented by formula (3) shown below

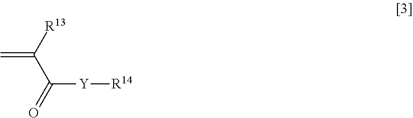

In formula (3), R¹³ represents a hydrogen atom, a halogen atom or a methyl group, and preferably represents a hydrogen atom or a methyl group. Y represents an oxygen atom, a sulfur atom or —N(R¹⁵)—, preferably represents an oxygen atom or —N(R¹⁵)—, and more preferably represents an oxygen atom. R¹⁵ represents a hydrogen atom or an alkyl group having from 1 to 8 carbon atoms, preferably represents a hydrogen atom or an alkyl group having from 1 to 4 carbon atoms, and more preferably represents a hydrogen atom or a methyl group.

R¹⁴ represents a straight-chain, branched or cyclic alkyl group having from 1 to 60 carbon atoms which may have a substituent or an aromatic group which may have a substituent (for example, a phenyl group or a naphthyl group). The alkyl group may contain a poly(alkyleneoxy) group. R¹⁴ is more preferably a straight-chain, branched or cyclic alkyl group having from 1 to 12 carbon atoms, an alkyl group containing a poly(alkyleneoxy) group and having from 5 to 40 carbon atoms or an aromatic group containing from 6 to 18 carbon atoms, and extremely preferably a straight-chain, branched or cyclic alkyl group having from 1 to 8 carbon atoms or an alkyl group containing a poly(alkyleneoxy) group and having from 5 to 30 carbon atoms. The poly(alkyleneoxy) group is described below.

The poly(alkyleneoxy) group is represented by (OR)ₓ, wherein R represents an alkylene group having from 2 to 4 carbon atoms, and preferably includes, for example, —CH₂CH₂—, —CH₂CH₂CH₂—, —CH(CH₃)CH₂— or —CH(CH₃)CH(CH₃)—. x represents from 2 to 30, preferably represents from 2 to 20, and more preferably represents from 4 to 15.

In the poly(oxyalkylene) group, the oxyalkylene unit may be the same as in poly(oxypropylene), two or more kinds of oxyalkylene units which are different from each other may be irregularly distributed, a straight-chain or branched oxypropylene unit or oxyethylene unit may be present, or a block of a straight-chain or branched oxypropylene unit and a block of an oxyethylene unit may be present.

The poly(oxyalkylene) chain may contain a poly(oxyalkylene) chain in which poly(oxyalkylene) chains are connected with one or more linkings (for example, —CONH-Ph-NHCO— or —S—, wherein Ph represents a phenylene group). The linkage having three or more valences provides means for obtaining a branched oxyalkylene unit. When the copolymer described above is used in the invention, a molecular weight of the poly(oxyalkylene) group is suitably from 250 to 3,000.

A poly(oxyalkylene) acrylate or methacrylate can be produced by reacting a commercially available hydroxy poly(oxyalkylene) compound, for example, products sold under trade names of “PLURONIC” produced by Adeka Corp., “ADEKA POLYETHER” produced by Adeka Corp., “CARBOWAX” produced by Glico products Co., Ltd.), “TRITON” (produced by Rohm and Haas Co., Ltd.) and “P.E.G” (produced by Dai-Ichi Kogyo Seiyaku Co., Ltd.) with acrylic acid, methacrylic acid, acryl chloride, methacryl chloride, acrylic anhydride or the like. Alternatively, a poly(oxyalkylene) diacrylate produced by a known method or the like may be used.

An amount of the monomer unit derived from the fluoroaliphatic group-containing monomer represented by formula (2) in the fluorine-based polymer used in the invention is preferably 10% by weight or more, more preferably 40% by weight or more, still more preferably 50% by weight or more, particularly preferably in a range from 70 to 100% by weight, based on the total monomer unit of the fluorine-based polymer.

An amount of the monomer unit derived from the monomer represented by formula (3) in the fluorine-based polymer used in the invention is preferably less than 90% by weight, more preferably less than 60% by weight, still more preferably less than 50% by weight, based on the total monomer unit of the fluorine-based polymer.

A weight average molecular weight of the fluorine-based polymer used in the invention is preferably from 3,000 to 100,000, more preferably from 6,000 to 80,000, and still more preferably from 8,000 to 60,000.

The weight average molecular weight above is a molecular weight determined by a differential refractive index detector using a GPC analyzer with a column of TSKgel GMHxL, TSKgel G4000HxL, TSKgel G2000HxL (produced by Tosoh Corp.) and THF as a solvent and calculated in terms of polystyrene. The molecular weight is calculated from peak areas of 300 or more components.

With respect to the amount of the fluorine-based polymer used in the invention, in view of expression of the effect by the addition, drying and prevention of surface state failure, the solid content (% by weight) of the fluorine-based polymer is preferably from 0.03 to 3% by weight, more preferably from 0.05 to 0.5% by weight, most preferably from 0.08 to 0.2% by weight, based on the total solid content of a coating solution.

Specific examples of the structure of the fluorine-based polymer according to the invention are set forth below, but the invention should not be construed as being limited thereto. In the formulae below, the numeral indicates a molar ratio of each monomer component and Mw indicates a weight average molecular weight.

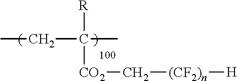

| | R | n | Mw |
|---|---|---|---|
| FP-1 | H | 4 | 8000 |
| FP-2 | H | 4 | 16000 |
| FP-3 | H | 4 | 33000 |
| FP-4 | CH₃ | 4 | 12000 |
| FP-5 | CH₃ | 4 | 28000 |
| FP-6 | H | 6 | 8000 |
| FP-7 | H | 6 | 14000 |
| FP-8 | H | 6 | 29000 |
| FP-9 | CH₃ | 6 | 10000 |
| FP-10 | CH₃ | 6 | 21000 |
| FP-11 | H | 8 | 4000 |
| FP-12 | H | 8 | 16000 |
| FP-13 | H | 8 | 31000 |
| FP-14 | CH₃ | 8 | 3000 |
| FP-15 | CH₃ | 8 | 10000 |
| FP-16 | CH₃ | 8 | 27000 |
| FP-17 | H | 10 | 5000 |
| FP-18 | H | 10 | 11000 |
| FP-19 | CH₃ | 10 | 4500 |
| FP-20 | CH₃ | 10 | 12000 |
| FP-21 | H | 12 | 5000 |
| FP-22 | H | 12 | 10000 |
| FP-23 | CH₃ | 12 | 5500 |
| FP-24 | CH₃ | 12 | 12000 |

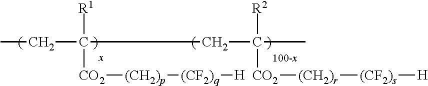

| | x | R¹ | p | q | R² | r | s | Mw |
|---|---|---|---|---|---|---|---|---|
| FP-25 | 50 | H | 1 | 4 | CH₃ | 1 | 4 | 10000 |
| FP-26 | 40 | H | 1 | 4 | H | 1 | 6 | 14000 |
| FP-27 | 60 | H | 1 | 4 | CH₃ | 1 | 6 | 21000 |
| FP-28 | 10 | H | 1 | 4 | H | 1 | 8 | 11000 |
| FP-29 | 40 | H | 1 | 4 | H | 1 | 8 | 16000 |
| FP-30 | 20 | H | 1 | 4 | CH₃ | 1 | 8 | 8000 |
| FP-31 | 10 | CH₃ | 1 | 4 | CH₃ | 1 | 8 | 7000 |
| FP-32 | 50 | H | 1 | 6 | CH₃ | 1 | 6 | 12000 |
| FP-33 | 50 | H | 1 | 6 | CH₃ | 1 | 6 | 22000 |
| FP-34 | 30 | H | 1 | 6 | CH₃ | 1 | 6 | 5000 |
| FP-35 | 40 | CH₃ | 1 | 6 | H | 3 | 6 | 3000 |
| FP-36 | 10 | H | 1 | 6 | H | 1 | 8 | 7000 |
| FP-37 | 30 | H | 1 | 6 | H | 1 | 8 | 17000 |
| FP-38 | 50 | H | 1 | 6 | H | 1 | 8 | 16000 |
| FP-39 | 50 | CH₃ | 1 | 6 | H | 3 | 8 | 19000 |
| FP-40 | 50 | H | 1 | 8 | CH₃ | 1 | 8 | 5000 |
| FP-41 | 80 | H | 1 | 8 | CH₃ | 1 | 8 | 10000 |
| FP-42 | 50 | CH₃ | 1 | 8 | H | 3 | 8 | 14000 |
| FP-43 | 90 | H | 1 | 8 | CH₃ | 3 | 8 | 9000 |
| FP-44 | 70 | H | 1 | 8 | H | 1 | 10 | 7000 |
| FP-45 | 90 | H | 1 | 8 | H | 3 | 10 | 12000 |
| FP-46 | 50 | H | 1 | 8 | H | 1 | 12 | 10000 |
| FP-47 | 70 | H | 1 | 8 | CH₃ | 3 | 12 | 8000 |

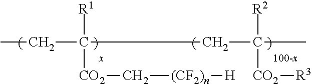

| | x | R¹ | n | R² | R³ | Mw |
|---|---|---|---|---|---|---|
| FP-48 | 80 | H | 4 | CH₃ | CH₃ | 11000 |
| FP-49 | 90 | H | 4 | H | C₄H₉(n) | 7000 |
| FP-50 | 95 | H | 4 | H | C₆H₁₃(n) | 5000 |
| FP-51 | 90 | CH₃ | 4 | H | CH₂CH(C₂H₅)C₄H₉(n) | 15000 |
| FP-52 | 70 | H | 6 | CH₃ | C₂H₅ | 18000 |
| FP-53 | 90 | H | 6 | CH₃ | 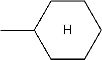 | 12000 |
| FP-54 | 80 | H | 6 | H | C₄H₉(sec) | 9000 |
| FP-55 | 90 | H | 6 | H | C₁₂H₂₅(n) | 21000 |
| FP-56 | 60 | CH₃ | 6 | H | CH₃ | 15000 |
| FP-57 | 60 | H | 8 | H | CH₃ | 10000 |
| FP-58 | 70 | H | 8 | H | C₂H₅ | 24000 |
| FP-59 | 70 | H | 8 | H | C₄H₉(n) | 5000 |
| FP-60 | 50 | H | 8 | H | C₄H₉(n) | 16000 |
| FP-61 | 80 | H | 8 | CH₃ | C₄H₉(iso) | 13000 |
| FP-62 | 80 | H | 8 | CH₃ | C₄H₉(t) | 9000 |
| FP-63 | 60 | H | 8 | H | 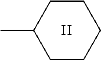 | 7000 |
| FP-64 | 80 | H | 8 | H | CH₂CH(C₂H₅)C₄H₉(n) | 8000 |
| FP-65 | 90 | H | 8 | H | C₁₂H₂₅(n) | 6000 |
| FP-66 | 80 | CH₃ | 8 | CH₃ | C₄H₉(sec) | 18000 |
| FP-67 | 70 | CH₃ | 8 | CH₃ | CH₃ | 22000 |
| FP-68 | 70 | H | 10 | CH₃ | H | 17000 |
| FP-69 | 90 | H | 10 | H | H | 9000 |
| FP-70 | 95 | H | 4 | CH₃ | —(CH₂CH₂O)₂—H | 18000 |
| FP-71 | 80 | H | 4 | H | —(CH₂CH₂O)₂—CH₃ | 16000 |
| FP-72 | 80 | H | 4 | H | —(C₃H₆O)₇—H | 24000 |
| FP-73 | 70 | CH₃ | 4 | H | —(C₃H₆O)₁₈—H | 18000 |
| FP-74 | 90 | H | 6 | H | —(CH₂CH₂O)₂—H | 21000 |
| FP-75 | 90 | H | 6 | CH₃ | —(CH₂CH₂O)₈—H | 9000 |
| FP-76 | 80 | H | 6 | H | —(CH₂CH₂O)₂—C₄H₉(n) | 12000 |
| FP-77 | 80 | H | 6 | H | —(C₃H₆O)₇—H | 34000 |
| FP-78 | 75 | F | 6 | H | —(C₃H₆O)₁₃—H | 11000 |
| FP-79 | 85 | CH₃ | 6 | CH₃ | —(C₃H₆O)₂₀—H | 18000 |
| FP-80 | 95 | CH₃ | 6 | CH₃ | —CH₂CH₂OH | 27000 |
| FP-81 | 80 | H | 8 | CH₃ | —(CH₂CH₂O)₈—H | 12000 |
| FP-82 | 95 | H | 8 | H | —(CH₂CH₂O)₉—CH₃ | 20000 |
| FP-83 | 90 | H | 8 | H | —(C₃H₆O)₇—H | 8000 |
| FP-84 | 95 | H | 8 | H | —(C₃H₆O)₂₀—H | 15000 |
| FP-85 | 90 | F | 8 | H | —(C₃H₆O)₁₃—H | 12000 |
| FP-86 | 80 | H | 8 | CH₃ | —(CH₂CH₂O)₂—H | 20000 |
| FP-87 | 95 | CH₃ | 8 | H | —(CH₂CH₂O)₉—CH₃ | 17000 |
| FP-88 | 90 | CH₃ | 8 | H | —(C₃H₆O)₇—H | 34000 |
| FP-89 | 80 | H | 10 | H | —(CH₂CH₂O)₃—H | 19000 |
| FP-90 | 90 | H | 10 | H | —(C₃H₆O)₇—H | 8000 |
| FP-91 | 80 | H | 12 | H | —(CH₂CH₂O)₇—CH₃ | 7000 |
| FP-92 | 95 | CH₃ | 12 | H | —(C₃H₆O)₇—H | 10000 |

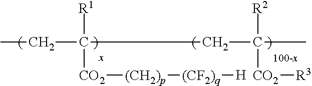

| | x | R¹ | p | q | R² | R³ | Mw |
|---|---|---|---|---|---|---|---|
| FP-93 | 80 | H | 2 | 4 | H | C₄H₉(n) | 18000 |
| FP-94 | 90 | H | 2 | 4 | H | —(CH₂CH₂O)₉—CH₃ | 16000 |
| FP-95 | 90 | CH₃ | 2 | 4 | F | C₆H₁₃(n) | 24000 |
| FP-96 | 80 | CH₃ | 1 | 6 | F | C₄H₉(n) | 18000 |
| FP-97 | 95 | H | 2 | 6 | H | —(C₃H₆O)₇—H | 21000 |
| FP-98 | 90 | CH₃ | 3 | 6 | H | —CH₂CH₂OH | 9000 |
| FP-99 | 75 | H | 1 | 8 | F | CH₃ | 12000 |
| FP-100 | 80 | H | 2 | 8 | H | CH₂CH(C₂H₅)C₄H₉(n) | 34000 |
| FP-101 | 90 | CH₃ | 2 | 8 | H | —(C₃H₅O)₇—H | 11000 |
| FP-102 | 80 | H | 3 | 8 | CH₃ | CH₃ | 18000 |
| FP-103 | 90 | H | 1 | 10 | F | C₄H₉(n) | 27000 |
| FP-104 | 95 | H | 2 | 10 | H | —(CH₂CH₂O)₉—CH₃ | 12000 |
| FP-105 | 85 | CH₃ | 2 | 10 | CH₃ | C₄H₉(n) | 20000 |
| FP-106 | 80 | H | 1 | 12 | H | C₆H₁₃(n) | 8000 |
| FP-107 | 90 | H | 1 | 12 | H | —(CH₃H₆O)₁₃—H | 15000 |
| FP-108 | 60 | CH₃ | 3 | 12 | CH₃ | C₂H₅ | 12000 |
| FP-109 | 60 | H | 1 | 16 | H | CH₂CH(C₂H₅)C₄H₉ (n) | 20000 |
| FP-110 | 80 | CH₃ | 1 | 16 | H | —(CH₂CH₂O)₂—C₄H₉(n) | 17000 |
| FP-111 | 90 | H | 1 | 18 | H | —CH₂CH₂OH | 34000 |
| FP-112 | 60 | H | 3 | 18 | CH₃ | CH₃ | 19000 |

| | | |
|---|---|---|
| 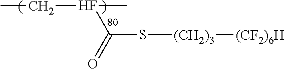 | 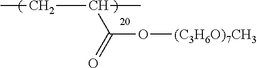 | FP-113 Mw 39,000 |
| 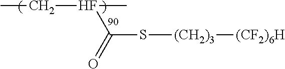 | 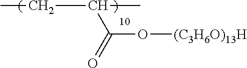 | FP-114 Mw 45,000 |
| 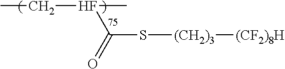 | 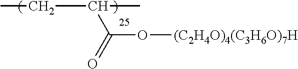 | FP-115 Mw 46,000 |
| 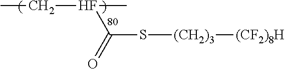 | 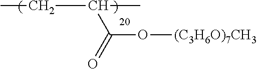 | FP-116 Mw 28,000 |
| 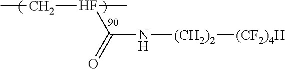 | 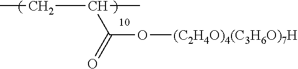 | FP-117 Mw 56,000 |
| 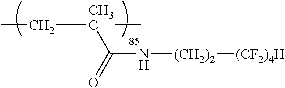 | 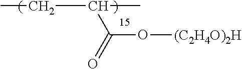 | FP-118 Mw 32,000 |
| 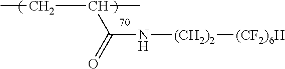 | 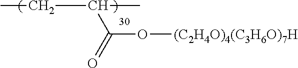 | FP-119 Mw 29,000 |
| 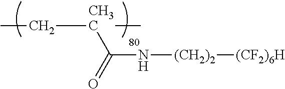 | 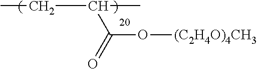 | FP-120 Mw 45,000 |
| 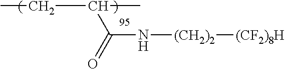 | 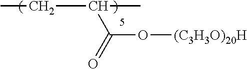 | FP-121 Mw 30,000 |
| 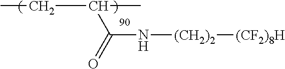 | 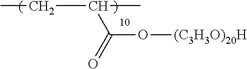 | FP-122 Mw 32,000 |
| 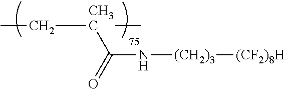 | 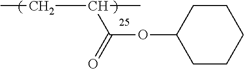 | FP-123 Mw 48,000 |
| 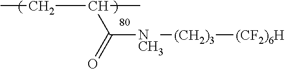 | 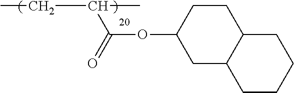 | FP-124 Mw 39,000 |
| 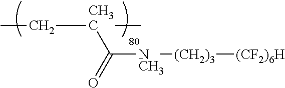 | 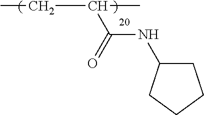 | FP-125 Mw 45,000 |
| 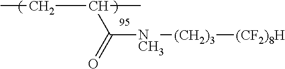 | 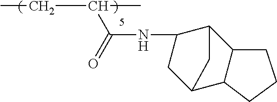 | FP-126 Mw 28,000 |
| 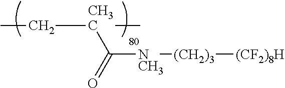 | 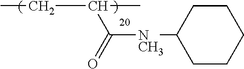 | FP-127 Mw 29,000 |
| 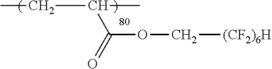 | 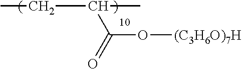 | FP-128 Mw 30,000 |
| 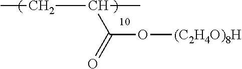 | | |
| 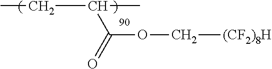 | 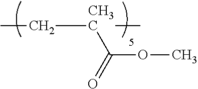 | FP-129 Mw 31,000 |
| 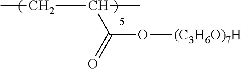 | | |
| 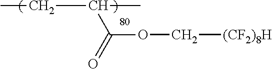 | 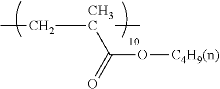 | FP-130 Mw 40,000 |
| 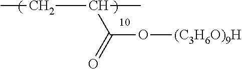 | | |
| 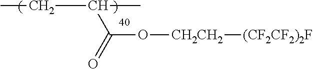 | 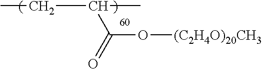 | FP-131 Mw 15,000 |
| 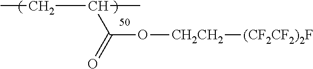 | 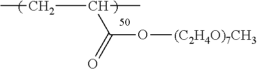 | FP-132 Mw 15,000 |
| 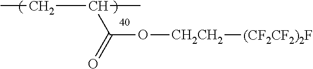 | 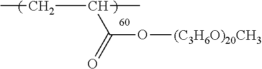 | FP-133 Mw 30,000 |
| 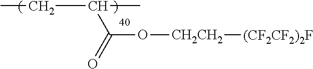 | 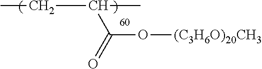 | FP-134 Mw 50,000 |
| 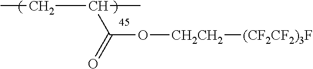 | 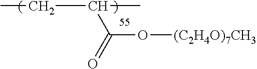 | FP-135 Mw 15,000 |
| 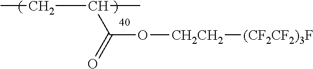 | 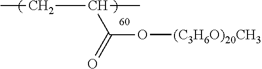 | FP-136 Mw 7,000 |
| 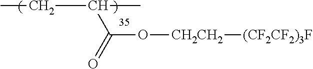 | 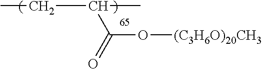 | FP-137 Mw 20,000 |
| 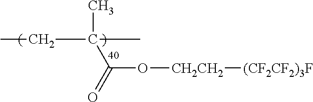 | 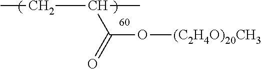 | FP-138 Mw 15,000 |
| 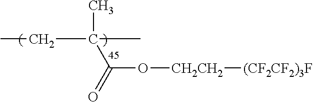 | 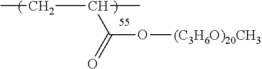 | FP-139 Mw 40,000 |
| 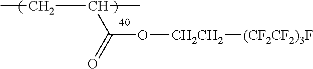 | 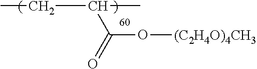 | FP-140 Mw 15,000 |
| 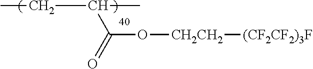 | 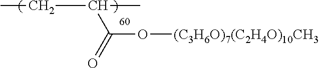 | FP-141 Mw 20,000 |
| 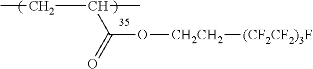 | 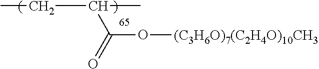 | FP-142 Mw 25,000 |

Now, the silicone-based compound (B2) is described in detail below.

As the silicone-based compound, a compound containing a structure represented by formula (S1) shown below can be used.

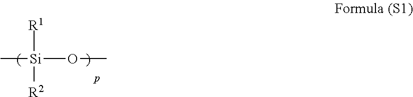

In formula (S1), R¹ and R², which may be the same or different, each represents an alkyl group or an aryl group. p represents an integer from 10 to 500.

The alkyl group has preferably from 1 to 10 carbon atoms and more preferably from 1 to 5 carbon atoms.

The aryl group has preferably from 6 to 20 carbon atoms and more preferably from 6 to 10 carbon atoms.

The alkyl group or aryl group may have a substituent. The substituent is not particularly restricted and includes an amino group, an epoxy group, a carboxyl group, a hydroxy group, a perfluoroalkyl group, a perfluoroalkylene group, a perfluoroalkyl ether group, a (meth)acryloyl group, a (meth)acryloyloxy group, a vinyl group, an alkoxy group and a polyether-modified group.

According to the invention, a silicone-based compound containing an amino group, a carboxyl group or a polyether-modified group which is relatively hard to be extracted with the antistatic layer and a silicone-based compound which does not contain such a group may be used together. A content of the silicone-based compound which is relatively hard to be eluted is preferably from 5 to 50% by weight, more preferably from 10 to 30% by weight, based on the total silicone-based compound.

In the case where the material forming the surface layer of the base material is a curable material, by introducing a functional group which reacts with the curable material into the silicone-based compound and conducting curing at the formation of base material, elution of the silicone-based compound is remarkably restrained at the subsequent coating of the antistatic layer. Thus, by using together a curable silicone-based compound with a noncurable silicone-based compound, concentration of the silicone-based compound in the in-plane direction of the surface of the base material can make uneven. As the curable functional group, a (meth)acryloyl group, an epoxy group, a hydroxy group or a silanol group is preferred and a (meth)acryloyl group is most preferred. A ratio of the curable silicone-based compound and the noncurable silicone-based compound used is preferably from 5/95 to 50/50, more preferably from 10/90 to 30/70, in terms of a weight ratio.

With respect to examples of the silicone-based compound containing a functional group which reacts with the curable material, as the silicone-based compound containing an unsaturated double bond in its molecule, X-22-174DX, X-22-2426, X-22-164B, X-22-164C and X-22-1821 (trade names, produced by Shin-Etsu Chemical Co., Ltd.), FM-0725, FM-7725, FM-6621, FM-1121, SILAPLANE FM0275 and SILAPLANE FM0271 (trade names, produced by Chisso Corp.), and DMS-U22, RMS-033, RMS-083, UMS-182, DMS-H21, DMS-H31, HMS-301, FMS121, FMS123, FMS131, FMS141 and FMS221 (trade names, produced by Gelest, Inc.) are exemplified but the invention should not be construed as being limited thereto.

With respect to examples of the silicone-based compound containing a thermosetting functional group in its molecule, as the silicone-based compound containing a hydroxy group, X-22-160AS, KF-6001, KF-6002, KF-6003, X-22-170DX, X-22-176DX, X-22-176D and X-22-176F (produced by Shin-Etsu Chemical Co., Ltd.), FM-4411, FM-4421, FM-4425, FM-0411, FM-0421, FM-0425, FM-DA11 and FM-DA25 (produced by Chisso Corp.), and CMS-626 and CMS-222 (produced by Gelest, Inc.) are exemplified.

As examples of the silicone-based compound containing a functional group which reacts with a hydroxy group, X-22-162C and KF-105 (produced by Shin-Etsu Chemical Co., Ltd.), and FM-5511, FM-5521, FM-5525, FM-6611, FM-6621 and FM-6625 (produced by Chisso Corp.) are exemplified.

Silicone-based compounds described in Tables 2 and 3 of JP-A-2003-112383 are also preferably used.

In particular, in case of intending to use the silicone-based compound having high fixity, a copolymer containing a polysiloxane structure in its main chain or side chain and having a crosslinkable reactive group can be used. Specific examples thereof include copolymers described in Tables 1 and 2 of JP-A-2007-291372 and copolymers described in Table 1 of JP-A-2008-106190.

Further, according to the invention as the low surface free energy component, the fluorine-containing compound (B1) and silicone-based compound (B2) may be used together in the surface of the base material adjacent to the antistatic layer. Since these compounds have different structures, the phase separation state is easily generated in the surface of the base material and difference in the elution rate to the antistatic layer is easily made, the sea-island phase separation of the conductive polymer is easily triggered in the antistatic layer. With respect to amount of the component (B1) and component (B2) added, the solid content (% by weight) of these components in total is preferably from 0.03 to 3% by weight, more preferably from 0.05 to 0.5% by weight, most preferably from 0.08 to 0.2% by weight, based on the total solid content of a coating solution. By controlling the amount added to the range described above, the sea-island phase separation of the conductive polymer is easily triggered on the surface of the base material.

### [Low Refractive Index Layer]

In the case where the antistatic layer formed from a composition containing the conductive polymer (A) is used as a layer which doubles as a low refractive index layer, the refractive index of the layer is preferably from 1.20 to 1.49, more preferably from 1.25 to 1.49, still more preferably from 1.25 to 1.46, and particularly preferably from 1.30 to 1.46. The refractive index can be directly measured by an Abbe refractometer or can be quantitatively determined by measurement of spectral reflection spectrum or spectral ellipsometry.

In order to achieve the refractive index described above, for example, to use the fluorine-containing curable compound described above is used as a binder of the antistatic layer or to incorporate the inorganic fine particle having a hollow structure to the antistatic layer is exemplified.

The thickness of the low refractive index layer is preferably from 50 to 400 nm, more preferably from 60 to 200 nm, and most preferably from 70 to 120 nm.

The haze of the low refractive index layer is preferably 3% or less, more preferably 2% or less, and most preferably 1% or less.

The strength of the low refractive index layer is preferably H or more, more preferably 2H or more, most preferably 3H or more, in the pencil hardness test applied a load of 500 g.

Further, in order to improve the antifouling property of the laminate, the contact angle of the surface of the low refractive index layer with water is preferably 90 degrees or more, more preferably 95 degrees or more, and particularly preferably 100 degrees or more.

### [High Refractive Index Layer]

The high refractive index layer preferably contains an inorganic filler which is composed of an oxide of at least one metal selected from titanium, zirconium, aluminum, indium, zinc, tin and antimony and has an average particle size of preferably 0.2 μm or less, more preferably 0.1 μm or less, and still more preferably 0.06 μm or less, in order to increase the refractive index of the layer and to reduce the cure shrinkage.

Similar to a hardcoat layer, the high refractive index layer may contain a mat particle or the inorganic filler in the range of amount similar to that of the hardcoat layer.

Further, in the high refractive index layer containing a high refractive index mat particle for the purpose of increasing the difference of refractive index between the mat particle and the layer, silicon oxide is preferably used in order to maintain the refractive index of the layer at a low level. A preferable particle size of the silicon oxide is same as that described for the inorganic fine particle used in the low refractive index layer above.

The bulk refractive index of a mixture of a binder and the inorganic filler constituting the high refractive index layer according to the invention is preferably from 1.48 to 2.00, and more preferably from 1.50 to 1.80. By appropriately selecting the kind and proportion of the binder and the inorganic filler, the refractive index can be controlled to the above-described range. How to make the selection can be easily known by preliminary experiments.

The high refractive index layer is described in Paragraph Nos. [0197] to [0206] of JP-A-2009-98658.

### [Hardcoat Layer]

The hardcoat layer is provided on the surface of support, if desired, in order to impart the physical strength to the laminate. In particular, it is preferably provided between the support and the high refractive index layer (or medium refractive index layer). The hardcoat layer may also double as a high refractive index layer by incorporating the high refractive index particle or the like as described above into the layer.

The hardcoat layer is preferably formed by a crosslinking reaction or a polymerization reaction of an ionizing radiation curable resin. For example, it can be formed by coating a coating composition containing an ionizing radiation curable polyfunctional monomer or polyfunctional oligomer on a support and causing a crosslinking reaction or a polymerization reaction of the polyfunctional monomer or polyfunctional oligomer.

Similar to the high refractive index layer, the hardcoat layer may contain a mat particle or the inorganic filler, in the range of amount similar to that of the high refractive index layer. As a result, an antiglaring property can be imparted to the hardcoat layer. Further, by adjusting refractive indexes of the mat particle and binder, the haze value and transmittance can be controlled.

### (Surface State Improving Agent)

A coating solution used for preparing any layer on the support may contain a surface state improving agent in order to relieve defects of the surface state (for example, coating unevenness, drying unevenness or point defect). As the surface state improving agent, at least any of fluorine-based and silicone-based surface state improving agents is preferred.

The surface state improving agent is described in Paragraph Nos. [0258] to [0285] of JP-A-2006-293329 and it may also be used in the invention.

### [Performances of Laminate]

The common logarithm value (Log SR) of surface resistivity SR (Ω/sq) of the surface of the antistatic layer of the laminate according to the invention is from 3.0 to 13.0, preferably from 4 to 12, and more preferably from 5 to 11. By controlling the value of surface resistivity in the range described above, the excellent dust resistance can be imparted without the degradation of film strength. The surface resistivity is a value measured at 25° C. and 60% relative humidity.

The laminate according to the invention contains the conductive polymer (A) in the antistatic layer and at least one kind of the fluorine-containing compound (B1) and the silicone-based compound (B2) in the surface of the base material adjacent to the antistatic layer at uneven concentration in the in-plane direction of the surface as described above and the surface resistivity described above can be achieved by appropriately selecting the kinds and concentrations of the conductive polymer (A), fluorine-containing compound (B1) and silicone-based compound (B2) and further the kinds of the fluorine-containing curable compound (C), silicone-based antifouling agent (D), volatile solvent and the like which may be used as the optional components. Although the laminate according to the invention may further have a layer containing another antistatic material (conductive material), the antistatic layer is preferably one layer from the standpoint of productivity, adhesion property of the coated film or the like.

In the laminate according to the invention, for the purpose of decreasing light scattering, the haze value is preferably from 0 to 1%, and for the purpose of imparting light scattering property, the haze value is preferably from 3 to 70%, and more preferably from 4 to 60%.

In the laminate according to the invention, the average reflectance in the range from 450 to 650 nm is preferably 3.0% or less, and more preferably 2.5% or less.

### [Production Method of Laminate]

The laminate according to the invention is preferably produced by a method including: distributing, onto the base material, at least one compound selected from (B1) a fluorine-containing compound and (B2) a silicone-based compound at an uneven concentration in an in-plane direction of a surface of the base material; and applying a solution containing a conductive polymer for forming the antistatic layer onto the base material.

The laminate according to the invention can be produced by the methods described below, but the method should not be construed as being limited thereto.

First, a coating solution containing the components for forming each layer is prepared. The resulting coating solution is coated on a base material by using, for example, a dip coating method, an air knife coating method, a curtain coating method, a roller coating method, a wire bar coating method, a gravure coating method or an extrusion coating method (see U.S. Pat. No. 2,681,294), followed by heating and drying. Of the coating methods, a gravure coating method is preferably used, because the coating solution can be coated in a small coating amount with a high uniformity of layer thickness as in the formation of each layer of the antireflective layer. Of the gravure coating methods, a microgravure coating method is more preferred because of the high uniformity of layer thickness.

Also, in the case of using the die coating method, the coating solution can be coated in a small coating amount with high uniformity of layer thickness. In addition, since the die coating method is a pre-metering system, it is advantageous in that control of the layer thickness is relatively easy and in that vaporization of the solvent in a coating unit is small.

Two or more layers may be simultaneously coated. A method of simultaneous coating is described in U.S. Pat. Nos. 2,761,791, 2,941,898, 3,508,947, and 3,526,528 and Yuji Harazaki, Coating Kogaku (Coating Engineering, page 253, Asakura Publishing Co., Ltd. (1973).

### [Saponification Treatment]

In the case of using the laminate according to the invention in a liquid crystal display device, ordinarily, for example, the laminate is provided with an adhesive layer on one surface thereof and then placed as the outermost surface of the display. For instance, when the support is triacetyl cellulose, since triacetyl cellulose is used as a protective film for protecting a polarizing film of polarizing plate, it is preferred in view of cost that the laminate according to the invention is used as it is as the protective film.

As described above, in the case where the laminate according to the invention is placed on the outermost surface of display or is used as it is as the protective film for polarizing plate, it is preferred to perform saponification treatment after formation of the antistatic layer on the base material in order to improve the adhesion property.

The saponification treatment is described in Paragraph Nos. [0289] to [0293] of JP-A-2006-293329 and it may also be used in the invention.

The laminate according to the invention is preferably used as an optical film.

### [Polarizing Plate]

A polarizing plate is mainly composed of two protective films sandwiching a polarizing film from the both surfaces thereof. It is preferred that the laminate according to the invention is used as at least one of the two protective films sandwiching a polarizing film from the both surfaces thereof. When the laminate according to the invention doubles as a protective film, the production cost of the polarizing plate can be reduced. Further, by using the laminate according to the invention as the outermost surface layer, it is possible to form a polarizing plate which is prevented, for example, from glare of external light and which is excellent, for example, in the scratch resistance or antifouling property. As the polarizing film, known polarizing film can be used. The polarizing film is described in Paragraph Nos. [0299] to [0301] of JP-A-2006-293329 and it may also be used in the invention.

### [Image Display Device]

The laminate according to the invention can be used for an image display device, for example, a liquid crystal display device (LCD), a plasma display panel (PDP), an electroluminescence display device (ELD), a cathode ray tube display device (CRT), a field emission display (FED) or a surface-conduction electron-emitter display (SED) in order to prevent reduction in contrast due to reflection of external light or reflected glare image. The optical film or polarizing plate having the optical film according to the invention is preferably placed on the surface (on the viewing side of the display screen) of a display of the liquid crystal display device.

In case of using the laminate according to the invention as one side of a surface protective film of a polarizing film, it can be preferably used for transmission type, reflection type or semi-transmission type liquid crystal display devices of a twisted nematic (TN) mode, a super twisted nematic (STN) mode, a vertical alignment (VA) mode, an in-plane switching (IPS) mode, an optically compensated bend cell (OCB) mode, an electrically controlled birefringence (ECB) mode or the like. The liquid crystal display device is described in Paragraph Nos. [0303] to [0307] of JP-A-2006-293329.

The laminate according to the present invention can be applied, for example, to an optical film for solar battery cell, a material for non-display surface of home appliance (antifouling and antistatic layer), decorative laminate, wallpaper or a base material for protecting clock face, as well as the optical film for image display device described above.

### EXAMPLES

The present invention will be described with reference to the following examples, but the invention should not be construed as being limited thereto. Unless otherwise specifically indicated, all “part” and “%” are on a weight basis.

### [Preparation of Coating Solution (HC-1) for Hardcoat Layer]

The composition containing each component shown in Table 3 was prepared and filtered through a polypropylene filter having a pore size of 30 μm to prepare Coating solution (HC-1) for hardcoat layer.

TABLE 3
Composition of Coating solution (HC-1) for hardcoat layer

| Coating solution | HC-1 |
|---|---|
| Binder | PET-30: 22.9 g |
| | BISCOAT 360: 22.9 g |
| Photopolymerization | IRGACURE 907: 1.5 g |
| initiator | |
| Light diffusion particle | 8 μm Crosslinked acryl/styrene particle |
| | (30% by weight MIBK dispersion): 8.3 g |
| Solvent | MIBK: 19.2 g |
| | MEK: 25 g |
| Fluorine-containing | R-1: 0.056 g |
| compound | |

The compounds used are described below.

PET-30: Mixture of pentaerythritol triacrylate and pentaerythritol tetraacrylate (produced by Nippon Kayaku Co., Ltd.)
BISCOAT 360: Trimethylolpropane PO-modified triacrylate (produced by Osaka Organic Chemical Industry Ltd.)
DPHA: Mixture of dipentaerythritol pentaacrylate and dipentaerythritol hexaacrylate (KAYARAD DPHA, produced by Nippon Kayaku Co., Ltd.)
UV1700B: Urethane binder (produced by The Nippon Synthetic Chemical Industry Co., Ltd.)
8 μm Crosslinked acryl/styrene particle (30% by weight): A dispersion in MIBK obtained by dispersing crosslinked acryl/styrene particles having an average particle size of 8.0 μm (produced by Sekisui Chemical Co., Ltd.) by POLYTRON disperser at 10,000 rpm for 20 minutes
6 μm Crosslinked acryl/styrene particle (30% by weight): A dispersion in MIBK obtained by dispersing crosslinked acryl/styrene particles having an average particle size of 6.0 μm and refractive index of 1.52 (produced by Sekisui Chemical Co., Ltd.) by POLYTRON disperser at 10,000 rpm for 20 minutes
2 μm Crosslinked acryl/styrene particle (30% by weight): A dispersion in MIBK obtained by dispersing crosslinked acryl/styrene particles having an average particle size of 2.0 μm and refractive index of 1.53 (produced by Sekisui Chemical Co., Ltd.) by POLYTRON disperser at 10,000 rpm for 20 minutes
IRGACURE 907: Photopolymerization initiator (produced by Ciba Specialty Chemicals Inc.)
IRGACURE 127: Photopolymerization initiator (produced by Ciba Specialty Chemicals Inc.)
MIBK: Methyl isobutyl ketone
MEK: Methyl ethyl ketone
R-1: Fluorine-based surfactant shown below (used as a 10% by weight MEK solution)

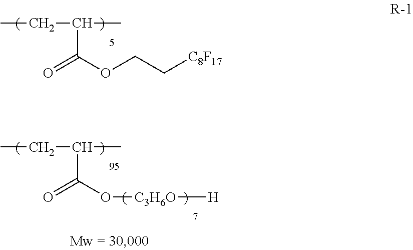

Coating solutions (HC-2) to (HC-9) for hardcoat layer were prepared in the same manner as in Coating solution (HC-1) for hardcoat layer except for changing Fluorine-containing compound R-1 in Coating solution (HC-1) to the fluorine-containing compound (B1) or silicone-based compound (B2) as shown in Table 4 below, respectively. The amount of the compound added shown in Table 4 means a solid content (% by weight) of the compound based on the total solid content in the coating solution. Further, Coating solutions (HC-10) to (HC-14) for hardcoat layer having the compositions shown in Table 4 (cont'd) below were prepared in the same manner as in Coating solution (HC-1) for hardcoat layer, respectively.

TABLE 4

| | |
|---|---|
| Fluorine-containing Compound | Silicone-based Compound |
| (solid content) | (solid content) |

| | | Amount | | Amount |
|---|---|---|---|---|
| | Kind | (% by weight) | Kind | (% by weight) |
| HC-1 | R-1 | 0.1 | — | — |
| HC-2 | FP-69 | 0.1 | — | — |
| HC-3 | FP-138 | 0.1 | — | — |
| HC-4 | FP-62 | 0.05 | — | — |
| | FP-138 | 0.05 | | |
| HC-5 | FP-62 | 0.08 | FM0721 | 0.02 |
| HC-6 | — | — | FM0721 | 0.03 |
| | | | FM4421 | 0.13 |
| HC-7 | — | — | KF945 | 0.03 |
| | | | FM4421 | 0.13 |
| HC-8 | — | — | — | — |
| HC-9 | — | — | X22-164C | 0.016 |

| | HC-10 | HC-11 | HC-12 | HC-13 | HC-14 |
|---|---|---|---|---|---|
| Binder | PET-30: 28.7 g | PET-30: 31.1 g | UV1700B: 52.5 g | PET-30: 28.7 g | PET-30: 28.7 g |
| | BISCOAT 360: | DPHA: 18.7 g | — | BISCOAT 360: | BISCOAT 360: |
| | 17.2 g | | | 17.2 g | 17.2 g |
| Photopolymerization | IRGACURE 127: | IRGACURE 127: | IRGACURE 127: | IRGACURE 127: | IRGACURE 127: |
| initiator | 1.7 g | 1.7 g | 1.7 g | 1.7 g | 1.7 g |
| Light diffusion | 6 μm Crosslinked | 2 μm Crosslinked | 2 μm Crosslinked | 6 μm Crosslinked | 6 μm Crosslinked |
| particle | acryl/styrene particle | acryl/styrene particle | acryl/styrene particle | acryl/styrene | acryl/styrene particle |
| | (30% by weight | (30% by weight | (30% by weight | particle (30% by | (30% by weight |
| | MIBK dispersion): | MIBK dispersion): | MIBK dispersion): | weight MIBK | MIBK dispersion): |
| | 18.3 g | 7.6 g | 7.6 g | dispersion): 18.3 g | 18.3 g |
| Solvent | MIBK: 5.5 g | MIBK: 12.3 g | MIBK: 17.2 g | MIBK: 5.5 g | MIBK: 5.5 g |
| | MEK: 23.7 g | MEK: 24.3 g | MEK: 24.3 g | MEK: 23.7 g | MEK: 23.7 g |
| Leveling agent | R-1: 0.55 g | FP-62: 0.35 g | FP-62: 0.35 g | X-22-164C: 0.55 g | FP-62: 0.35 g |
| | | FP-138: 0.2 g | FP-138: 0.2 g | | FP-138: 0.2 g |

The compounds used in the tables are described below.

R-1: Mw=30,000, component having molecular weight of less than 15,000=15% by weight
FP-69: Mw=9,000, component having molecular weight of less than 15,000=70% by weight
FP-138: Mw=15,000, component having molecular weight of less than 15,000=50% by weight
FP-62: Mw=9,000, component having molecular weight of less than 15,000=70% by weight
FM0721: Mw=5,000, one-terminal methacryloyloxy group modified polydimethylsiloxane (produced by Chisso Corp.)
FM4421: Mw=5,000, both-terminal hydroxy group modified polydimethylsiloxane (produced by Chisso Corp.)
KF945: side-chain polyether modified silicone (HLB: 4) (produced by Shin-Etsu Chemical Co., Ltd.)
X-22-164C: Mn=10,000, both-terminal methacryloyloxy group modified polydimethylsiloxane (produced by Shin-Etsu Chemical Co., Ltd.)

### [Preparation of Coating Solutions (Ln-1) to (Ln-19) for Antistatic Layer]

### 1. Preparation of Dispersion of Organic Conductive Compound

### Preparation Example 1

### Preparation of Dispersion (A) of Organic Conductive Compound

A mixture of 200 g of toluene, 2 g of aniline, 4.2 g of dodecylbenzenesulfonic acid, 1.0 g of polyacrylic acid derivative and 0.03 g of 4-methylaniline was dissolved to prepare a solution and 60 g of distilled water containing 3.58 ml of 6N hydrochloric acid dissolved was added thereto.

To the resulting mixed solution was added 180 mg of tetrabutylammonium bromide, the mixture was cooled to 5° C. or lower and then 30 g of distilled water containing 5.4 g of ammonium persulfate dissolved was added thereto. The mixture was subjected to oxidation polymerization at the state of 5° C. or lower for 4 hours and then toluene was removed by vacuum distillation.

The resulting polyaniline precipitate was collected by filtration and washed with water to obtain the desired polyaniline. The polyaniline was dispersed in 200 g of toluene, the aqueous layer was removed, and the concentration was adjusted to 2% by weight to obtain toluene dispersion (A). The organic conductive compound obtained is a compound in which dodecylbenzenesulfonic acid is doped in polyaniline. The specific dielectric constant of toluene as the solvent is 2.2.

### Preparation Example 2

### Preparation of Dispersion (B) of Organic Conductive Compound

Using 6,000 g of distilled water and 400 ml of 36% hydrochloric acid, 400 g of aniline was dissolved. To the resulting solution was added 500 g of a 5 mol/l aqueous sulfuric acid solution and the mixture was cooled to −5° C.

In a beaker, 980 g (4.295 mol) of ammonium peroxodisulfate was added to 2,293 g of distilled water and dissolved to prepare an aqueous solution of oxidizing agent. The aqueous ammonium peroxodisulfate solution was gradually added dropwise to the aqueous acidic solution of aniline with stirring while cooling at −5° C. to obtain blackish green precipitate.

The resulting polymer precipitate was collected by filtration, washed with water and then with acetone and vacuum-dried at room temperature to obtain power of quinonediimine-phenylenediamine type conductive polyaniline. In 90 g of N-methyl-2-prrolidone was dissolved 1.49 g of phenylhydrazine and then was dissolved 10 g of the solvent-soluble quinonediimine-phenylenediamine type polyaniline with stirring.

Separately, 5 g of 1,5-naphthalenedisulfonic acid tetrahydrate and 2.92 g of diethanolamine were dissolved in 58.92 g of N-methyl-2-prrolidone. With 5 g of the polyaniline solution was mixed 3.33 g of the solution of 1,5-naphthalenedisulfonic acid and the mixture was subjected to defoaming treatment. The solution was diluted so as to have a solvent composition of N-methyl-2-prrolidone and methyl ethyl ketone in a mixing ratio of 1:1 by weight to obtain polyaniline dispersion (B) having a solid content concentration of 4% by weight. The organic conductive compound obtained is a compound in which 1,5-naphthalenedisulfonic acid is doped in polyaniline. The average specific dielectric constant of the solvents is 23.8.

### Preparation Example 3

### Preparation of Solution (C) of Organic Conductive Compound

To 1,000 ml of a 2% by weight aqueous solution of polystyrenesulfonic acid having a molecular weight of about 100,000 (PS-5, produced by Tosoh Organic Chemical Co., Ltd.) was added 8.0 g of 3,4-ethylenedioxythiophene, followed by mixing at 20° C. To the mixed solution was added 100 ml of an oxidation catalyst solution (containing 15% by weight of ammonium persulfate and 4.0% by weight of ferric sulfate), the mixture was stirred at 20° C. for 3 hours to undergo reaction.

To the resulting reaction solution was added 1,000 ml of ion-exchanged water and then about 1,000 ml of the liquid was removed using an ultrafiltration method. These operations were repeated 3 times.

To the resulting solution were added 100 ml of an aqueous 10% by weight sulfuric acid solution and 1,000 ml of ion-exchanged water and then about 1,000 ml of the liquid was removed using an ultrafiltration method. To the resulting solution was added 1,000 ml of ion-exchanged water and then about 1,000 ml of the liquid was removed using an ultrafiltration method. These operations were repeated 5 times. Thus, about 1.1% by weight aqueous solution of PEDOT-PSS was obtained. The solid content concentration of the solution was adjusted with ion-exchanged water to make a 1.0% by weight aqueous solution, thereby preparing organic conductive polymer solution (C). The solution (C) is an aqueous solution and the dielectric constant of water is 80.

### Preparation Example 4

### Preparation of Acetone Solution (D) of Organic Conductive Polymer

To the 200 ml of the aqueous solution (C) of PEDOT-PSS prepared in Preparation Example 3 was added 200 ml of acetone and then 210 ml of water and acetone was removed using an ultrafiltration method. These operations were repeated one more time and the solid content concentration was adjusted with acetone to prepare a 1.0% by weight water/acetone solution. To 200 ml of the solution was added 500 ml of acetone containing 2.0 g of trioctylamine dissolved and the mixture was stirred by a stirrer for 3 hours. Using an ultrafiltration method, 510 ml of water and acetone was removed. The solid content concentration of the solution was adjusted with acetone to make a 1.0% by weight acetone solution, thereby preparing organic conductive polymer solution (D). The water content of the solution was 2% by weight and the dielectric constant of the solvent was 22.7.

### Preparation Example 5

### Preparation of Methyl Ethyl Ketone Solution (E) of Organic Conductive Polymer

To the 200 ml of the solution (D) of PEDOT-PSS prepared in Preparation Example 4 was added 300 ml of methyl ethyl ketone and the mixture was concentrated under a reduced pressure at room temperature until the total volume became 200 ml. The solid content concentration of the solution was adjusted with methyl ethyl ketone to make a 1.0% by weight methyl ethyl ketone solution, thereby preparing organic conductive polymer solution (E). The water content of the solution was 0.05% by weight and the residual ratio of acetone was 1% by weight or less. The dielectric constant of the solvent was 15.5.

### 2. Synthesis of Fluorine-Containing Curable Compound

### 2-1: Synthesis of Compound F-1

Compound F-1 described hereinbefore as the specific example of the polymerizable fluorine-containing compound was synthesized according to a route shown below.

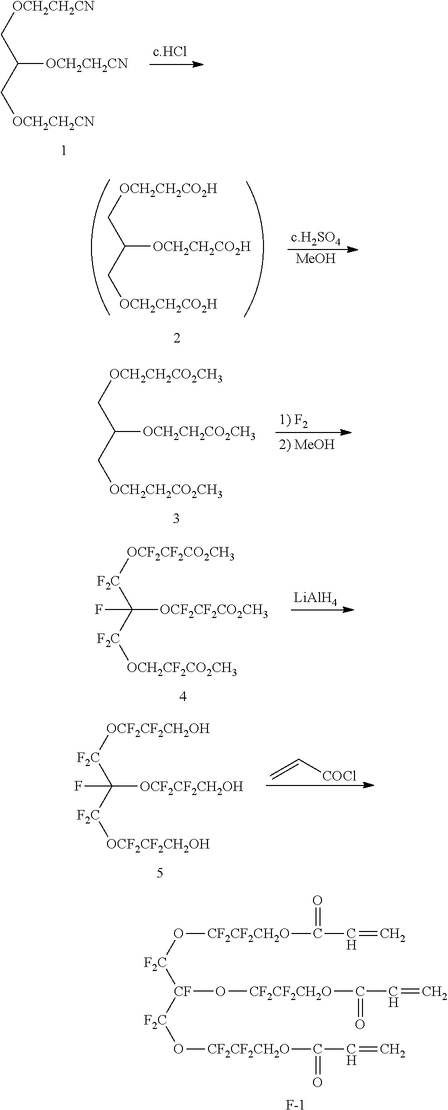

### (Synthesis of Compound 3)

To 110 ml of concentrated hydrochloric acid was dropwise added 4 ml of a methanol solution containing 36.6 g (145.6 mmol) of Compound 1 known in literature (for example, Journal of American Chemical Society, 70, 214 (1948)) at 50° C. over a period of one hour. The reaction solution was stirred at 65° C. for 6 hours, cooled to 35° C., and 80 ml of methanol was added thereto, followed by stirring at the temperature for 5 hours. The reaction solution was extracted with a mixture of 150 ml of toluene and 100 ml of a 10% by weight aqueous sodium chloride solution, and the organic layer was concentrated to obtain Compound 2. To the concentrated residue of Compound 2 were added 40 ml of methanol and one ml of concentrated sulfuric acid, and the mixture was stirred at room temperature for 4 hours. The reaction solution was extracted with a mixture of 150 ml of toluene and 150 ml of a 7.5% by weight aqueous sodium hydrogen carbonate solution, and the organic layer was washed with 150 ml of a 25% by weight aqueous sodium chloride solution and dried over sodium sulfate. The solvent was removed by distillation under a reduced pressure and the residue was purified by column chromatography (developing solvent: ethyl acetate/hexane=1/3) to obtain 40.8 g (116.5 mmol, yield of 80%) of Compound 3.

### (Synthesis of Compound 4)

In a 1-liter reaction vessel made of Teflon® equipped with a raw material inlet, a fluorine inlet, a helium gas inlet and air outlet which was connected to a fluorine trap through a reflux apparatus cooled with dry ice was charged 750 ml of a chlorofluorocarbon solvent. Helium gas was introduced at a flow rate of 100 ml/min into the reaction vessel at an inner temperature of 30° C. for 30 minutes. Sequentially, 20% F₂/N₂ gas was introduced thereinto at a flow rate of 100 ml/min for 30 minutes. Then, the fluorine flow rate was controlled to 200 ml/min, and a mixed solution of 15 g (42.8 mmol) of Compound 3 and 4.0 ml of hexafluorobenzene was added at a rate of 1.1 ml/h. The fluorine flow rate was decreased to 100 ml/min, 1.2 ml of hexafluorobenzene was added at a rate of 0.6 ml/h, and 20% F₂/N₂ gas was introduced thereinto at a flow rate of 100 ml/min for 15 minutes. After substituting the gas in the reaction vessel with helium gas, 100 ml of methanol was added to the reaction vessel, the mixture was stirred for one hour and then the solvent was removed at a reduced pressure. The concentrated residue was washed with an ether/aqueous sodium hydrogen carbonate solution, and the ether layer was dried on magnesium sulfate. After distilling off the ether, the residue was purified by distillation at 2 mm Hg to obtain 17.4 g (26.5 mmol, yield of 62%) of Compound 4.

### (Synthesis of Compound 5)

In 300 ml of diethyl ether was dispersed 3.5 g of lithium aluminum hydride and 100 ml of a diethyl ether solution containing 10 g (15.2 mmol) of Compound 4 was dropwise added thereto at a temperature of 10° C. or lower. The reaction solution was stirred at a room temperature for 6 hours, and 100 ml of ethyl acetate was gradually added dropwise thereto. The solution was gradually poured into a mixture of diluted aqueous hydrochloric acid/ice/ethyl acetate and an insoluble material was removed by filtration. The organic layer was washed with water and then with an aqueous sodium chloride solution, dried on magnesium sulfate and then concentrated under a reduced pressure. The residue was purified by column chromatography (developing solvent: ethyl acetate/hexane=1/1) to obtain 8.0 g (14.0 mmol, yield of 92%) of Compound 5 as a viscous oily product.

### (Synthesis of Compound F-1)

In 120 ml of acetonitrile solution containing 5.7 g (10 mmol) and 9.0 g of potassium carbonate was dropwise added 2.7 ml of acrylic chloride at a temperature of 10° C. or lower. After stirring the reaction mixture at a room temperature for 5 hours, 8 g of potassium carbonate and 2.5 ml of acrylic chloride were added thereto, followed by further stirring 20 hours. The reaction solution was poured into a mixture of 500 ml of ethyl acetate and 500 ml of diluted aqueous hydrochloric acid to separate. The organic layer was washed with an aqueous sodium hydrogen carbonate solution and then an aqueous sodium chloride solution and purified by column chromatography (developing solvent: ethyl acetate/hexane=1/3) to obtain 5.4 g (yield of 74%) of Compound F-1.

3. Preparation of Inorganic Fine Particle Dispersion (Silica Dispersion A-2)

To 500 g of a hollow silica fine particle sol (isopropyl alcohol silica sol, average particle size: 60 nm, thickness of shell: 10 nm, silica concentration: 20% by weight, refractive index of silica particle: 1.31, prepared according to Preparation Example 4 of JP-A-2002-79616, provided that the size was changed) were added 10 g of acryloyloxypropyltrimethoxysilane (produced by Shin-Etsu Chemical Co., Ltd.) and 1.0 g of diisopropoxyaluminum ethyl acetate to mix, and then 3 g of ion-exchanged water was added thereto. After reacting at 60° C. for 8 hours, the reaction solution was cooled to a room temperature, and 1.0 g of acetyl acetone was added thereto. While adding cyclohexanone to 500 g of the resulting dispersion so as to maintain the silica content almost constant, solvent replacement by reduced-pressure distillation was performed. The occurrence of a foreign material was not observed in the dispersion. The viscosity was 5 mPa·s at 25° C., when the solid content concentration was controlled to 22% by weight with cyclohexanone. The remaining amount of isopropyl alcohol in Dispersion A-2 was analyzed by gas chromatography and found to be 1.0% by weight.

### 4. Preparation of Composition for Antistatic Layer

Each of the components was mixed in the ratio (% by weight) shown in Table 5 below and diluted with the solvent shown in Table 5 to prepare Coating solutions (Ln-1) to (Ln-19) for antistatic layer each having a solid content concentration of 3.0% by weight, respectively.

Although Coating solutions (Ln-2) to (Ln-19) exhibited good solubility, Coating solution (Ln-1) was not mixed and normal coating could not be conducted.

TABLE 5

| | Composition for Antistatic Layer (solid content) | | | | | | | | | | | |
|---|---|---|---|---|---|---|---|---|---|---|---|---|
| | | | | | | | | | Polymeri- | | | |
| | Fluorine- | | Organic | | | | Anti- | | zation | | | |
| | Containing | | Conductive | | Poly- | | fouling | | Initiator | Inorganic | | |
| | Curable | | Compound | | functional | | Agent (D) | | (IRGACURE- | Particle | | |
| | Compound (C) | | (A) | | Monomer | | or (F) | | 907) | (F) | | Solvent for |
| | Kind | Amount | Kind | Amount | Kind | Amount | Kind | Amount | Amount | Kind | Amount | Dilution |
| Ln-1 | — | 0 | (C) | 20 | DPHA | 78 | — | 0 | 2 | — | 0 | MEK(85) |
| | | | | | | | | | | | | Cyclohexanone(15) |
| Ln-2 | — | 0 | (A) | 10 | DPHA | 88 | — | 0 | 2 | — | 0 | Toluene(85) |
| | | | | | | | | | | | | Cyclohexanone(15) |
| Ln-3 | — | 0 | (A) | 20 | DPHA | 78 | — | 0 | 2 | — | 0 | Toluene(85) |
| | | | | | | | | | | | | Cyclohexanone(15) |
| Ln-4 | — | 0 | (A) | 30 | DPHA | 68 | — | 0 | 2 | — | 0 | Toluene(85) |
| | | | | | | | | | | | | Cyclohexanone(15) |
| Ln-5 | — | 0 | (A) | 65 | DPHA | 33 | — | 0 | 2 | — | 0 | Toluene(85) |
| | | | | | | | | | | | | Cyclohexanone(15) |
| Ln-6 | P-13 | 68 | (A) | 20 | DPHA | 10 | — | 0 | 2 | — | 0 | Toluene(85) |
| | | | | | | | | | | | | Cyclohexanone(15) |
| Ln-7 | P-13 | 83 | (A) | 5 | DPHA | 10 | — | 0 | 2 | — | 0 | Toluene(85) |
| | | | | | | | | | | | | Cyclohexanone(15) |
| Ln-8 | P-13 | 78 | (A) | 10 | DPHA | 10 | — | 0 | 2 | — | 0 | Toluene(85) |
| | | | | | | | | | | | | Cyclohexanone(15) |
| Ln-9 | P-13 | 58 | (A) | 30 | DPHA | 10 | — | 0 | 2 | — | 0 | Toluene(85) |
| | | | | | | | | | | | | Cyclohexanone(15) |
| Ln-10 | P-13 | 68 | Quaternary | 20 | DPHA | 10 | — | 0 | 2 | — | 0 | MEK(85) |
| | | | Ammonium Salt | | | | | | | | | Cyclohexanone(15) |
| | | | (PQ-10) | | | | | | | | | |
| Ln-11 | P-13 | 68 | (B) | 20 | DPHA | 10 | — | 0 | 2 | — | 0 | MEK(85) |
| | | | | | | | | | | | | Cyclohexanone(15) |
| Ln-12 | P-13 | 68 | (D) | 20 | DPHA | 10 | — | 0 | 2 | — | 0 | MEK(80) |
| | | | | | | | | | | | | PGMEA(20) |
| Ln-13 | P-13 | 68 | (D) | 20 | DPHA | 6 | — | 0 | 2 | — | 0 | MEK(80) |
| | | | | | HEM | 4 | | | | | | PGMEA(20) |
| Ln-14 | P-13 | 40 | (A) | 20 | DPHA | 10 | — | 0 | 2 | — | 0 | Toluene(85) |
| | F-1 | 28 | | | | | | | | | | Cyclohexanone(15) |
| Ln-15 | P-16 | 40 | (E) | 20 | DPHA | 10 | — | 0 | 2 | — | 0 | MEK(80) |
| | F-1 | 28 | | | | | | | | | | PGMEA(20) |
| Ln-16 | P-13 | 40 | (E) | 20 | DPHA | 10 | — | 0 | 2 | — | 0 | MEK(80) |
| | F-1 | 28 | | | | | | | | | | PGMEA(20) |
| Ln-17 | P-13 | 35 | (E) | 20 | DPHA | 10 | MF1 | 5 | 2 | — | 0 | MEK(80) |
| | F-1 | 28 | | | | | | | | | | PGMEA(20) |
| Ln-18 | P-13 | 20 | (E) | 20 | DPHA | 10 | MF1 | 5 | 2 | A-2 | 30 | MEK(80) |
| | F-1 | 13 | | | | | | | | | | PGMEA(20) |
| Ln-19 | — | 0 | (E) | 35 | DPHA | 58 | X22-164C | 5 | 2 | — | 0 | MEK(80) |
| | | | | | | | | | | | | PGMEA(20) |

In Table 5, the amount of each component is indicated by the ratio (% by weight) of the solid content of each component based on the total solid content of the composition for antistatic layer. The solvent for dilution is a mixed solvent containing the respective solvents in the weight ratio shown in Table 5.

The compounds used above are described below.

PQ-10: Polymer type cationic antistatic agent (quaternary ammonium salt-containing acrylic resin (trade name, PQ-10) produced by Soken Chemical & Engineering Co., Ltd.)

DPHA: Mixture of dipentaerythritol pentaacrylate and dipentaerythritol hexaacrylate (produced by Nippon Kayaku Co., Ltd.)

HEAA: 2-Hydroxyethylacrylamide (produced by Kohjin Co., Ltd.)
IRGACURE-907: Photopolymerization initiator (produced by Ciba Specialty Chemicals Inc.)
MF1: Fluorine-containing unsaturated compound a-1 shown below.

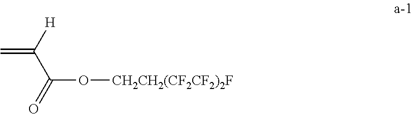

Dispersion A-2: Hollow silica fine particle dispersion (solid content ratio: 22% by weight)
PGMEA: Propylene glycol monomethyl ether acetate
X22-164C: Mn=10,000, both-terminal hydroxy group modified polydimethylsiloxane (produced by Shin-Etsu Chemical Co., Ltd.)
P-13, P-16 and F-1: Fluorine-containing compound P-13, P-16 and F-1 described hereinbefore, respectively.

### Example 1

### Production of Optical Film

### (Formation of Hardcoat Layer)

On a triacetyl cellulose film (TAC-TD80U, produced by FUJIFILM Corp.) having a thickness of 80 μm and a width of 1,340 mm, each of Coating solutions (HC-1) to (HC-9), (HC-12) and (HC-13) for hardcoat layer was coated by a die coater under a condition of transportation speed of 30 m/min and dried at 60° C. for 150 seconds, and the coated layer was cured by irradiating an ultraviolet ray at an illuminance of 400 mW/cm² and an irradiation dose of 150 mJ/cm² using an air-cooled metal halide lamp (produced by Eye Graphics Co., Ltd.) of 160 W/cm while purging the system with nitrogen (oxygen concentration of 0.5% or less), thereby forming a hardcoat layer having a thickness after curing of 6 μm.

Also, hardcoat layers for Sample Nos. 130 and 134 were prepared in the same manner as described above except for using Coating solutions (HC-10) and (HC-14), changing the thickness of the hardcoat layer to 12 μm and changing the support to a triacetyl cellulose film (TAC-TD60U, produced by FUJIFILM Corp.) having a thickness of 60 μm, respectively.

Further, a hardcoat layer for Sample No. 131 was prepared in the same manner as described above except for using Coating solution (HC-11), changing the thickness of the hardcoat layer to 3 μm and changing the substrate to a triacetyl cellulose film having a thickness of 40 μm.

### (Formation of Antistatic Layer)

The triacetyl cellulose film having the hardcoat layer provided thereon thus-obtained was used as a base material and on the hardcoat layer was coated a coating solution for antistatic layer (any one of Ln-1 to LN-19) as shown in Table 6 or 7 by a die coater so as to control that a thickness of the antistatic layer after curing was 100 nm and dried at 80° C. for 120 seconds, and the coated layer was cured by irradiating an ultraviolet ray at an illuminance of 400 mW/cm² and an irradiation dose of 240 mJ/cm² using an air-cooled metal halide lamp (produced by Eye Graphics Co., Ltd.) of 160 W/cm while purging the system with nitrogen (oxygen concentration of 0.01% or less), thereby forming an antistatic layer.

Thus, Optical Film Sample Nos. 101 to 134 were prepared, respectively.

### [Dope Treatment]

A 5% by weight of ethanol solution of p-benzoquinone and a 20% by weight aqueous solution of 1,5-dinaphthalenedisulfonic acid tetrahydrate were prepared. These solutions were mixed in an equal weight ratio to prepare a dope solution.

Into the dope solution, Optical Film Sample No. 113 was immersed at a room temperature for 10 minutes, washed with ethanol and dried at 60° C. for 20 minutes to perform the dope treatment. Due to the dope treatment, the polyaniline in the antistatic layer of the optical film sample was doped under oxidative condition to increase the conductivity, thereby achieving the log SR evaluated hereinafter.

### [Saponification Treatment of Optical Film]

The surface of the antistatic layer side of the optical film sample obtained as above was laminated to protect and the rare surface thereof was subjected to the saponification treatment in the manner shown below.

A 1.5 mol/l of aqueous sodium hydroxide solution was prepared and maintained at 55° C. A 0.005 mol/l of aqueous diluted sulfuric acid solution was prepared and maintained at 35° C. The optical film sample was immersed in the aqueous sodium hydroxide solution for 2 minutes and then immersed in water to thoroughly wash for removing the aqueous sodium hydroxide solution. Then, the optical film sample was immersed in the diluted sulfuric acid solution for one minute and then immersed in water to thoroughly wash for removing the diluted sulfuric acid solution. Finally, the optical film sample was dried at 120° C. for 3 minutes to prepare an optical film subjected to the saponification treatment.

[Change in Surface Free Energy of Hardcoat Layer after Coating of Coating Solution for Antistatic Layer]

Since the fluorine-containing compound (B1) (fluoroaliphatic group-containing polymer) according to the invention is localized in the surface of a layer (hardcoat layer in the example) into which it is incorporated, the surface free energy of the layer is changed due to the incorporation of the fluoroaliphatic group-containing polymer (B1).

Further, since the fluoroaliphatic group-containing polymer (B1) is ordinarily has a molecular weight distribution, when the coating solution for antistatic layer is coated on the layer containing the fluoroaliphatic group-containing polymer (B1), due to difference in the molecular weight of the fluoroaliphatic group-containing polymer (B1) some fluoroaliphatic group-containing polymers (B1) are eluted into the coating solution for antistatic layer and some fluoroaliphatic group-containing polymers (B1) remain in the surface of the under layer. As a result, distribution of the surface free energy of the under layer (fluctuation of surface energy) is generated.

In order to confirm those described above, the triacetyl cellulose films having the hardcoat layer provided thereon used for preparing Optical Film Sample Nos. 105, 107, 111 and 118 were subjected to the experiment described below.

Each of the triacetyl cellulose films having the hardcoat layer provided thereon used for preparing Optical Film Sample Nos. 105, 107, 111 and 118 was maintained at temperature of 25° C. and humidity of 60% RH for 2 hours to conduct humidity conditioning and then, contact angles of the surface of the hardcoat layer to water and methylene iodide were measured from which a surface free energy was determined.

Further, in order to investigate behavior of the surface free energy of the hardcoat layer when the coating solution for antistatic layer is coated on the surface of the hardcoat layer containing fluoroaliphatic group-containing polymer (B1) according to the invention, a mixed solvent of methyl ethyl ketone and cyclohexanone in a weight ration of 85/15 used as a solvent in the coating solution for antistatic layer was run on the surface of the hardcoat layer of the triacetyl cellulose films having the hardcoat layer provided thereon which was declined at an angle, and after drying contact angles of the surface of the hardcoat layer to water and methylene iodide were measured from which a surface free energy was determined.

The value of surface free energy of the hardcoat layer before the running of the mixed solvent of methyl ethyl ketone and cyclohexanone on its surface was subtracted form the value of surface free energy of the hardcoat layer after the running of the mixed solvent of methyl ethyl ketone and cyclohexanone on its surface to evaluate the change in the surface free energy. The results obtained are shown in Table 6.

TABLE 6

| | Adjacent Layer | | | Surface Free | Change in Surface | |
|---|---|---|---|---|---|---|
| | Fluorine-containing Compound (B1) | | | Energy before | Free Energy after | |
| | | Composition for | Composition for | Contact with | Contact with | |
| Sample No. | Kind | HC Layer | Antistatic Layer | Solvent | Solvent | Remarks |
| 105 | R-1 | HC-1 | Ln-5 | 31 | ±0 | Comparative |
| | | | | | | Example |
| 107 | FP-69 | HC-2 | Ln-6 | 30 | +3 | Example |
| 111 | FP-138 | HC-3 | Ln-6 | 31 | +5 | Example |
| 118 | FP-62 | HC-4 | Ln-16 | 30 | +3 | Example |
| | EP-138 | | | | | |

As shown in Table 6 above, it can be seen that when the coating solution for antistatic layer is coated on the surface of the layer containing the fluorine-containing compound (B1) according to the invention, the change in the surface free energy is observed and the fluorine-containing compound (B1) is eluted.

### [Evaluation of Optical Film]

With the optical film sample obtained, the evaluations and determinations of the items shown below were conducted.

(Evaluation 1) Determination of Distribution of Conductive Polymer (A) and Fluorine-Containing Compound (B1) and/or Silicone-Based Compound (B2) in Adjacent Layer

The optical film was obliquely cut at an angle of 0.05° by a microtome and the cut section of the coated layer obtained was analyzed by TOP-SIMS method to measure the local concentration distribution of the compound in the layer thickness direction by noting ions inherent to each component.

With respect to the conductive polymer (A), the distribution of the conductive polymer in the cut area of the antistatic layer was determined by TOF-SIMS method to make mapping. The concentration distribution of the conductive polymer was analyzed to examine whether the conductive polymer was present in the sea region of the sea-island phase separation structure.

The result was evaluated according to the criteria shown below.

“Yes”: Case where the conductive polymer was present in the sea region of the sea-island phase separation structure.
“No”: Case where the conductive polymer was not present in the sea region of the sea-island phase separation structure or case where the sea-island structure was not formed.

With respect to the fluorine-containing compound (B1) and/or silicone-based compound (B2), the distribution of the compound at the interface of the base material adjacent to the antistatic layer was determined by TOF-SIMS method to make mapping. The distribution of the compound in the interface of the base material adjacent to the antistatic layer was evaluated according to the criteria shown below.

Even: Region of 10 nm square or more where difference in the concentration of the compound (B1) or (B2) in the in-plane direction of the interface was 15% or more was not present.
Uneven: Region of 10 nm square or more where difference in the concentration of the compound (B1) or (B2) in the in-plane direction of the interface was 15% or more was present.

The results are indicated using “Yes” and “No” which correspond to Uneven and Even described above respectively.

The measurement by TOF-SIMS method was performed using the apparatus described below.

Apparatus: TRIFT II, produced by Physical Electronics (PHI) Inc.

### (Evaluation 2) Determination of Average Integrated Reflectance

The optical film was pasted on polarizing plates of cross Nicol and a spectral reflectance (%) at an incident angle of 5° in a wavelength range from 380 to 780 nm was measured using a spectrophotometer (produced by JASCO Corp.). The integrating sphere average reflectance in a wavelength range from 450 to 650 was used for the result.

### (Evaluation 3) Evaluation of Scratch Resistance

A rubbing test was conducted using a rubbing tester under the conditions shown below.

Environmental conditions for evaluation: 25° C., 60% RH
Rubbing material: Steel wool (Grade No. 0000, produced by Nihon Steel Wool Co., Ltd.) was wound on the rubbing tip (1 cm×1 cm) of the tester which would come into contact with the sample and fixed with a band not to move.

A reciprocal rubbing movement of the sample was made on the rubbing material under the conditions shown below.

Moving distance (one way): 13 cm
Rubbing speed: 13 cm/sec
Load: 500 g/cm²
Contact area of the tip: 1 cm×1 cm
Number of times of rubbing: 10 reciprocations

To the rear side of the sample after the rubbing was applied oil-based black ink and the scratch mark in the rubbed portion was visually observed with reflection light and evaluated according to the criteria shown below.

A: Scratch mark was not found at all even when observed extremely carefully.
AB: Weak scratch mark was slightly found when observed extremely carefully.
B: Weak scratch mark was found.
BC: Scratch mark of medium degree was found.
C: Scratch mark was found at a glance.

In the evaluation of the scratch resistance, the criteria of A and AB are of high practical value.

### (Evaluation 4) Evaluation of Adhesion Property

The optical film sample was subjected to humidity conditioning under the conditions of 25° C. and 60% RH for 2 hours. The surface of the optical film sample on the antistatic layer side was notched in a grid-like pattern with 11 vertical lines and 11 horizontal lines using a cutter knife, thereby forming 100 squares in total. A polyester adhesive tape (No. 31B, produced by Nitto Denko Corp.) was attached onto the surface of the film sample. After lapse of 30 minutes, the polyester adhesive tape was rapidly peeled off in the vertical direction from the film sample. A number of squares peeled off was counted on the film sample and evaluated according to the four-grade criteria shown below. The procedures for evaluating the adhesion property described above were repeated three times and an average value thereof was determined.

A: No peeling off was recognized at all in the 100 squares.
B: Peeling off of one or two squares was recognized in the 100 squares.
C: Peeling off of 3 to 10 squares was recognized in the 100 squares (within an acceptable range).
D: Peeling off of 11 or more squares was recognized in the 100 squares.

### (Evaluation 5) Evaluation of Surface Resistance

The surface resistance of the optical film on the antistatic layer (outermost layer) side was measured using an ultra-insulation resistance/micro ammeter (1R-8601, produced by Advantest Corp.) under the conditions of 25° C. and 60% RH. The result was indicated by a common logarithm value log(SR) of the surface resistivity.

### (Evaluation 6) Evaluation of Dust Resistance

The base material side of the optical film sample was laminated on a CRT surface and the laminate was used for 24 hours in a room having from 100 to 2,000,000 particles of dust of 0.5 μm or more and tissue paper scraps per 1 ft³ (cubic feet). The number of particles of dust and the number of the tissue paper scrapes attached per 100 cm² of the optical film were measured and the average value thereof was determined and evaluated according to the criteria shown below.

A: Less than 20 pieces.
B: From 20 to 49 pieces.
C: From 50 to 199 pieces.
D: 200 or more pieces.

In the evaluation of the dust resistance, the criteria of A and B are of high practical value.

### (Evaluation 7) Visual Evaluation of Optical Surface State

The optical film was subjected to (1) transmission surface state test under a three-wavelength florescent lamp. Also, after applying oil-based black ink on the surface of the optical film on the side opposite to the antistatic layer, it was subjected to (2) reflection surface state test under a three-wavelength florescent lamp. From these results, uniformity of the surface state (absence of unevenness, for example, unevenness due to wind, drying unevenness or coating streaks unevenness) was totally evaluated in detail according to the criteria shown below.

1: Surface state was extremely bad.
2: Surface state was poor and the goal was not attained.
3: Although the unevenness was present, it was the lower limit in practical use and in an acceptable level.
4: Surface state was fairly good.
5: Surface state was extremely good.

The results obtained are shown in Table 7 below.

TABLE 7

| | Adjacent Layer | | | | | | | | | | | | |
|---|---|---|---|---|---|---|---|---|---|---|---|---|---|
| | Fluorine-containing | | | | | | | | | | | | |
| | Compound (B1) or | | Antistatic Layer | | | | | | | | | | |
| | Silicone-based | | Compo- | | | | | | | | | | |
| | Compound (B2) | | sition | | Performances | | | | | | | | |
| | | Compo- | for | | Inte- | | | Sea- | Uneven- | Surface | | | |
| | | sition | Anti- | Re- | grated | Scratch | | island | ness of | Re- | Dust | Optical | |
| Sample | | for HC | static | fractive | Re- | Re- | Adhesion | Struc- | Adjacent | sistance | Re- | Surface | |
| No. | Kind | Layer | Layer | Index | flectance | sistance | Property | ture | Layer | (log SR) | sistance | State | Remarks |
| 101 | FP-69 | HC-2 | Ln-1 | 1.53 | — | — | — | — | — | — | — | — | Comparative |
| | | | | | | | | | | | | | Example |
| 102 | R-1 | HC-1 | Ln-2 | 1.53 | 4.5 | AB | C | No | No | 14.2 | C | 3 | Comparative |
| | | | | | | | | | | | | | Example |
| 103 | R-1 | HC-1 | Ln-3 | 1.53 | 4.5 | B | C | No | No | 14.0 | C | 3 | Comparative |
| | | | | | | | | | | | | | Example |
| 104 | R-1 | HC-1 | Ln-4 | 1.54 | 4.6 | BC | D | No | No | 13.8 | C | 3 | Comparative |
| | | | | | | | | | | | | | Example |
| 105 | R-1 | HC-1 | Ln-5 | 1.54 | 4.6 | C | D | No | No | 11.5 | B | 2 | Comparative |
| | | | | | | | | | | | | | Example |
| 106 | FP-69 | HC-2 | Ln-3 | 1.53 | 4.5 | A | B | Yes | Yes | 12.5 | B | 3 | Example |
| 107 | FP-69 | HC-2 | Ln-6 | 1.48 | 3.1 | A | A | Yes | Yes | 11.5 | B | 4 | Example |
| 108 | FP-69 | HC-2 | Ln-7 | 1.47 | 3.0 | A | A | No | Yes | 13.7 | D | 4 | Comparative |
| | | | | | | | | | | | | | Example |
| 109 | FP-69 | HC-2 | Ln-8 | 1.47 | 3.0 | A | A | Yes | Yes | 11.5 | B | 4 | Example |
| 110 | FP-69 | HC-2 | Ln-9 | 1.48 | 3.2 | AB | B | Yes | Yes | 9.8 | A | 4 | Example |
| 111 | FP-138 | HC-3 | Ln-6 | 1.48 | 3.1 | A | B | Yes | Yes | 10.8 | A | 4 | Example |
| 112 | FP-138 | HC-3 | Ln-10 | 1.48 | 3.1 | AB | B | Yes | Yes | 11.6 | A | 4 | Example |
| 113 | FP-138 | HC-3 | Ln-11 | 1.48 | 3.1 | A | B | Yes | Yes | 9.7 | A | 4 | Example |
| 114 | FP-138 | HC-3 | Ln-12 | 1.48 | 3.1 | A | B | Yes | Yes | 9.5 | A | 4 | Example |
| 115 | FP-138 | HC-3 | Ln-13 | 1.48 | 3.1 | A | B | Yes | Yes | 9.2 | A | 5 | Example |
| 116 | FP-138 | HC-3 | Ln-14 | 1.47 | 3.0 | A | B | Yes | Yes | 10.2 | A | 5 | Example |
| 117 | FP-138 | HC-3 | Ln-15 | 1.47 | 3.0 | A | B | Yes | Yes | 10.5 | A | 5 | Example |
| 118 | FP-62 | HC4 | Ln-16 | 1.47 | 3.0 | A | A | Yes | Yes | 10.4 | A | 5 | Example |
| | FP-138 | | | | | | | | | | | | |
| 119 | FP-62 | HC-4 | Ln-17 | 1.47 | 3.0 | A | A | Yes | Yes | 10.2 | A | 5 | Example |
| | FP-138 | | | | | | | | | | | | |
| 120 | FP-62 | HC-4 | Ln-18 | 1.43 | 2.1 | A | A | Yes | Yes | 10.1 | A | 5 | Example |
| | FP-138 | | | | | | | | | | | | |
| 121 | FP-62 | HC-4 | Ln-6 | 1.48 | 3.1 | A | A | Yes | Yes | 10.6 | A | 5 | Example |
| | FP-138 | | | | | | | | | | | | |
| 122 | — | HC-8 | Ln-19 | 1.53 | 4.5 | A | B | No | No | 13.5 | C | 3 | Comparative |
| | | | | | | | | | | | | | Example |
| 123 | X22-164C | HC-9 | Ln-19 | 1.53 | 4.5 | C | D | No | No | 13.5 | C | 2 | Comparative |
| | | | | | | | | | | | | | Example |
| 124 | FP-62 | HC-5 | Ln-19 | 1.53 | 4.5 | A | B | Yes | Yes | 11.8 | B | 3 | Example |
| | FM072 | | | | | | | | | | | | |
| 125 | FP-62 | HC-5 | Ln-16 | 1.47 | 3.0 | A | B | Yes | Yes | 10.1 | A | 5 | Example |
| | FM072 | | | | | | | | | | | | |
| 126 | FM072 | HC-6 | Ln-19 | 1.53 | 4.5 | A | B | Yes | Yes | 11.8 | B | 3 | Example |
| | FM4421 | | | | | | | | | | | | |
| 127 | FM072 | HC-6 | Ln-16 | 1.47 | 3.0 | A | B | Yes | Yes | 10.4 | A | 5 | Example |
| | FM4421 | | | | | | | | | | | | |
| 128 | KF945 | HC-7 | Ln-19 | 1.53 | 4.5 | A | B | Yes | Yes | 11.8 | B | 3 | Example |
| | FM4421 | | | | | | | | | | | | |
| 129 | KF945 | HC-7 | Ln-16 | 1.47 | 3.0 | A | A | Yes | Yes | 10.4 | A | 5 | Example |
| | FM4421 | | | | | | | | | | | | |
| 130 | R-1 | HC-10 | Ln-3 | 1.53 | 4.5 | AB | C | No | No | 14.2 | C | 3 | Comparative |
| | | | | | | | | | | | | | Example |
| 131 | FP-62 | HC-11 | Ln-16 | 1.47 | 3.0 | A | B | Yes | Yes | 10.2 | A | 5 | Example |
| | FP-138 | | | | | | | | | | | | |
| 132 | FP-62 | HC-12 | Ln-18 | 1.43 | 2.1 | A | A | Yes | Yes | 10.1 | A | 5 | Example |
| | FP-138 | | | | | | | | | | | | |
| 133 | X22-164C | HC-13 | Ln-16 | 1.47 | 3.0 | A | B | Yes | Yes | 11.6 | B | 5 | Example |

As show in Table 7 above, in the cases where the same amount of the conductive polymer is used, the optical films (Samples 106, 107 and 109) of the example according to the invention in which the conductive polymer is distributed in the sea-island state to from the sea region of the sea-island structure exhibit the reduced surface resistance, have the excellent dust resistance, and exhibit the excellent surface state free from streak or unevenness, scratch resistance and adhesion property in comparison with the optical films in which the sea-island structure is not recognized as in Samples 102 to 105 and 130. As for Sample 101, since the degree of degradation of surface state after the coating of the coating solution for antistatic layer Ln-1 was large, the evaluation could not be performed. Further, in Sample 108, although the phase separation structure was recognized in the antistatic layer, the conductive polymer was present not in the sea region but in the island region.

Further, the increase in the adhesion property and the conductivity (decrease in the log SR) and the improvement in the surface state of coated layer are recognized when the fluorine-containing curable compound (C) is incorporated into the coating solution for antistatic layer (comparison of Sample 106 with Sample 107). Moreover, in the case where the conductivity of the laminate is same, the use of the fluorine-containing curable compound (C) leads to the excellent scratch resistance (comparison of Sample 105 with Sample 107).

Furthermore, the increase in the conductivity (decrease in the log SR) and the improvement in the surface state of coated layer are recognized when the component of a low surface free energy having different structure in the adjacent layer to the antistatic layer (comparison of Samples 107 and 111 with Sample 121).

### Example 2

### Evaluation Using Liquid Crystal Display Device

### (Preparation of Polarizing Plate)

A triacetyl cellulose film (TAC-TD80U, produced by FUJIFILM Corp.) having a thickness of 80 μm which had been substituted to immersion treatment with a 1.5 mol/l aqueous sodium hydroxide solution at 55° C. for 2 minutes, neutralization and washing with water and each of the optical films subjected to the saponification treatment of Examples and Comparative Examples were adhered to the both surfaces of a polarizer prepared by adsorbing iodine to polyvinyl alcohol and stretching, in order to protect the both surfaces, thereby preparing a polarizing plate.

### (Preparation of Liquid Crystal Display Device)

A polarizing plate provided in a VA-mode liquid crystal display device (LC-37GS10, produced by Sharp Corp.) was peeled and instead, the polarizing plate prepared above was attached thereon so that the transmission axes correspond to those of polarizing plate provided in the device to prepare a liquid crystal display device having each of the optical films obtained in Examples and Comparative Examples. The polarizing plate was attached so as to be arranged the optical film on the viewing side.

The polarizing plate and image display device thus prepared using any of the optical films in Examples exhibited the excellent surface state free form streak or unevenness, scratch resistance, antifouling property, dust resistance and adhesion property similar to those of the optical films attached in comparison with those prepared using any of the optical films in Comparative Examples. Further, the image display device exhibited very high display quality with very few formation of reflected glare image and was excellent in antifouling property.

1. A laminate comprising an antistatic layer on a base material, wherein the antistatic layer has a sea-island phase separation structure and comprises (A) a conductive polymer in a sea region of the sea-island phase separation structure, in a surface of the base material on a side adjacent to the antistatic layer at least one compound selected from (B1) a fluorine-containing compound and (B2) a silicone-based compound is distributed at an uneven concentration in an in-plane direction of the surface, and a common logarithm value (log SR) of surface resistivity SR (Ω/sq) of the antistatic layer is from 3.0 to 13.0.

2. The laminate as claimed in claim 1, wherein in the distribution of at least one compound selected from (B1) a fluorine-containing compound and (B2) a silicone-based compound in the surface of the base material in a side adjacent to the antistatic layer, concentration of at least one compound selected from (B1) a fluorine-containing compound and (B2) a silicone-based compound in the surface of the base material adjacent to the sea region containing (A) the conductive polymer of the antistatic layer is lower than concentration of at least one compound selected from (B1) a fluorine-containing compound and (B2) a silicone-based compound in the surface of the base material adjacent to the island region of the antistatic layer.

3. The laminate as claimed in claim 1, wherein in the surface of the base material on a side adjacent to the antistatic layer (B1) the fluorine-containing compound is distributed at an uneven concentration in an in-plane direction of the surface, and (B1) the fluorine-containing compound is a fluoroaliphatic group-containing polymer containing 10% by weight or more of a polymerization unit derived from a fluoroaliphatic group-containing monomer.

4. The laminate as claimed in claim 3, wherein the fluoroaliphatic group-containing polymer is a polymer having in its side chain, a perfluoroalkyl group having 4 or more carbon atoms or a fluoroalkyl group having 4 or more carbon atoms and a —CF₂H group.

5. The laminate as claimed in claim 1, wherein (A) the conductive polymer is a π-conjugated system conductive polymer or a derivative thereof.

6. The laminate as claimed in claim 5, wherein the π-conjugated system conductive polymer is at least one selected from polythiophene, polyaniline, a polythiophene derivative and a polyaniline derivative.

7. The laminate claimed in claim 1, wherein the antistatic layer further comprises (C) a cured compound of a fluorine-containing curable compound.

8. The laminate as claimed in claim 1, wherein the antistatic layer further comprises at least one selected from (D) a silicone-based antifouling agent and (F) a fluorine-containing antifouling agent.

9. The laminate claimed in claim 1, wherein the antistatic layer further comprises (F) an inorganic oxide particle.

10. The laminate as claimed in claim 1, wherein a thickness of the antistatic layer is from 20 nm to 5 μm.

11. The laminate as claimed in claim 1, wherein the base material comprises a support and a layer formed by applying a curable resin onto the support and curing the applied resin, and a surface of the layer formed by applying a curable resin onto the support and curing the applied resin is the surface of the base material adjacent to the antistatic layer.

12. The laminate as claimed in claim 11, wherein the layer formed by applying a curable resin onto the support and curing the applied resin is a hardcoat layer.

13. The laminate as claimed in claim 1, wherein the antistatic layer is a low refractive index layer having a refractive index from 1.25 to 1.49.

14. The laminate claimed in claim 1, which further comprises a layer on the antistatic layer, and a common logarithm value (log SR) of surface resistivity SR (Ω/sq) of an outermost surface of the laminate is from 3.0 to 13.0.

15. An optical film comprising a laminate comprising an antistatic layer on a base material, wherein the antistatic layer has a sea-island phase separation structure and comprises (A) a conductive polymer in a sea region of the sea-island phase separation structure, in a surface of the base material on a side adjacent to the antistatic layer at least one compound selected from (B1) a fluorine-containing compound and (B2) a silicone-based compound is distributed at an uneven concentration in an in-plane direction of the surface, and a common logarithm value (log SR) of surface resistivity SR (Ω/sq) of the antistatic layer is from 3.0 to 13.0.

16. A polarizing plate comprising a polarizing film and two protective films provided on both side of the polarizing film, wherein at least one of the protective films is a laminate comprising an antistatic layer on a base material, wherein the antistatic layer has a sea-island phase separation structure and comprises (A) a conductive polymer in a sea region of the sea-island phase separation structure, in a surface of the base material on a side adjacent to the antistatic layer at least one compound selected from (B1) a fluorine-containing compound and (B2) a silicone-based compound is distributed at an uneven concentration in an in-plane direction of the surface, and a common logarithm value (log SR) of surface resistivity SR (Ω/sq) of the antistatic layer is from 3.0 to 13.0.

17. An image display device having a laminate comprising an antistatic layer on a base material, wherein the antistatic layer has a sea-island phase separation structure and comprises (A) a conductive polymer in a sea region of the sea-island phase separation structure, in a surface of the base material on a side adjacent to the antistatic layer at least one compound selected from (B1) a fluorine-containing compound and (B2) a silicone-based compound is distributed at an uneven concentration in an in-plane direction of the surface, and a common logarithm value (log SR) of surface resistivity SR (Ω/sq) of the antistatic layer is from 3.0 to 13.0.

18. A method for producing a laminate comprising an antistatic layer on a base material:
wherein the antistatic layer has a sea-island phase separation structure and comprises (A) a conductive polymer in a sea region of the sea-island phase separation structure, in a surface of the base material on a side adjacent to the antistatic layer at least one compound selected from (B1) a fluorine-containing compound and (B2) a silicone-based compound is distributed at an uneven concentration in an in-plane direction of the surface and a common logarithm value (log SR) of surface resistivity SR (Ω/sq) of the antistatic layer is from 3.0 to 13.0, and
wherein the method comprises: distributing, onto the base material, at least one compound selected from (B1) a fluorine-containing compound and (B2) a silicone-based compound at an uneven concentration in an in-plane direction of a surface of the base material; and applying a solution containing a conductive polymer for forming the antistatic layer onto the base material.
